(19) United States
(12) Patent Application Publication
(10) Pub. No.: US 2026/0031363 A1
(43) Pub. Date: Jan. 29, 2026

(54) MOISTURE ELECTRIC GENERATING DEVICE

(71) Applicant: AUSTRALIAN ADVANCED MATERIALS PTY LTD, Subiaco, Western Australia (AU)

(72) Inventors: Dewei CHU, Subiaco, Western Australia (AU); Tao WAN, Subiaco, Western Australia (AU); Mengyao LI, Subiaco, Western Australia (AU); Charles MURPHY, Subiaco, Western Australia (AU); Elliot NICHOLLS, Subiaco, Western Australia (AU)

(21) Appl. No.: 18/998,433

(22) PCT Filed: Jul. 27, 2023
(86) PCT No.: PCT/AU2023/050699

§ 371 Date: Jan. 24, 2025

(30) Foreign Application Priority Data
Jul. 27, 2022 (AU) 2022902105
Apr. 28, 2023 (AU) 2023901264

(51) Int. Cl. H01M 4/66; H01M 14/00

(52) U.S. Cl. CPC H01M 4/667; H01M 4/668; H01M 14/00; H01M 2300/0065

(57) ABSTRACT

A moisture electric generating device comprising: a first electrode and a second electrode; and disposed between the first electrode and the second electrode and a functional layer which releases electrical charge carriers; the functional layer includes at least two sub layers; a first sub layer acting as a moisture reservoir to a second sublayer, to provide moisture to the second sublayer; the second sub layer which produces electrical charge carriers as a function of moisture available from the first sub layer.

This patent application claims priority from Australian Patent Application No. 2022902105 filed on 27 Jul. 2022 and Australian Patent Application No. 2023901264 filed on 28 Apr. 2023, the contents of which are hereby incorporated herein by reference in their entirety.

### FIELD OF INVENTION

The present invention relates to a moisture electric generating device and, in particular, to a moisture electric generating device including a layer acting as a moisture reservoir.

### BACKGROUND

Harvesting green energy from the environment plays a vital role in the development of future energy supply due to the shortage of traditional energy sources. Moisture, one of the most abundant green energy sources, remains to be utilised for energy harvesting and conversion from thermal energy to electricity. Recently, moisture-electric generators (MEGs) with ionised groups or polar bonds in the nanomaterials have been widely investigated to harvest energy from the moisture in the environment and convert it into electric power by the moisture absorption and ion migration. For example, the oxygen functional groups in the surface of carbon nanomaterials interact with water molecules from the moisture and dissociate the water molecule to generate the mobile hydrogen ions. Therefore, more hydrogen ions in the outer layer exposed to the moisture contribute to concentration difference of hydrogen ions for an electric potential. Moreover, MEGs have also been demonstrated to be used as wearable devices by harvesting moisture from respiration or environment, which presents a great potential in self-powered wearable devices.

Generally, metallic oxides (TiO₂) and carbon-based materials (graphene oxides, polymer) are employed for MEGs as polar bonds or oxygen-based groups (—OH and —COOH) can absorb H⁺ ions and induce potential. Specially, graphene oxides (GO) show high specific surface area, abundant oxygen-based groups, and good mechanical properties, which exhibits fast moisture absorption and steady electric output. Besides, GO can be modified with oxygen-based groups or inner structure to further improve its electric output. In a recent study, a flexible MEG based on graphene oxide presented an open-circuit voltage of 0.7 V with a small size of 0.8 mm². However, the voltage or current of MEG is strongly related to the relative humidity (RH) in the environment and shows instantaneous output, which inhibit its widespread application in electric generator. Besides, the electric output of MEG requires further improvement so that it is applicable for powering devices with high power. The mechanism of electric generation and enhancement should also be investigated to better understand its fabrication and application for powering devices in the future.

### SUMMARY OF THE INVENTION

In accordance with an embodiment a moisture electric generating device comprises: a first electrode and a second electrode; and disposed between the first electrode and the second electrode and a functional layer which releases electrical charge carriers; the functional layer includes at least two sub layers; a first sub layer acting as a moisture reservoir to a second sublayer, to provide moisture to the second sublayer; the second sub layer which produces electrical charge carriers as a function of moisture available from the first sub layer.

The inclusion of a water/moisture reservoir sub layer within the moisture electric generating (MEG) device helps to control delivery of moisture to the second (functional) sub-layer. The functional sub-layer may also be referred to as an active sub layer. The functional sub layer releases electrical charge when it absorbs moisture. For example, functional groups of the functional layer produce charge carriers by disassociating water molecules of the moisture.

The moisture reservoir provides a delivery of moisture into the functional sub layer which is less dependent on the environmental moisture conditions as itself contains water molecules inside. The moisture electric generating device may generate electric charge in low and high humidity conditions, e.g. the water in the moisture reservoir sub layer will evaporate at low humidity, and it will adsorb water at high humidity. This can help to make the performance of the MEG device less variable in changing environmental moisture conditions because moisture delivery to the functional sub layer can be maintained.

The sub layer is able to retain moisture and it can act as a pool to other layers in the moisture electric generating device by providing moisture to those other layers. It acts as a moisture source to other sub layers in the moisture electric generating device. The sub layer acting as a moisture reservoir may also be referred to as a hydration layer since it can hydrate other sub layers. The advantage of providing a sub layer acting as a moisture reservoir to the second sub layer is that it can hydrate the second sub layer. Moisture can be provided to the second sub layer from the first sub layer, meaning that the second sub layer can be hydrated even in low humidity environmental conditions. Thus, the first sub layer can assist in hydrating the second sub layer at ambient or even the extreme condition (RH of 0%) owing to the abundant water within the first sub layer. The water reservoir sub layer acts like a pool which can release water at low humidity and store water at high humidity.

The sub layers may have different primary functions, the first sub layer acting as a moisture reservoir (hydration layer) for the second sub layer, and the second sub layer acting as a functional (active) layer to disassociate charge carriers on absorption of moisture.

In further embodiments the first sublayer comprises a polymer.

Polymers can be hydrated to include a high water content. Polymers can be efficient moisture absorbers meaning that moisture can be absorbed into the moisture electric generating device even in low humidity environments. This allows moisture to be absorbed into the moisture electric generating device more readily than an example with a single non-polymer functional layer, for example GO. This efficient moisture absorption property allows the moisture electric generating to absorb water in low humidity environments, and improve the electrical performance of the device in low humidity environments. Examples of polymers include 4-styrensulfonic acid (PSSA), PSSNa, PAA, PVA, PSSLi, PSSK, PSSNH4, PSSMg2, PSSAI3, PSSH, chitin, chitosan, cellulose, starch, gums, alginate, and carrageenan, polyamides, polyphenols, organic polyesters, inorganic polyesters, and polyanhydrides. Polymers include hydrogels. Some benefits of polymers include that they are flexible, stretchable, and easy for device fabrication, cost-effective, or semi-transparent, workable at low humidity.

Some polymers have hydrophilic functional groups so they can be water reservoir. Polymers may also form framework to hold salts.

In further embodiments the first electrode, the second electrode and the functional layer are configured in a stacked arrangement.

The stacked orientation is beneficial because this allows the interface between layers to have a relatively large surface area in the direction of charge movement between electrodes. This creates a relatively large surface area for the interface between the layers (for example a much greater surface area compared with the cross-sectional surface area of the layers that would be used in an end-to-end interface connection between the layers). This large surface area of the interface reduces internal resistance of the moisture electric generating device and provides the opportunity for high current compared with smaller contact areas. In principal, in-plane alignment will also work but the ion migration needs a long pathway so the internal resistance will be quite high. The large surface area of the interface also allows a greater surface area for moisture to penetrate from the first sub layer into the other sub layers.

In further embodiments the sublayers are arranged in a stacked configuration to form the functional layer.

In further embodiments the first and second sublayers are adjacent sublayers within the functional layer.

The adjacent sub layers provide an electrical interface between a surface of the first sublayer acting as a moisture reservoir and a surface of the second sub layer for the movement of charge carriers between the layers. The adjacent sub layers allow movement of moisture directly between the layers.

In some examples the functional layer is a bi-layer structure having two layers, namely the first sublayer acting as a moisture reservoir to the second sub layer, the second sublayer being a functional sub layer.

In further embodiments the first sub layer releases electrical charge carriers when the moisture electric generating cell is exposed to moisture.

An advantage is that both the functional sub layer and the first sub layer are MEG layers. This can provide the advantage that additional charge carriers can be provided to the moisture electric generating device by the first sub layer, in addition to those provided by the functional sublayer. This increase in the number of electrical charge carriers may increase the electrical performance (such as voltage output) of the device compared with single layered MEG.

In further embodiments the second sublayer has a net electric charge which is opposite to the charge of the of the charge carriers in the first sub layer.

The net charge of the second sublayer being opposite to the charge of the charge carriers in the first sub layer is advantageous to attract charge carriers from the first sub layer. These charge carriers in the first sub layer may be released. For example if the second sub layer is a net negative charge (for example a GO layer) protons or other positive ions present in the first sub layer (for example the polymer) will be attracted towards the second sub layer. This charge attraction can help to increase charge flow through the MEG device, which may improve the electrical properties of the MEG device. Examples may include increasing voltage and electric current of the moisture electric charge device.

In further embodiments the second sublayer comprises a carbon-based material.

In further embodiments the second sublayer comprises graphene oxide.

Graphene oxide is known to be a MEG material. The graphene oxide has a higher density than other more porous materials, for example Mxene. GO can adsorb excessive water from the polymer layer. GO is negatively charged so it can attract protons or other positive charge carriers from the polymer layer.

In further embodiments the moisture generating device being configured with the second sublayer being positioned between the first layer and the second electrode, the second layer having a top surface facing towards the first sub layer and a bottom surface facing towards the second electrode, the moisture electric generating device being configured to resist the ingress of moisture into the bottom surface of the second sub layer.

The advantage of resisting the ingress of moisture into the bottom surface of the second sub layer is that a moisture gradient can be created across the moisture generating electricity device. This moisture gradient may create a charge gradient within the MEG device.

In further embodiments the second electrode is insulating to moisture.

In further embodiments the second sub layer is adjacent to the second electrode and is electrically connected to the second electrode.

In further embodiments the first sub layer includes ionic salt.

The concentration of salt also plays a significant role in the device performance. The presence of ionic salts in the polymer layer provides mobile ions that could serve as the media to strengthen the ion concentration gradient across the device. This increases the number of ions in the first (moisture) layer. MEG devices including ionic salt within the polymer layer may possess a higher voltage output than the device without the ionic salt. Such free ions significantly enhance the conductivity of the polymer layer.

Salts include NaCl and Kcl. Li, Na and K are considered Group 1 alkaline metals.

Ionic salts also help the polymer absorb more moisture. These are hydrophilic salts.

In further embodiments the first sub layer comprises a hydrogel.

Hydrogels are three-dimensional networks of polymer chains. They are crosslinked polymers.

Hydrogels are hydrophilic and can absorb large amounts of water. Advantages of the use of hydrogels are that they have good moisture absorption properties. They are able to absorb moisture, even in low humidity environments. Hydrogels can be hydrated and provide a source of moisture to adjacent sub layers. This makes hydrogels effective for use as a moisture reservoir (hydration layer). Hydrogels have three-dimensional frameworks This structure provides operational durability as the structural integrity of the hydrogel layer can be maintained even in humid environments as the hydrogel is hydrated. This allows the MEG device to maintain performance. Hydrogels are also versatile in the materials that can be doped with various ions. These are ionic hydrogels. For examples, metal ions, salts can be injected into the hydrogel. This provides flexibility of charge carriers when designing a MEG device.

Hydrogels provide excellent water retention capability. Hydrogels can contain mobile ions caused. The hydrophilic properties of hydrogels having efficient moisture absorption capabilities mean that the device is less restricted by the humidity conditions of the environment compared with single layer, conventional, MEGs, and it can still produce electricity under low humidity environments,

In further embodiments the first sub layer is doped with charge carriers.

Introducing additional charge carriers enables the electrical performance of the moisture electric generating device to be improved. In high humidity environments in which there is an abundance of moisture and an abundance of H₊ ions from the disassociation of H₊ ions from moisture, the dominant charge carrier is H₊ ions. In lower humidity environments, fewer H₊ ions are dissociated due to a reduced amount of moisture but the metal ions from the first sub layer remain mobile and so metal ions can contribute to the electrical performance of the MEG device.

In further embodiments the device is configured to absorb moisture from the environment and that electrical performance is increased in higher moisture environments.

The device may be arranged to absorb moisture from the environment. The design of the devices is arranged to allow the absorption of moisture from the environment into the device which is fed into the functional layers to provide electrical performance of the device.

In accordance with a further aspect, a moisture electric generating device comprises: a first electrode and a second electrode; a functional layer which releases electrical charge carriers to the first and second electrodes; and a layer acting as a moisture reservoir to provide moisture to the functional layer.

In further embodiments the layer acting as a moisture reservoir to provide moisture to the functional layer is disposed between the first electrode and the second electrode.

In further embodiments the functional layer includes at least two sub layers, the first sub layer being the layer acting as a moisture reservoir and a second sub layer which provides electrical charge carriers when provided with moisture.

In accordance with a further aspect a moisture electric generating device comprises: a first electrode and a second electrode; and disposed between the first electrode and the second electrode a functional layer which releases electrical charge carriers when the electricity generating cell is exposed to moisture; the functional layer includes at least two sub layers, the sub layers being stacked between the first and second electrode (and adjacent layers being electrically connected); wherein one of the sub layers being a polymer sub layer.

In further embodiments the polymer sub layer acts as a moisture reservoir to an adjacent sub layer when the electricity generating cell is exposed to moisture.

In a further aspect a moisture electric generating device comprises: a first electrode and a second electrode; and disposed between the first electrode and the second electrode a functional layer which releases electrical charge carriers when the electricity generating cell is exposed to moisture; the functional layer includes at least two sub layers, the sub layers being stacked between the first and second electrode (and adjacent layers being electrically connected); wherein one of the sub layers being a polymer sub layer acts as a moisture reservoir to an adjacent sub layer when the electricity generating cell is exposed to moisture.

In a further aspect an electricity generating cell comprises a first electrode and a second electrode and located between the first and second electrode a functional layer which releases electrical charge carriers when the electricity generating cell is exposed to moisture.

In further embodiments the functional layer includes at least two sub layers, the sub layers being stacked between the first and second electrode and adjacent sub layers being electrically connected.

Each of the sub layers may release electrical charge carriers when the electricity generating cell is exposed to moisture. Each of the sub-layers comprises different materials. A first of the sub-layers may be a polymer sub layer. The polymer sub layer may be one of: PSSA, PSSNa, PAA, PVA, PSSLi, PSSK, PSSNH4, PSSMg2, PSSAI3, PSSH. A second of the sub layers comprises one of: MXene, oxidised MXene, PVA, PAA, GO.

In further embodiments the second of the sub-layers being adjacent to the first polymer sub layer.

In further embodiments a second of the sub-layers comprises a carbon-based material that releases charge carriers when exposed to moisture.

In further embodiments the first of the sublayers being a polymer sub layer is adjacent to the first electrode and is electrically connected to the first electrode.

In further embodiments the first electrode being porous to moisture.

The first electrode may comprise Ag, Zn, Zn plate, Zn foam, Al, Mg, Cu, Ni, Fe, or Ti.

In further embodiments the second of the sublayers is adjacent to the second electrode and is electrically connected to the second electrode,

In further embodiments the second electrode being insulating to moisture.

In further embodiments the sub-layers have different moisture absorption properties. In further embodiments the moisture absorption properties of the sub layers decrease from the sub layer adjacent to the first electrode to the sub layer adjacent to the second electrode.

In further embodiments a first of the sub layers being a polymer layer acts as a moisture reservoir to an adjacent sub layer when the electricity generating cell is exposed to moisture.

In further embodiments the first electrode exhibits an electrochemical reaction on contact with moisture.

In further embodiments the first electrode comprises at least one active metal: Al, Cu, Ni, Al, Zn, Zn foam, Mg, Fe, or Ti.

In further embodiments the functional layer comprises PSSNa.

In a further aspect an electricity generating cells comprises a first electrode and a second electrode and located between the first and second electrode a functional layer which releases electrical charge carriers when the electricity generating cell is exposed to moisture; the functional layer includes at least two sub layers, the sub layers being stacked between the first and second electrode; each of the sub layers releasing electrical charge carriers when the electricity generating cell is exposed to moisture; wherein a first of the sub-layers is a polymer sub layer and is electrically connected to an adjacent sub layer.

In further embodiments the first of the sublayers is PSSNa.

In further embodiments one of the sub layers is electrically connected to the second electrode, and comprises GO.

In a further aspect an electricity generating cell comprises a first electrode and a second electrode and located between the first and second electrode a functional layer which releases electrical charge carriers when the electricity generating cell is exposed to moisture, wherein the functional layer comprises PSSNa.

### BRIEF DESCRIPTION OF THE FIGURES

In order that the invention be more clearly understood and put into practical effect, reference will now be made to preferred embodiments of an assembly in accordance with the present invention. The ensuing description is given by way of non-limitative example only and is with reference to the accompanying drawings, wherein:

FIG. 1 shows a moisture electric generator battery cell having a functional layer, a first electrode and a second electrode.

FIG. 2 shows a moisture electric generator battery cell having a functional layer, a first electrode and a second electrode.

FIG. 3 shows an example of acidification of the functional layer of a moisture electric generator battery cell.

FIG. 4 (a) shows a structure illustration of an embodiment of a MEG.

FIG. 4 (b) shows a photo of device after acid-treatment.

FIG. 4 (c) shows morphology of GO/PVA before acid-treatment.

FIG. 4 (d) shows morphology of GO/PVA after acid-treatment.

FIG. 5 shows voltage output of GO/PVA film acidified by 32 wt. % HCl at different relative humidity (RH).

FIG. 6 shows voltage output of GO/PVA film treated with different HCl concentration.

FIG. 6(a) shows voltage retention; FIG. 6(b) shows max voltage output.

FIG. 6 (c) shows voltage cycles.

FIG. 6 (d) shows current cycles.

FIG. 7(a) shows XRD pattern of GO films and GO/PVA films.

FIG. 7 (b) is the interlayer spacing of GO films and GO/PVA films.

FIG. 8 (a) is XPS spectra of GO/PVA films with and without HCl acidification.

FIG. 8 (b) is the ratio of chemical bonds in GO/PVA films with and without HCl acidification.

FIG. 9 (a) is voltage retention of one unit, two units, four units.

FIG. 9 (b) is current cycles of one unit, two units, four units.

FIG. 9 (c) is max voltage and current of one unit, two units, four units.

FIG. 10 (a) is a photograph of acidified GO/PVA on the carbon cloth and its voltage output at room humidity of 45%.

FIG. 10 (b) is voltage output of flat acidified GO/PVA on the carbon cloth at RH=75%.

FIG. 10 (c) is voltage output of acidified GO/PVA wrapped on glass bottle with a diameter of 2 cm.

FIG. 10 (d) is voltage output of acidified GO/PVA wrapped on glass bottle with a diameter of 1 cm.

FIG. 10 (e) is patter design for device arrays on the FTO glass.

FIG. 10 (f) is a photograph of working calculator powered by two devices in series.

FIG. 11 is an illustration of device fabrication of: (a) Single MEG unit; (b) Four units in series for voltage measurement; and (c) Four units in parallel for current measurement.

FIG. 12 (a) is a photo of GO films on the FTO glass.

FIG. 12 (b) is voltage cycles of GO films at ΔRH=75%.

FIG. 13 shows voltage output of GO/PVA films with different thickness after 32% HCl washing (a) 6.21 μm. (b) 12.23 μm. (c) 15.53 μm. (d) 23.73 μm.

FIG. 14 shows voltage output of films with different area. (a) 0.5×0.5 cm2. (b) 1.0×1.0 cm2. (c) 1.5×1.5 cm2.

FIG. 15 (a) is a FTIR spectra of GO film, GO/PVA film, HCl-washed GO/PVA film.

FIG. 15 (b) is a Raman spectra of GO film, GO/PVA film, HCl-washed GO/PVA film.

FIG. 16 is voltage output of GO/PVA films washed with (a) 80 wt. % acetic acid and (b) 20 wt. % sodium hydroxide. XPS spectra of GO/PVA films washed with (c) 80 wt. % acetic acid and (d) 20 wt. % sodium hydroxide.

FIG. 17 (a) illustrates fabrication of GO/PVA pattern after acidification with 32 wt. % HCl.

FIG. 17 (b) illustrates two units in series for powering practical device.

FIG. 18 is an illustration of fabrication of Ag electrode.

FIG. 19 is a digital photo of experimental setup showing:
(a) Sample chamber for moisture generation and electric connection; and
(b) Keysight system for electric output measurement.

FIG. 20 is an illustration of five units in series for electric output measurement.

FIG. 21 (a) is voltage discharge curve of a single MEG battery cell with 1 resistor unit with 2000 k ohms at RH=75%,

FIG. 21 (b) is voltage retention of 5 connected MEG battery cell for 5.3 hours.

FIG. 21 (c) is voltage cycles of 5 connected MEG battery cell.

FIG. 21 (d) is current cycles of 5 connected MEG battery cell.

FIG. 22 shows MEGs with different functional layers for harvesting moisture from environment. (a) Illustration of abundant and sustainable moisture in the environment. (b) Structure illustration of MEG device. (c) Voltage output of GO film at RH=75%. (d) Voltage output of PVA film at RH=75%. (e) Voltage output of GO/PVA film at RH=75%.

FIG. 23 shows electric output comparison of MEGs with different protonation. (a) Voltage retention of MEGs acidified with different HCl concentration at RH=75%. (b) Vmax of MEGs acidified with different HCl concentration at RH=75%. (c) Voltage output of MEGs acidified by 32.0% HCl at different RH. (d) EIS of MEGs with and without 32.0% HCl acidification at room humidity of 55%. (e) Current output of MEGs acidified with different HCl concentration at RH=75%. The Ag electrode area of single MEG is 0.5×0.2 cm2. (f) Voltage output cycle of MEGs acidified with different HCl concentration. The moisture was input by wet N2 to increase electric output until it reached highest value and was then eliminated by dry N2 as one cycle.

FIG. 24 shows characterization and illustration of GO/PVA films in acidification. (a) Electric generation for acidified GO/PVA film. The protons in the functional groups of GO are mobilized by moisture absorption and achieve charge separation by proton migration toward inner layer. Conversely, the migration direction is opposite under the moisture removal and contributes to the charge recombination. (b) XPS spectra of GO/PVA films with and without HCl acidification. (c) The ratio of chemical bonds in the GO/PVA films with and without HCl acidification. (d) Illustration of functional group change in HCl acidification. C—O bonds transform into C═O bonds with better stability after HCl acidification.

FIG. 25 shows theoretical determination of the structural and proton-binding properties of functionalized graphene oxide by using DFT calculations. H binding for O-surface functionalized graphene oxide in the absence (a) and presence (b) of carbon vacancies. H binding for OH-surface functionalized graphene oxide in the absence (c) and presence (d) of carbon vacancies. HCl acidification promotes the formation of carbon vacancies.

FIG. 26 shows electric output of MEGs with different units at RH=75%. (a) Current output of one unit, two units, four units in parallel. The Ag electrode area of one unit is 0.5×0.2 cm2. (b) Voltage retention of one unit, two units, four units in series. (c) Vmax and max current output of one unit, two units, four units.

FIG. 27 shows demonstration of MEGs as a power source in various practical application. (a) Voltage output of acidified GO/PVA films wrapped on glass bottle with different curvatures at RH=75%. (b) Vmax of acidified GO/PVA on carbon cloth before and after 2000 bending cycles. (c) Voltage output of charging commercial capacitor by MEG at RH=75%. (d) Electric output of resistor with different resistances connected to MEG at RH=75%. (e) Voltage signals of pressure sensor powered by MEG at room humidity of 55%. (f) Photograph of commercial pressure sensor powered by a single MEG at room humidity of RH=55%. (g) Photograph of working calculator powered by MEG with 2 in series×20 in parallel at RH=75%.

FIG. 28 shows XRD of pristine GO film, HCl-acidified GO film and HNO3-acidified GO film.

FIG. 29 shows XPS spectra of GO film on FTO glass. (a) Pristine GO film without acidification. (b) GO film acidified by HNO3 vapor. (c) The O/C ratio of pristine GO film and GO film acidified by 70 wt. % HNO3 solution and vapor.

FIG. 30 shows the power output of an embodiment of a MEG device.

FIG. 31 shows the power output of an embodiment of a MEG device.

FIG. 32 shows morphology of GO/PVA film. (a) Surface of pristine film. (b) Cross-section of pristine film. (c) Surface of film acidified with 32% HCl. (d) Cross-section of film acidified with 32% HCl.

FIG. 33 illustrates a MEG device having a functional layer having two sub layers.

FIG. 34 illustrates a MEG device having a functional layer having two sub layers.

FIG. 35 illustrates a MEG device having a functional layer having two sub layers.

FIG. 36 illustrates a MEG device having a functional layer having two sub layers.

FIG. 36b illustrates a MEG device having a functional layer having two sub layers.

FIG. 37 shows a moisture electric generating device including two sub-layers.

FIG. 38 shows the current characteristics of various samples of electricity generating cells. The performance of the cells is measured in different humidity environments (RH %).

FIG. 39 shows the current characteristics of various samples of electricity generating cells.

FIG. 40 shows voltage characteristics against time for a first sample #1 having a silver (Ag) first electrode and a second sample #2 having a Zn plate first electrode.

FIG. 41 shows the electrical performance of various moisture electric generating devices.

FIG. 42 the voltages of electric generating devices are shown having different second sub layers.

FIG. 43 shows the voltage of moisture electric generating devices having different first sub layers.

FIG. 44 shows the voltage across the different sublayers in a moisture electricity generating cell for a cell including a GO sublayer and a cell including an acidified GO sublayer.

FIG. 45 shows the electrical performance of various moisture electricity generating cells having different top electrodes.

FIG. 46 shows the voltage results for further samples.

FIG. 47 shows the voltage of moisture electric generating devices with a single functional layer located between an Ag top electrode and a CNT bottom electrode.

FIG. 48 shows: a) schematic of HMEG with a diverse applicable condition, b) durable output performance, and c) self-restoration through absorbing ambient moisture. d) Schematic of HMEG structure. e) Long-term measurement of electrical performance of HMEG at 25° C. and 45%±10% RH. f) Radar plot showing the overall performance comparison of recently reported MEGs.

FIG. 49 shows electricity generation performance of the HMEG. a Voltage output at different RH conditions. b Electricity generation performance of HMEG at different RH conditions. c Dynamic monitoring of voltage output in response to varied RH. d Electricity generation performance of HMEG at different working conditions. e Cyclic weight measurement of HMEG with different gel contents exposed to oven (50° C., 15% RH) and ambient condition (25° C., 45% RH) for 30 min sequentially. The pristine sample was dehydrated at the oven (HT) for 30 min followed by water absorption at ambient condition (RT) to restore the water loss. f The weight and current recovery of the oven-dried (30 min) HMEGs after settling at ambient condition (25° C., 45% RH) for 1 h with different LiCl concentration. g Voltage retention of HMEG exposed to the ambient environment (30% 65% RH) for 4 months. The inset shows the enlarged curve. h Voc and Isc of HMEG under different loads at RH of 45%. i Comparison of electrical performance of the proposed HMEG with the existing MEGs.

FIG. 50 shows parameters affects the output performance. a Electric output of HMEG with different thickness of GO layer at 45% RH. b Electric output of HMEG with different concentration of LiCl at 45% RH. c EIS measurement of hydrogel with different concentration of LiCl. d Water absorption capability of HMEG-0% LiCl, HMEG-1.2% LiCl and HMEG-4.8% LiCl. e Effect of salt concentration on the weight and current output recovery of HMEGs. f Raman spectra of the hydrogels with (i) 0% LiCl and (ii) 4.8% LiCl. Analysis of the state of water within the hydrogel through tracking the O—H peaks. The peaks of 3223 and 3400 cm-1 indicate the free waters. The peaks of 3515 and 3630 cm-1 refer to the intermediate water. g Water absorption capability of HMEGs with different hygroscopic salts at 45% RH. h Electrical performance of HMEGs with different hygroscopic salts at 45% RH.

FIG. 51 shows the working principle of the HMEG. a FTIR spectrum of the hydrogels with different concentration of LiCl. b XRD analysis of the hydrogels with and without LiCl. c 2D Raman mapping of hydrogel with different concentration of LiCl to show the interior water content. d XPS etching analysis of the underlayer GO after peeling off from the hydrogel. e Voltage contribution of each component layer at 25° C. and 0% RH. f Schematic illustration on the proposed working mechanism at different conditions: (i) Ambient condition, (ii) high humidity (>65%) and (iii) low humidity (<15%). Due to the superior water absorption capability, the hydrogel starts to harvest moisture from the humid airflow. Under the dry condition, water evaporation within the hydrogel is triggered.

FIG. 52 shows demonstrations of the HMEGs. a Series of connection of HMEGs that shows the ability to scale up the voltage output. b Voltage output against the number of units, indicating a linear relationship. The insets show the generated voltage from 168 devices and the enlarged curve. c Schematic of flexible HMEGs connected in series. d 39 LEDs with “UNSW” pattern directed powered by the 168 devices connected in series. e Charging of 100 pF and 470 pF capacitors with single cell and 168 cells of HMEGs, respectively. The inset shows the circuit for the charging process. f The current response of the synaptic device driven by a pulse train (amplitude: +3V, width: 10 ms, period: 30 ms), which is powered by the charged capacitor. The inset shows the schematic of the synaptic device. g Powered commercial smart window and ink screen: i, iii before connection. ii, iv after connection.

FIG. 53 shows fabrication process of the hydrogel-based MEG.

FIG. 54 shows schematic of the interior structure of the hydrogel.

FIG. 55 shows photographs of (a-c) LiCl powder and (d-f) PVA-LiCl hydrogel before water absorption and after water absorption. (a) LiCl powder before water absorption. (b) LiCl powder after water absorption for 2 h at 45% RH and deliquescence of the salt was observed. (c) LiCl powder completely deliquesces into liquid after 24 h of water absorption. (d) PVA-4.8% LiCl hydrogel before water absorption. (e) PVA-4.8% LiCl hydrogel after water absorption for 2 h at 45% and no physical change was observed. (f) PVA-4.8% LiCl retains the initial condition after 24 h of absorption.

FIG. 56 shows a Measurement conditions in the oven (50° C., 15% RH). b Stability of the voltage output of HMEG-4.8% LiCl at 50° C. and 15% RH.

FIG. 57 shows electrical Performance of HMEG at RH of 0%.

FIG. 58 shows a Voltage and b current generation performance of the device with a sole GO layer at different RH.

FIG. 59 shows electricity generation performance of the device with a sole GO layer at RH of 0%.

FIG. 60. a The hydrogel settled at −20° C. for 40 min, 2 h, and 24 h. The hydrogel retained the original appearance, and no frozen part was observed after 1 day. b The hydrogels with 0 and 4.8% LiCl settled at 50° C. for 1 h. Smaller shrinkage was observed in the hydrogel with 4.8% LiCl.

FIG. 61. a Voltage and b current performance at the ambient conditions (25° C., 40% RH) and the oven (50° C., 15% RH).

FIG. 62. The device without LiCl was delaminated from the substrate after 1 day at room condition.

FIG. 63. Cyclic voltage and weight measurement of HMEG with 4.8% LiCl exposed to oven (50° C., 15% RH) and ambient condition (25° C., 45% RH) for 30 min sequentially.

FIG. 64. Water retention of HMEG with different concentration of LiCl.

FIG. 65. Power output of the device with connection of external resistance at RH of 45%.

FIG. 66. Long-term voltage stability of the devices without a hydrogel layer and b GO layer at room condition.

FIG. 67. a, b Effect of the hydrogel thickness on the performance of HMEG. c Electrical performance of HMEG with different electrode size.

FIG. 68. Water absorption capability of pure GO layer at 25° C. and 45% RH.

FIG. 69. Schematic illustration of the interaction between salt ions and the water molecules within the a low and b high-concentrated hydrogels

FIG. 70. Change in amount ratio of intermediate water and free water in hydrogel upon introducing LiCl salt.

FIG. 71. Voltage output of the HMEG assembled by different top electrodes: a CNT, b Ag, and c Cu at RH of 45%.

FIG. 72. XPS analysis to reveal the resistance of Li and Cl ions across the underlayer GO.

FIG. 73. a The cross-sectional SEM image of peeled-off GO layer and b the EDS mapping of Cl element. c EDS mapping index.

FIG. 74. a Photograph of the underlayer GO after peeling off the upper hydrogel layer. b Voc and Isc of the underlayer GO and pristine GO at RH of 45%.

FIG. 75. a CV curve of the HMEG under different working conditions.

FIG. 76. Photograph of a 168 units connected in series and b LEDs illumination.

FIG. 77. Photograph of 168 units connected in series under a flat and b bending states.

FIG. 78. Schematic of the circuit design of the MEG-powered E-ink display.

### DETAILED DESCRIPTION

### Single Layer MEG Devices:

In illustrative device a functional layer for a moisture electric generating battery cell is provided.

Moisture electric generating devices generate electricity on exposure to moisture due to the interaction of the materials with moisture. Ionization occurs when the H2O molecules facilitate dissociation of functional groups (—OH and —COOH) in the functional layer. Mobilized H⁺ ions are released as charge carriers for electric generation. At least some of the H⁺ ions remain mobile to provide electrical properties of the functional layer.

Moisture comprises H2O molecules. The H2O molecules may be in a liquid (water) or water vapour. The term moisture is used in this application and should be understood to refer to H2O molecules in any state.

The functional layer includes a least one composite layer including a carbon containing material and a binder. The carbon containing material may include carbon nano materials.

An example of a carbon containing material is graphene oxide. Graphene oxide (GO) is known to show high specific surface area, abundant oxygen-based groups, and good mechanical properties, which exhibits fast moisture absorption and steady electric output. Other examples of carbon containing materials include carbon nano-tubes, MXene; or Carbon Nitride (C3N4).

The binder provides interface adhesion between the functional layer and an electrode when an electrode is applied to the functional layer. The binder provides stability of the adhesion between the functional layer and the electrode. Functional layers including binders maintain good adhesion to electrodes over, for example, time periods, electrical testing, exposure to moisture. Improved adhesion provides improved mechanical adhesion between the functional layer and the electrode. Improved adhesion also provides improved electrical stability across multiple charging cycles. Without a binder, the functional layer may exhibit poor stability and reliability of electrical performance. For example, the functional layer may become detached from the electrode. The binder may be electrically conductive or non-conductive.

Binders include electrically insulating polymers. Examples of binders include: polyvinyl alcohol (PVA); polyvinyl butyra (PVB); Poly(methyl methacrylate) (PMMA); Polyvinylpyrrolidone (PVP). PVA has abundant hydroxyl group which allows moisture to be absorbed from the environment. PVA also has good viscosity, which makes it a good candidate for printing. As discussed above in relation to binders, PVA provides stable attachment of the functional layer to an electrode.

In a device, the functional layer is a composite layer including graphene oxide (GO) and polyvinyl alcohol (PVA). PVA may change the spacing between layers of graphene oxide.

The spacing between layers of graphene oxide may be increased by PVA. An increase in spacing between the layers may increase the max voltage and current of a MEG battery cell containing a composite layer of graphene oxide and polyvinyl alcohol.

The inclusion of the binder can increase the interlayer spacing of the carbon containing material, compared with the interlayer spacing of the carbon containing material without the binder. Increased interlayer spacing allows greater penetration of the moisture into the functional layer. Greater penetration of the moisture enables a greater number of H₊ ions to be disassociated. However, if the interlayer spacing is increased excessively, then the internal resistance of the functional layer is increased.

In illustrative devices, a functional layer for a moisture electric generating battery cell is provided where the functional layer includes graphene oxide having a ratio of C═O bonds to C—C bonds of more than 1:9. Examples of ratios of more than 1:9 include 2:9, 1:8, 1:5 etc. In some embodiments, the ratio of C═O bonds to C—C bonds is more than 1:8 or is more than 1:7 or is more than 1:6 or is more than 1:5. In some embodiments, the ratio of C═O bonds to C—C bonds is less than 1:1. The ratio of bonds in the functional layer may be measured, for example, using X-ray photoelectron spectroscopy (XPS).

C═O is a double bond between an oxygen atom and a carbon atom. C—C is a single bond between a carbon atom and another carbon atom.

As discussed above, the functional layer may consist of a carbon based material and a binder.

The carbon based material may be graphene oxide. The binder may be a polymer binder that is selected to bond with an electrically conductive substrate. Examples of polymer binders include one or more of: PVA, PVB, PMMA or PVP.

In embodiments, the graphene oxide and the polymer binder are a generally homogenous mixture with the graphene oxide and the polymer binder mixed in the mass ratio in the range of 100:1 to 2:1.

In an illustrative device, a functional layer for a moisture-electric generating cell is provided where the functional layer includes treated graphene oxide having an interlayer spacing that is greater than the interlayer spacing of graphene oxide from which the treated graphene oxide is prepared.

In the functional layer, the treated graphene oxide may have a ratio of C═O bonds to C—C bonds of more than 1:9. Examples of ratios of more than 1:9 include 2:9, 1:8, 1:5 etc. In some embodiments, the ratio of C═O bonds to C—C bonds is more than 1:8 or is more than 1:7 or is more than 1:6 or is more than 1:5. In some devices, the ratio of C═O bonds to C—C bonds is less than 1:1. The ratio of bonds in the functional layer may be measured, for example, using X-ray photoelectron spectroscopy (XPS).

In an illustrative example, the interlayer spacing of the treated graphene oxide is 0.799 nm.

As discussed above, the functional layer may consist of a carbon based material and a binder.

The carbon based material may be graphene oxide. The binder may be a polymer binder that is selected to bond with an electrically conductive substrate. Examples of polymer binders include one or more of: PVA, PVB, PMMA or PVP. The interlayer spacing of the treated graphene oxide may be 1.00 nm or 1.10 nm.

In an illustrative device, the functional layer comprises a plurality of sub-layers and at least one of the sub-layers has a first ratio of C═O bonds to C—C bonds and at least one of the other sub-layers has a second ratio of C═O bonds to C—C bonds and the first ratio is higher than the second ratio. Each sub-layer has a different ratio of C═O bonds to C—C bonds and the sub-layers are arranged to define a gradient in the ratio through the functional layer.

In illustrative devices, a moisture electric generating battery cell comprises a functional layer, a first electrode and a second electrode. The functional layer is disposed between and is electrically connected to the first and second electrodes. The moisture electric generating battery cell is configured to create a moisture absorption gradient across the functional layer when the moisture electric generating battery cell is exposed to moisture.

Moisture electric generation battery cells are charged by the reaction of H2O molecules with the functional layer of the moisture electric generation battery cell to create ionisation. The H2O molecules may be provided in a liquid, liquid water, or water vapour. Moisture comprises H2O molecules. During ionization, the moisture is brought into contact with the functional layer and facilitate dissociation of functional groups (—OH and —COOH) of the functional layer.

This releases mobilized H₊ as charge carrier for electric generation.

By creating a charge gradient across sides of the functional layer, for example where a top side of the functional layer has a high concentration of mobilized H₊ ions compared with the concentration of mobilized H₊ ions of a bottom side of the functional layer, a charge gradient is created across the functional layer. This charge gradient creates a potential difference across the functional layer. The mobilized H⁺ ions migrate from areas of higher H₊ ion concentration to areas of lower H₊ concentration generating electric current through the functional layer.

Since the mobilised H⁺ ions are created by the dissociation of functional groups when the functional layer is exposed to moisture, a charge gradient can be created across the functional layer by also creating a moisture absorption differential between the sides of the functional layer. For example, if a top side of a functional layer is exposed to moisture a high concentration of H⁺ are released at the top layer due to the reaction of the functional layer with the moisture. If a bottom layer of the functional layer is not exposed to moisture, or exposed to less moisture, a lower concentration of H⁺ ions are released at the bottom layer. This difference in moisture exposure across the functional layer creates a charge gradient across the functional layer and charges the MEG battery cell.

The charge gradient across the functional layer is related to the voltage output of the MEG battery cell. In general, the greater the protonation gradient across the functional layer, the greater the voltage of the MEG battery cell.

Electrical performance of the MEG battery cell can be improved by creating a moisture absorption differential across the MEG battery cell. In example embodiments, a moisture absorption differential is created across the functional layer of the MEG battery cell when the MEG battery cell is exposed to moisture. This moisture absorption differential produces a moisture absorption gradient across the functional layer. The moisture absorption differential produces an ion gradient across the functional layer when the moisture electric battery cell is exposed to moisture.

In example devices, a moisture absorption differential is achieved across the functional layer by providing the first electrode and the second electrode comprising different electrode materials. The electrodes are asymmetrical. Preferably the electrodes are asymmetrical in moisture absorption properties and so the electrodes allow different amounts of moisture to penetrate through the electrodes and to contact the functional layer.

A first electrode of the MEG device is porous to moisture. The second electrode may be impervious to moisture.

The first electrode permits moisture to penetrate through the electrode and into the functional layer. The second electrode is configured to resist the penetration of moisture through the electrode and into the functional layer. The second electrode may prevent the penetration of moisture through the electrode and into the functional layer and allow no moisture through the electrode. The second electrode may be waterproof. The second electrode may provide resistance to moisture penetration by preventing at least some of the moisture from penetrating through the electrode.

The first electrode may comprise silver nanowires or zinc, nickel, magnesium, or other metals.

The second electrode may comprise at least one of FTO, ITO, carbon nanotubes, graphene or carbon black, and MXene.

Factors used to control the absorption of moisture into a functional layer of the battery cell include the design of the electrode and the material used for the electrode.

Selection of the material used for electrodes can affect the electrical performance of the device.

Improved performance of the MEG battery device can be created when moisture can penetrate one surface of a functional layer more than another surface of the battery cell. This creates an absorption differential of moisture across the battery cell since once surface of the functional layer is exposed to, and absorbs, more moisture than another surface. The difference in moisture coming into contact with, for example, the top surface and the bottom surface creates an electrical potential across the functional layer.

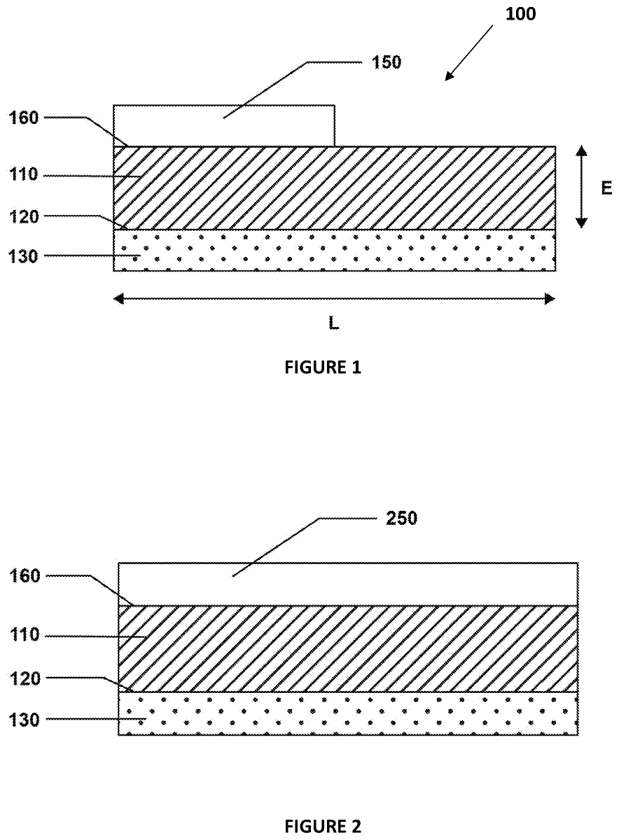

Referring now to FIG. 1, the MEG battery cell 100 includes a composite GO/PVA layer 110. This is the functional layer of the MEG battery cell. First electrode 130 is attached to a first surface 120 of the GO/PVA layer 110. Second electrode 150 is attached to a second surface 160 of the GO/PVA layer 110. In the example of FIG. 1, first surface 120 and second surface 160 are opposite faces of the composite GO/PVA layer. For the purposes of the description electrode 130 is referred to the bottom electrode and electrode 150 is referred to as the top electrode. It is clear that the orientation of the battery cell is not limiting and that these labels are used for the purposes of description only.

The GO/PVA layer 110 has a length dimension (1) and a depth dimension much greater than the dimension of the thickness (E). For example, the thickness of the GO/PVA layer is around 0.5 mm, the length is around 1 cm and the depth is around 1 cm. The surface area of surfaces 120 and 160 are large compared with the thickness.

In FIG. 1, the battery cell is configured to promote absorption of moisture into the top surface 160 of the GO/PVA layer 110 and resist absorption of moisture into the bottom surface 120 of the GO/PVA layer 110. This configuration helps to create a moisture absorption differential between the surfaces of the functional layer when moisture is applied to the battery cell. This promotes an abundance of moisture absorbed into the top surface of the functional layer 160 and lack of moisture absorbed into the bottom surface of the functional layer 120.

In FIG. 1 electrode 150 is configured to cover only a portion of top surface 160 of the GO/PVA layer. The electrode does not fully cover surface top surface 160. The remainder of the top surface of the GO/PVA layer is left uncovered. This allows direct contact of moisture onto the top surface. Larger top electrodes can result in larger current carrying capacity through the GO/PVA to electrode joint. However, if the electrode is too large then water can be prevented from escaping from the GO/PVA layer and also moisture may be prevented from contacting surface through the electrode.

In FIG. 1, the top electrode 150 is silver.

In further devices electrode 150 may cover the whole of the top surface 160 of the GO/PVA layer. Such electrodes should be moisture absorbent and allow moisture to penetrate through the electrode and onto the GO/PVA layer. Such electrodes may be porous. In one embodiment the electrode 150 comprises silver nanowires.

In FIG. 1 electrode 130 extends across the bottom surface of the GO/PVA layer. Electrode 130 covers the bottom surface of the GO/PVA layer. Examples of suitable material for the first electrode include carbon based materials, for example carbon nanotubes or graphene. Other suitable materials for the bottom electrode include FTO, ITO, MXene, Au, Pt and carbon black.

By covering the bottom surface, electrode 130 reduces the penetration of moisture into the GO/PVA layer 110 through electrode 130. Preferably electrode 130 prevents penetration of moisture into the GO/PVA layer 110. Preferred electrodes have moisture insulating properties to resist penetration of moisture into the GO/PVA layer.

Preferably, first electrode 130 has moisture insulating properties, to resist penetration of moisture into the GO/PVA layer 110. The penetration of moisture through the first electrode 130 and into the GO/PVA layer is reduced by using an electrode with moisture insulating properties. Preferably the first electrode 130 prevents the penetration of moisture into the GO/PVA layer 110 through electrode 130. In the example of FIG. 1 electrode 130 extends across the entire bottom surface of the GO/PVA layer. Examples of suitable material for the first electrode include carbon based materials, for example carbon nanotubes or graphene. Other suitable materials for the bottom electrode include FTO, ITO, MXene, Au, Pt and carbon black.

Additional resistance to moisture penetration can be provided by mounting the first electrode 130 onto a separate substrate. This can improve the moisture resistive properties of the bottom layer by requiring that any moisture penetrating the bottom layer 120 of the battery cell must first penetrate through the substrate and then penetrate through the first electrode 130 in order to penetrate into the GO/PVA layer.

In the example of FIG. 1, electrode 130 covers the surface of the GO/PVA layer 110. As shown in FIG. 1 the first electrode 130 extends across the full bottom surface of the GO/PVA layer 110. This configuration covers the entire surface from direct contact with moisture. As described above this helps reduce the penetration of moisture across the entire bottom surface of the cell.

The electrical performance of the battery cell is also improved by selecting electrode materials with suitable mechanical properties. Improved electrical performance may be achieved by using electrodes comprising a material with similar mechanical properties to the GO/PVA composite layer, for example a material having a similar thermal expansion coefficient to the composite layer. By having a similar thermal expansion coefficient, the functional layer composite layer 110 and electrode 130 tend to expand and contract proportionally. This maintains adhesion between the composite layer 110 and the electrode 130 during use. A small amount of PVA between the GO and electrodes also improves the mechanical properties. This helps prolong usage of the MEG battery cell by preventing electrical contact failure and increased resistivity of the interface between the electrode and the composite layer over time.

In FIG. 1 the first electrode is carbon nanotube. In further devices, the first electrode is graphene, having similar mechanical properties to the GO/PVA composite layer.

In devices in which the functional layer is pure graphene oxide, a small amount of PVA or other adhesive may be applied between the functional layer and the electrode to improve adhesion.

A further benefit of the first electrode 130 extending across the entire surface of the GO/PVA layer 110 is that the contact area of the GO/PVA layer 110 and the electrode 130 is increased compared with an electrode which partially extending across the GO/PVA layer. This greater contact area results in an increased surface area of the electrical joint. The greater contact area can reduce the electrical resistivity of the joint.

Preferably, the bottom electrode 130 includes one or more of the following properties: moisture repellent, waterproof, moisture proof, soft, provides good adhesion on the interface with the composite layer, flexible, lightweight, similar thermal expansion coefficient to the composite layer, good adhesion on the GO/carbon nanotube interface, highly conductive, flexible.

The considerations for the top electrode 150 are different from those of bottom electrode 130.

To produce a moisture gradient across the functional layer of the MEG battery cell, absorption of moisture into top surface of 160 of GO/PVA layer is promoted.

In FIG. 1, electrode 150 is configured to cover only a portion of top surface 160 of the GO/PVA layer. The remainder of the top surface is left uncovered and exposed to allow direct contact of moisture onto the top surface when the MEG battery cell is exposed to moisture.

Electrode 150 may be porous. Electrode 150 may be porous to moisture. Larger top electrodes, having larger contact area with the functional layer, can result in larger current carrying capacity through the GO/PVA to electrode joint. However, if the electrode is too large then water can be prevented from escaping from the GO/PVA layer and also moisture may be prevented from contacting the surface through the electrode.

Shown in FIG. 2 is a further MEG Battery Cell. FIG. 2 includes the same GO/PVA functional layer 110 and first electrode configuration 130 as described above in relation to FIG. 1. In FIG. 2, the second electrode 250 is porous. Second electrode 250 is porous to allow penetration of moisture. Second electrode 250 covers the surface 160 of GO/PVA functional layer. In further devices the second electrode may partially cover the surface 160 of the functional layer.

The porosity of electrode 250 allows moisture to penetrate through the electrode and into the top surface of GO/PVA layer 110. Consequently, larger electrodes can be used which cover a greater portion of the top surface of the GO/PVA functional layer but allow absorption of moisture into the GO/PVA layer. The moisture is absorbed into and passes through electrode 250 and into the surface of functional layer 110. Porous electrodes increase the contact area between the electrode 250 and the GO/PVA surface to help achieve higher current. In the example of FIG. 2, the second electrode 250 covers the top surface of the GO/PVA layer 160.

In FIG. 2, the electrode 250 is a silver nanowire based electrode.

More generally, examples of a porous second electrode include electrodes containing metal nanowires. Preferably, the metals should have a good resistance to corrosion and smaller work function compared with GO. The metal nanowires have a network structure so moisture can penetrate through the electrode and into the GO/PVA layer.

The top electrode is applied as an ink. Preferably the concentration of the ink includes between 0.1 wt % to 20 wt % of sliver nanowires. In an example embodiment, the ink is a 1 wt % silver nanowires ink. The ink is drop coated or gravure coated or screen coated on the MEG device.

In an illustrative embodiment, a moisture-electric generating cell is provided where the work function of one of the first or second electrodes is higher than the work function of the functional layer and the work function of the other of the first or second electrodes is lower than the work function of the functional layer, to create a work function gradient between the first electrode, functional layer and the second electrode.

Electrical performance of a moisture electric generating cell and selection of electrode material is also affected by the work function of the materials. GO has a work function of around 4.7 to 4.9 eV.

Suitable electrodes configuration can induce a Schottky barrier at the electrodes/GO interface that can match well with the direction of diffusion of protons in GO, thus enhancing the voltage output. In particular, GO has a work function around 4.7 to 4.9 eV, so a top electrode with smaller work function would prevent the recombination of electrons and protons. An example of a suitable material is zinc. Zinc which has a work function of 4.3 which is much smaller than that of GO. In an example embodiment, the top electrode is zinc foil, having a thickness of around 0.5 mm.

Preferably the bottom electrode has a work function higher than the GO/PVA layer. This creates a work function gradient across the MEG battery device from the first electrode to the GO/PVA functional layer to the second electrode.

The work function gradient may increase from the first electrode to the second electrode or increase from the second electrode to the first electrode. So the work function of one electrode is higher than the work function of the GO/PVA layer and the work function of the other electrode is lower than the work function of the GO/PVA layer. When the work function of one of the first or second electrodes is higher than the work function of the composite layer, and the work function of the other of the first or second electrodes is lower than the work function of the composite layer, a work function gradient is created between the first electrode, composite layer and the second electrode.

Preferably the electrically insulating polymer is water soluble. GO solution and binder solution are mixed with a mass ratio of 1:1 by sonication. Other mixing mass ratios could be used from 100:0 to 100:200. A 1:1 ratio is found to provide a good attachment of GO/PVA to the substrate and electrodes.

Preferably the GO and binder solution is in the form of an ink. The ink is printable.

The following description describes fabrication techniques and considerations for a Moisture-Electric Generator battery cell. The battery cell includes at least one functional layer between two electrodes. The functional layer may comprise graphene oxide. The functional layer may comprise a composite layer including a carbon containing material and binder. The carbon containing material may be Graphene Oxide (GO). The binder may be polyvinyl alcohol (PVA).

Various configurations of electrodes and substrates are described for different embodiments and fabrication techniques. The functional layer is deposited onto an electrode substrate so the bottom surface of the layer contacts the electrode substrate. A further electrode is positioned onto the top surface of the layer to complete the battery cell.

The binder improves the adhesion of the layer to the electrodes.

Other materials may be used in place of GO and/or PVA. Carbon nanotubes are an alternative to GO. Oxygen containing polymers with tuneable electric properties may be used in place of Graphene Oxide.

The functional group density of the MEG battery cell can be tuned to change the electrical properties of the MEG battery cell. Functional group density can be tuned by acid treatment. Acid treatments are described below and include immersion treatments and a vapour treatment. Acid treatment may be applied before or after the functional layer is deposited on an electrode. Acid treatment may be applied to the functional layer while the layer is in liquid form, or when the functional layer is in a film form.

In an example method, GO powder was synthesised by the oxidation of graphite powder according to the Hummers method. 20 mg/mL GO solution was obtained by dispersing GO powder in the distilled water with sonication for 30 mins. 20 mg/mL PVA solution was obtained by dissolving PVA powder (Mw 13000-23000) in distilled water at 90° C. for 30 min.

In some samples, the fluorine doped tin oxide (FTO) glass was cut into 2.5×2.5 cm² pieces and was used as substrate/bottom electrode. Other electrically conducting substrates may be used in place of FTO coated glass, for example ITO coated glass or other conductive electrode materials.

In some further devices different sized substrates/electrodes were used. In these embodiments the fluorine doped tin oxide (FTO) glass was cut into 1.0×2.0 cm² pieces and was used as substrate/bottom electrode.

FTO glass was then cleaned with ethanol and deionized water, followed by ultraviolet radiation for 30 min. The ultraviolet radiation can remove organic impurities on the substrate.

GO solution and PVA solution are mixed with a mass ratio of 1:1 by sonication. Other mixing mass ratios could be used from 100:0 to 100:10. The 1:1 can provide a good attachment of GO/PVA to the substrate.

The mixture and was dried directly onto the FTO glass at 50° C. for 12 h to form 1×1 cm² GO/PVA film. Further layers of the mixture can be applied to increase the thickness of the GO/PVA layer. Typically, further layers are deposited after the previous layer has been dried. In other embodiments the layers may be different mixtures.

The mixture may be applied to the substrate using different methods. In one example method, the mixture may be applied using spin coating or drop coating techniques. Printing techniques may also be used to apply the mixture onto the substrate, including screen printing. Printing techniques are particularly beneficial when the mixture is an ink.

The concentration of the material can be controlled. This will affect the porosity.

In other embodiments, carbon cloth is used as an electrode substrate, being electrically conductive and flexible. The carbon cloth was soaked in the GO/PVA solution for 10 mins and was dried for 12 h. Other soaking periods may be used. Different drying periods may be used.

The top electrode may be applied to the film before or after acid treatment of the MEG battery cell (described below).

There are several considerations for electrode configuration which can affect the performance of the MEG battery device, these include the moisture absorption and repellent properties of the electrodes, mechanical properties of the electrodes, work function of the electrodes. These are now discussed in relation to each electrode:

In further systems a method of preparing a functional layer for a moisture electric battery cell is provided. The functional layer is provided as a mixture. The mixture is exposed to an acid treatment. The mixture may be solution of graphene oxide. The mixture may be a mixture of graphene oxide and a polymer binder.

The acid treatment comprises applying an acid to the mixture. Preferably the acid is at least one of hydrochloric acid; nitric acid; or sulphuric acid. The acid treatment may be a liquid treatment or a vapour treatment.

Preferably, preparing the mixture comprises mixing a solution of graphene oxide. The mixture may comprise mixing a solution of graphene oxide with a solution of the polymer binder.

Exposing the mixture to the acid treatment comprises mixing a liquid acid into the mixture. The mixture is a printable solution and in one embodiment the acid treatment involves mixing acid with the printable solution before printing the functional layer onto a substrate.

In other systems, the method comprises applying the acid treatment after the mixture is applied to a substrate. The substrate may be an electrode.

The acid treatment may be applied while the mixture is in a liquid form. The acid treatment may be applied when the mixture is in a solid form, for example as a functional layer deposited onto an electrode.

In example systems, the acid used in the acid treatment has a concentration in the range 0.1 to 70 wt %. The acid used in the acid treatment may have a concentration in the range 1 to 30% to 50 wt %. The concentration of the acid may be selected based on the acid used in the acid treatment.

The acid treatment has the effect of increasing the ratio of C═O bonds to C—C bonds in the functional layer.

In embodiments, the method comprises preparing a plurality of mixtures. Each mixture comprises graphene oxide and the polymer binder and then exposing each mixture to a different acid treatment so that each mixture has a different ratio C═O bonds to C—C bonds. The different mixtures are then stacked to form the functional layer comprising a series of sub-layers and wherein the mixtures are stacked in order of the ratio of C═O bonds to C—C bonds.

The functional layer comprising a series of sublayers is positioned between a top electrode and a bottom electrode to form a MEG battery cell.

The step of preparing the mixture of graphene oxide and the polymer binder comprises dissolving water soluble graphene oxide in water to form a graphene oxide solution and dissolving water-soluble polymer binder in water to form a polymer binder solution and mixing the graphene oxide solution with the polymer binder solution.

The graphene oxide solution and the polymer binder solution are mixed in a 1:1 mass ratio.

The graphene oxide solution may comprise 10 to 30 mg/mL of graphene oxide.

The graphene oxide solution may comprise 10 to 30 mg/mL of polymer binder.

In an example, to treat the MEG, MEG battery cell was immersed in hydrochloric acid for 10 mins. Then MEG battery cell was washed with distilled water for 10 mins. MEG was then dried at 50° C. for 12 h for electrical measurement. Various samples were immersed in hydrochloric acid having different concentrations and the electrical properties of each of the samples were then tested. Hydrochloric acid having concentration of 0.5%, 1%, 16% and 32 wt % were used.

In the example, the bottom surface of the GO/PVA layer was attached to the conductive substrate. The conductive substrate is liquid resistant and so resists the acid from penetrating through the conductive substrate and onto the bottom surface of the GO/PVA layer. Thus, it is expected that the bottom surface of the layer was not directly exposed to the hydrochloric acid.

Preferably, the MEG battery cell was treated before the top electrode was applied to the GO/PVA layer. So the first electrode was applied to the GO/PVA layer and the first electrode and GO/PVA sample was treated. In this example the sample was treated with a single electrode attached only.

A benefit of applying the second electrode to the functional layer after applying the acid treatment is that during treatment the surface of the functional layer is not covered by an electrode. This means that the surface area of the film to which the acid will contact, is not reduced. Another benefit of applying the second electrode after the acid treatment has been applied is that the acid will not damage the second electrode.

In other systems the acid treatment is applied after the second electrode has been applied to the functional layer.

The method steps included: preparing a GO/PVA mixture; depositing the GO/PVA mixture onto an electrode to form a GO/PVA layer; applying the acid treatment; apply a second electrode to the GO/PVA layer.

As discussed above, in other embodiments the GO/PVA solution can be mixed with acid before applying to the substrate. In this case, the GO/PVA mixture is mixed with the acid.

The GO/PVA mixture may be an ink. The solution is then deposited onto the conductive substrate after the acid treatment.

In other example devices, multiple layers of solution may be deposited. A first layer is deposited onto the conductive substrate. After the layer is dry, a further layer is deposited on top of the first layer. After this further layer is dry, additional layers may be deposited. Depending on the required electrical properties, each layer may include the same solution or different solutions. For example a first layer may comprise a solution which has not been mixed with acid. A further layer may be deposited onto the first layer, where the further layer comprises a solution mixed with acid having a particular concentration, for example 1%. Further layers may comprise solutions mixed with different concentrations of acid. The multiple layers together form the functional layer.

In an alternative device, an alternative acid treatment technique is used. In this technique the MEG battery cell is treated by acid vapour. The acid vapour technique can be used in place of the acid immersion technique described above. Different vapour treatments may be used.

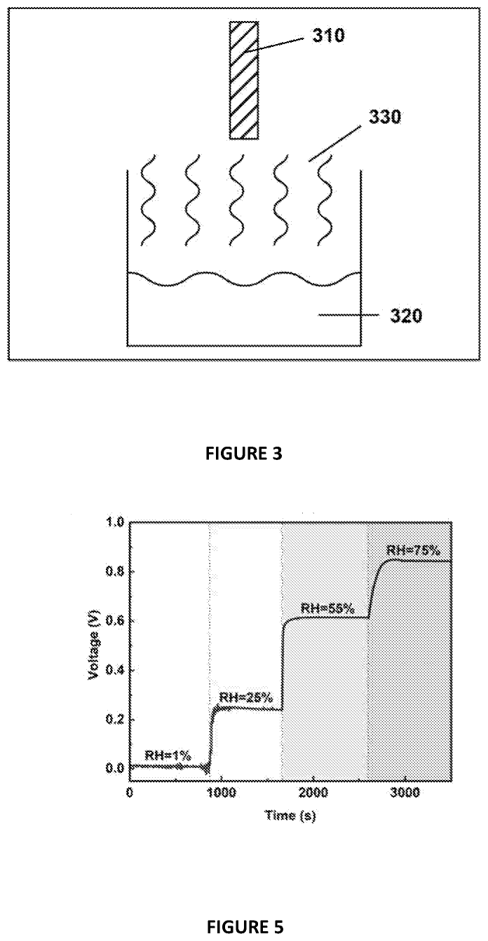

In an example device, the functional layer 310, for example the GO/PVA layer, is hanged over an HCl solution 320 as shown in FIG. 3. HCl vapour 330 is emitted from the HCl solution 320 and contacts the GO/PVA layer 310. The acid vapour is absorbed into the surfaces of the GO/PVA layer. Various procedures may be used to generate vapour from the HCl solution, for example: the MEG materials can be put on the top of HCl solution and the container is heated. For example the HCl solution may be heated from room temperature to 100 degrees C.

In FIG. 3, no electrode or substrate is shown. In further embodiments the GO/PVA layer is deposited onto an electrode before acid treatment. The electrode may be an electrically conducting substrate. The electrode may be deposited onto a substrate and the functional layer may be deposited onto the electrode before acid treatment.

Preferably, the MEG battery cell and the acid are contained within a sealed chamber to prevent escape of the HCl vapour.

Preferably the HCl solution may be 32 wt % concentration. Different concentrations of HCl solution may be used. For example, 0.5 wt %, 1 wt %, 16 wt %, 32 wt %. Concentrations may be used in the range 0.5 wt % to 36 wt %. Preferably the concentration is in the range of 20 wt % to 36 wt %. Most preferably the concentration is in the range of 30 wt % to 36 wt %.

In an example treatment the exposure time is 1 hour. Longer or shorter treatment times may be used to change the exposure time of the MEG battery cell to the HCl vapour.

After exposure to the HCl vapour the MEG battery cell is dried. For example, the battery cell may be placed in an oven for drying.

Benefits of the vapour treatment compared with the immersion technique include that liquid, in particular, water molecules from the HCl solution are less likely to penetrate into the MEG battery cell. Water molecules penetrating into the battery cell can evaporate during drying and produce cracks in the GO/PVA composite layer damaging the battery cell and reducing the electrical performance of the battery cell.

Further benefits of the vapour treatment include reduced drying times compared to immersion of the battery cell in HCl solution.

Other acids may be used to treat the functional layer. HNO3 (nitric acid) may be used. Typically nitric acid is available between 0.1 to 98 wt %. Sulphuric acid may also be used for acid treatment. Typically sulphuric acid is available between 0.1 wt % and 98 wt %.

### Statements:

In a first system, a functional layer for a moisture electric generating battery cell wherein the functional layer includes graphene oxide having a ratio of C═O bonds to C—C bonds of more than 1:9. The atomic ratio of C═O bonds to C—C bonds may be more than 1:8 or more than 1:7 or more than 1:6 or more than 1:5. The ratio of C═O bonds to C—C bonds may be less than 1:1.

C═O is a double bond between an oxygen atom and a carbon atom. C—C is a single bond between a carbon atom and another carbon atom.

The functional layer consists of graphene oxide and a polymer binder that is selected to bond with an electrically conductive substrate. The polymer binder may be one or more of: PVA, PVB, PMMA or PVP. The electrically conductive substrate forming an electrode may be mounted onto a further substrate.

In devices the graphene oxide and the polymer binder are a generally homogenous mixture with the graphene oxide and the polymer binder in the range of 100:1 to 2:1. In devices the functional layer includes treated graphene oxide having an interlayer spacing that is greater than the interlayer spacing of graphene oxide from which the treated graphene oxide is prepared. In devices the treated graphene oxide has a ratio of C═O bonds to C—C bonds of more than 1:9. The ratio of C═O bonds to C—C bonds may be more than 1:8 or more than 1:7 or more than 1:6 or more than 1:5. The ratio of C═O bonds to C—C bonds may be less than 1:1. In devices the interlayer spacing of the treated graphene oxide is 0.799 nm.

The treated graphene oxide may consist of graphene oxide and a polymer binder that is selected to bond with an electrically conductive substrate. The polymer binder may be one or more of: PVA, PVB, PMMA or PVP.

The interlayer spacing of the treated graphene oxide may be 1.00 nm or is 1.10 nm.

The functional layer may comprises a plurality of sub-layers and at least one of the sub-layers has a first ratio of C═O bonds to C—C bonds and at least one of the other sub-layers has a second ratio of C═O bonds to C—C bonds and the first ratio is higher than the second ratio. In some devices each sub-layer has a different ratio of C═O bonds to C—C bonds and the sub-layers are arranged to define a gradient in the ratio of C═O to C—C bonds through the functional layer.

In a further system a moisture-electric generating cell comprises: (a) first and second electrodes; and (b) the functional layer according to any one of the other aspects; and wherein the functional layer is disposed between and is electrically connected to the first and second electrodes.

The first electrode may be porous to moisture and the second electrode is moisture proof. The second electrode may comprise at least one of FTO, ITO, carbon nanotubes, MXene, graphene; or carbon black, or metals. The first electrode may permit moisture penetration through the first electrode and into the functional layer. Moisture comprises H2O molecules. H2O molecules may be present in liquid water or in water vapour. H2O molecules may be present in liquid water and in water vapour at the same time.

The first electrode may comprise silver or comprises zinc, nickel, aluminium, magnesium, or other metals. Preferably the first electrode may be silver nanowires. The first electrode may be partially covered silver particles, for example from silver paste.

Preferably a work function of one of the first or second electrodes is higher than the work function of the functional layer and the work function of the other of the first or second electrodes is lower than the work function of the functional layer, to create a work function gradient between the first electrode, functional layer and the second electrode.

A method of preparing a functional layer for a moisture electric battery cell comprises the steps of: (a) preparing a mixture of graphene oxide; and, (b) exposing the mixture to an acid treatment.

In a further method, a method of preparing a functional layer for a moisture electric battery cell comprises the steps of: (a) preparing a mixture of graphene oxide and a polymer binder; and, (b) exposing the mixture to an acid treatment.

In the method the acid treatment comprises applying at least one of hydrochloric acid; nitric acid; or sulphuric acid, to the mixture. The acid treatment may be a liquid treatment or a vapour treatment. In the method, preparing the mixture comprises mixing a solution of graphene oxide with a solution of the polymer binder. In the method, exposing the mixture to the acid treatment comprises mixing a liquid acid into the mixture.

In the method, the mixture is a printable solution and the acid treatment involves mixing acid with the printable solution before printing the functional layer onto a substrate. The method may comprises applying the acid treatment after the mixture is applied to a substrate.

In the method, acid used in the acid treatment has a concentration in the range 0.1 to 98 wt %. Acid used in the acid treatment may have a concentration in the range 1 to 30 wt % to 98 wt % The method may comprises preparing a plurality of mixtures, each mixture comprising a carbon based material and a polymer binder and then exposing each mixture to a different acid treatment so that each mixture has a different ratio C═O bonds to C—C bonds and then stacking the different mixtures to form the functional layer comprising a series of sub-layers and wherein the mixtures are stacked in order of the ratio of C═O bonds to C—C bonds. Preferably the carbon based material is graphene oxide.

In the method, the step of preparing the mixture of graphene oxide and the polymer binder comprises dissolving water soluble graphene oxide in water to form a graphene oxide solution and dissolving water-soluble polymer binder in water to form a polymer binder solution and mixing the graphene oxide solution with the polymer binder solution.

In the method the graphene oxide solution and the polymer binder solution are mixed in a 1:1 mass ratio. The graphene oxide solution may comprise 10 to 30 mg/mL of graphene oxide. The graphene oxide solution comprises 10 to 30 mg/mL of polymer binder.

Some systems provide a moisture electric generating battery cell comprising: afunctional layer; a first electrode; a second electrode; where the battery cell is configured to create a moisture absorption gradient across the at least one functional layer when the moisture electric generating battery cell is exposed to moisture. The first electrode and the second electrode may comprise different electrode materials. The first electrode and the second electrode have different moisture permeability properties.

The first electrode comprises at least one of FTO, ITO, carbon nanotubes, mxene, graphene; carbon nanoparticles, or carbon black. The second electrode may comprise silver nanowires/particles. The second electrode extends partially over the functional layer.

The first electrode may have moisture insulating properties, to resist the ingress of moisture into the functional layer, and the second electrode is porous and allows moisture penetration through the second electrode and into the functional layer.

A functional layer for a moisture electric generating battery cell may comprise at least one composite layer including a carbon containing material and an binder. The binder may be water soluble. The binder may be polyvinyl alcohol (PVA).

The carbon containing material may be graphene oxide.

The binder may facilitate the functional layer binding to at least one electrode. The binder may be electrically conductive. The binder may be electrically non-conductive.

The system may provide a moisture electric generator battery according to any preceding statement wherein the work function of one of the first or second electrodes is higher than the work function of the composite layer and the work function of the other of the first or second electrodes is lower than the work function of the composite layer, to create a work function gradient between the first electrode, composite layer and the second electrode.

The system may provide an electronic device powered by a moisture electric generating cell comprising a functional layer according to any preceding statement. Preferably the electronic device is configured to have a surface positioned in contact with the skin of a subject when in use. Preferably the electronic device is at least one of a sensor; a memory; or a radio transceiver.

The system may provide a battery pack comprising multiple connected moisture generator battery cells comprising functional layers according to another aspect, the moisture generator battery cells may be stacked.

The system provides an electronic device powered by at least one moisture electric generator battery cell according to another aspect.

A moisture electronic battery generator is configured to have one surface positioned in close contact with a wearer's skin. The electronic device may comprise at least one of: a sensor; a memory; and/or a radio transceiver.

A method provides a method for manufacturing a moisture electric generator battery cell comprising the steps of depositing at least one layer of a mixture of a carbon containing material and a binder onto a substrate, the substrate being a first electrode, drying the layer of the mixture and applying a second electrode so the layer is positioned between the electrodes.

A system provides a moisture electric generator battery cell comprising at least one composite layer including a carbon containing material and a binder. The inclusion of a binder has the advantage that it increases the adhesion properties of the layer to a substrate in the battery cell. This can improve the voltage stability of the battery cell. Increased adhesion properties can also improve the current stability of the battery cell. The substrate may be an electrode. The binder may be is a water soluble binder. Preferably the binder does not dissolve in acid.

The layer thickness can be gradually changed by varying the amount of carbon nano material and water soluble binder.

The carbon containing material may be a carbon nano material. The carbon containing material may be organic carbon material. Preferably the carbon containing material is graphene oxide (GO). Graphene oxides (GO) show high specific surface area, abundant oxygen-based groups, and good mechanical properties, which exhibits fast moisture absorption and steady electric output. GO can be modified with oxygen-based groups or inner structure to further improve its electric output. This provides tuneable electrical properties. Graphene oxide has the advantage that it is non-toxic.

Preferably the binder is polyvinyl alcohol (PVA). PVA has abundant hydroxyl group which allows moisture to be absorbed from the environment. Absorption of moisture from the environment absorbs H₊ ions which induces potential. PVA also has good viscosity and also improves the attachment of film to a substrate. The improved attachment produces a stable battery having steady electric output across multiple charging cycles. The battery cell provides good voltage retention. PVA can change the spacing between layers of graphene oxide. The spacing between layers of graphene oxide may be increased by PVA. The increase in spacing between the layers may increase the max voltage and current of the battery cell.

Preferably the layer of carbon nano material and water soluble binder comprises a solution of carbon nano material and solution of water soluble binder mixed with a mass ratio of 1:1. The mixture is an ink. The mixture is stable. The mixture can be solution processed. The mixture applied to a substrate using different techniques, including printing and coating techniques.

Preferably the battery cell comprises a first electrode and a second electrode, the at least one layer of a carbon nano material and a water-soluble binder being positioned between first electrode and second electrodes. Electrodes can be deposited using techniques including physical vapour deposition (for example sputtering) or solution processed techniques (for example printing). First and second electrodes may be composed of different materials. Preferably electrically conductive materials.

Preferably the at least one layer is mounted on a substrate. The substrate may comprise the first electrode. This allows the layer of the battery cell to be applied directly onto the bottom electrode. This reduces the size of the battery cell. Preferably the substrate is fluorine doped tin oxide (FTO) glass. Other electrode substrates may be used including ITO coated glass.

The substrate is a flexible substrate, for example carbon cloth. Use of flexible substrates produces flexible battery cells. Flexible battery cells provide opportunities for devices requiring flexibility, for example wearables, IoT devices, electronic skin patches.

The substrate may be stretchable. This can enable battery cells to be used for stretchable electronics.

Preferably the second electrode covers a portion of surface of the layer of carbon containing material and the binder. Preferably the second electrode does not completely cover the surface of the layer. This allows at least part of the layer to be exposed and treatable.

Preferably the at least one layer having at least one of the following properties: moisture stable; cyclable electrical properties, this allows the battery cell to be charged, discharged and recharged; adhesive to a substrate; adhesive to an electrode; solution processable, for example printing and coating techniques; vapour deposition techniques, for example sputtering.

Preferably the at least one layer of a carbon containing material and a binder is treatable to change the oxygen based functional groups in the at least one layer. Changing the oxygen based functional groups can increase the ability of the layer to absorb H₊ ions. Preferably, the change in functional groups is an increase in the number of C═O bonds in at least one layer. The increase in the number of C═O bonds can allow an increase in the number of H₊ ions absorbed by at least one layer. This can increase the voltage and/or current produced by the battery cell.

The layer may be treated before being applied to the substrate. The carbon containing material and the binder are mixed with hydrochloric acid before being applied to the substrate. This can produce a generally homogenous distribution of C═O bonds within a solution containing the carbon containing material and binder. When deposited on the substrate, the layer of carbon containing material and binder includes a generally homogeneous distribution of C═O bonds.

Preferably the at least one layer is formed by depositing the composite carbon containing material and binder onto the substrate and then drying, wherein the treatment of the layer to change the oxygen based functional group in the layer is performed by treating the carbon containing material and binder before depositing it onto the substrate. Preferably the carbon containing material and binder is in the form of an ink

The layer may be treated after being applied to the substrate. The layer has a first surface and a second surface wherein the layer is treated on the first or the second surface. The advantage of treating one surface of the layer is that the functional groups at the treated surface are changed. This can create a gradient in the functional groups across the layer. The increase in gradient of functional groups increases the gradient in ability to absorb H₊ ions. Thus, when exposed to H₊ ions, this may increase the potential of the battery cell.

Preferably the layer is treated by acidification. Preferably the layer is treated by hydrochloric acid (HCl) acidification. HCl acidification increases the number of C═O bonds. HCl acidification decreases the resistivity of the layer.

The battery cell may include multiple layers of carbon containing materials and binders. Each layer may undergo different treatments. For example, layers may be treated with acids having different concentrations. The different concentrations may produce different amounts of C═O bonds in the layer.

Preferably at least one layer is a film. Preferably the moisture absorbing properties of the first and second electrodes are different. Preferably the layer is applied to the substrate by at least one of the following techniques: spin coating, spray coating, dip coating, drop coating, slot die coating, nanoimprint, ink-jet printing, spray printing, intaglio printing, screen printing, flexographic printing, offset printing, stamp printing, gravure printing and aerosol jet.

The viscosity of the mixture is controllable to facilitate different application processes. The concentration of GO can be changed and organic materials, such as PVA, can be added to improve its application properties and adhesion on different substrates. The viscosity can also be controlled by adding different amounts of organic materials, such as PVA.

Preferably the concentration of hydrochloric acid is between 0.1 to 32 wt %. Preferably the concentration is 32 wt %. 32 wt % produces good electrical properties for the battery cell. Other concentrations of hydrochloric acid may be used. Hydrochloric acid having concentration of 1% has been found to produce stable electric properties over multiple charge and recharge cycles.

Embodiments have a voltage output and a current output wherein at least one of the voltage output and current output is increased upon treating the at least one layer.

The interlayer spacing of the at least one layer is increased by treating and increases at least one of the voltage output or the current output of the battery cell. Typically, the GO nanosheet exhibits a multilayer structure, and its interlayer spacing can be tuned to realise different physical and chemical properties.

In a further system a moisture electric generator battery cell comprises at least one layer including a carbon containing material, wherein the layer is treated to change the oxygen based functional groups in the layer. Changing the oxygen based functional groups can increase the ability of the layer to release H₊ ions. Preferably, the change in functional groups is an increase in the number of C═O bonds in at least one layer. An increase in the number of C═O bonds can allow an increase in the number of H₊ ions absorbed by the at least one layer. This can increase the voltage and/or current produced by the battery cell.

Preferably the layer is treated after being applied to the substrate. Preferably the at least one layer is formed by depositing the carbon containing material onto the substrate and then drying, wherein the treatment of the layer to change the oxygen based functional group in the layer is performed by treating the carbon containing material before depositing it onto the substrate to form the layer. Preferably the layer is an ink and the layer is treated by mixing acid with the ink before depositing the layer onto the substrate. Preferably the layer includes a binder.

In a further system a battery pack comprises multiple moisture generator battery cells according to the first or second aspects. In embodiments, the moisture generator battery cells are stacked. In embodiments, the moisture generator battery cells are connected in series.

In embodiments the moisture generator battery cells are connected in parallel. Embodiments may include moisture generated battery cells including series and parallel electrical connections between cells.

In a further system an electronic device powered by one or more moisture electric generator battery cells of the first aspect or the second aspect. Preferably, the moisture electronic generator battery cell is configured to have one surface positioned in close contact with the wearer's skin. Preferably, the electronic device further comprising at least one of: a sensor; a memory; and/or wireless communication component/module.

In a further system a method for manufacturing a moisture electric generator battery cell comprising the steps of depositing at least one layer of a mixture of a carbon containing material and a binder onto a substrate, the substrate being an electrode, drying the layer of the mixture and applying a further electrode so the layer is positioned between the electrodes. The first electrode may be applied to a substrate.

Preferably the second electrode is applied to a portion of the second surface of the layer. Preferably the second electrode does not completely cover the surface of the layer. This allows at least part of the layer to be exposed and treatable.

Preferably the carbon nano material is graphene oxide (GO). Preferably the water soluble binder is polyvinyl alcohol (PVA). Preferably the solution is a mixed solution of GO and PVA in a 1:1 mass ratio.

Preferably the method includes the further step of treating the layer of a carbon nano material and a water soluble binder to increase the number of C═O bonds in the at least one layer. Preferably the layer is treated by acidification. Preferably the acidification is HCl.

The method the step of depositing is performed by at least one of the following techniques: spin coating, spray coating, dip coating, drop coating, slot die coating, nanoimprint, ink-jet printing, spray printing, intaglio printing, screen printing, flexographic printing, offset printing, stamp printing, gravure printing and aerosol jet.

Preferably the moisture electric generator battery cell having a voltage output and a current output wherein at least one of the voltage output and current output is increased upon treating the at least one layer.

The method wherein the first electrode is a material with similar mechanical properties to the composite layer. The method wherein the first electrode comprises a material having a similar thermal expansion coefficient to the composite layer. The method wherein the first electrode comprises carbon nanotubes.

Preferably the first electrode includes at least one of the following properties: waterproof, soft, provides good adhesion on the interface with the composite layer, flexible, lightweight. Similar structure and expansion coefficient to GO so good adhesion on the GO So electrical resistivity of the connection is low to increase conductivity during operation.

Preferably the work function of one of the first or second electrodes is higher than the work function of the composite layer, and the work function of the other of the first or second electrodes is lower than the work function of the composite layer, to create a work function gradient between the first electrode, composite layer and the second electrode.

The method wherein the second electrode has a work function lower than the work function of the composite layer. The method wherein the second electrode has a work function lower than the work function of the composite layer, and the composite layer has a work function lower than the first electrode.

The method wherein the second electrode comprises a porous material. Preferably the second electrode comprises a material that allows water penetration. Preferably the second electrode comprises silver nanowires.

The method wherein the second electrode comprises zinc.

Applications for the moisture electric generator battery cells include power sources for thin film transistors, memory device (for example RRAM, memristors), large area electronics, IoT devices, sensors, wearable devices, electronic skin patches.

A moisture electric generator battery cell wherein the first electrode has moisture insulating properties, to resist ingress of moisture into the layer.

A moisture electric generator battery cell wherein the first electrode prevents ingress of moisture through the first electrode and into the layer.

A moisture electric generator battery cell wherein the first electrode substantially covers a first surface of the layer.

A moisture electric generator battery cell wherein the first electrode may comprise a carbon based conductive material. The first electrode may comprise carbon nanotubes, or graphene, or carbon black.

A moisture electric generator battery cell wherein electrode is a material with similar mechanical properties to the composite layer. A moisture electric generator battery cell wherein the electrode comprises a material having a similar thermal expansion coefficient to the composite layer.

A moisture electric generator battery cell wherein the electrode comprises carbon nanotubes.

Preferably the electrode includes at least one of the following properties: waterproof, soft, provides good adhesion on the interface with the composite layer, flexible, lightweight. Similar structure and expansion coefficient to GO so good adhesion on the GO/carbon nanotube interface. So electrical resistivity of the connection is low to increase conductivity during operation.

A moisture electric generator battery wherein the second electrode is in contact with a second surface or the layer. A moisture electric generator battery wherein the second electrode has a work function lower than the work function of the composite layer. A moisture electric generator battery wherein the second electrode has a work function lower than the work function of the composite layer, and the composite layer has a work function lower than the first electrode. A moisture electric generator battery wherein the second electrode comprises a porous material. Preferably the second electrode comprises a material that allows water penetration. Preferably the second electrode comprises silver nanowires.

A moisture electric generator battery wherein the second electrode comprises zinc.

### Section 1: Samples and Results

The following Section 1 describes a first series of samples and results:

### Materials

GO powder was synthesised by the oxidation of graphite powder according to the Hummers method. 20 mg/mL GO solution was obtained by dispersing GO powder in the distilled water with sonication for 30 mins. 20 mg/mL PVA solution was obtained by dissolving PVA powder (Mw 13000-23000) in distilled water at 90° C. for 30 min.

### Fabrication of MEG

The FTO glass was cut into 2.5×2.5 cm² pieces and was used as substrate/bottom electrode. Other electrically conducting substrates may be used in place of FTO coated glass, for example ITO coated glass or other conductive electrode materials.

GO solution and PVA solution are mixed with a mass ratio of 1:1 by sonication. Other mixing mass ratios could be used from 100:0 to 100:10.

The mixture and was dried directly onto the FTO glass at 50° C. for 12 h to form 1×1 cm² GO/PVA film. Further layers of the mixture can be applied to increase the thickness of the GO/PVA layer. Typically, further layers are deposited after the previous layer has been dried.

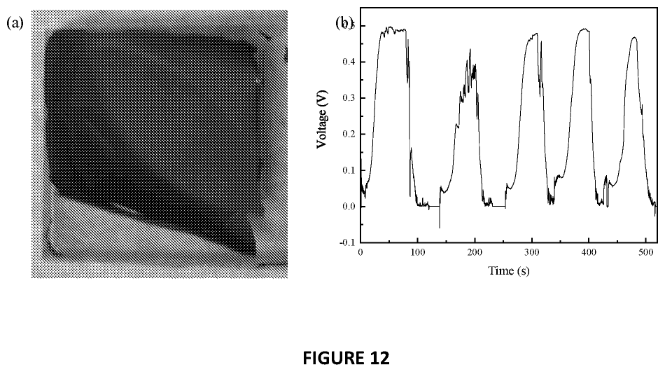

The rest exposed area of FTO glass was cover by the insulative tape and spread Ag paste as the top electrode. This process is described in more detail below with reference to FIG. 12.

In an alternative embodiment carbon cloth is used as an electrode substrate, being electrically conductive and flexible. The carbon cloth was soaked in the GO/PVA solution for 10 mins and was dried for 12 h.

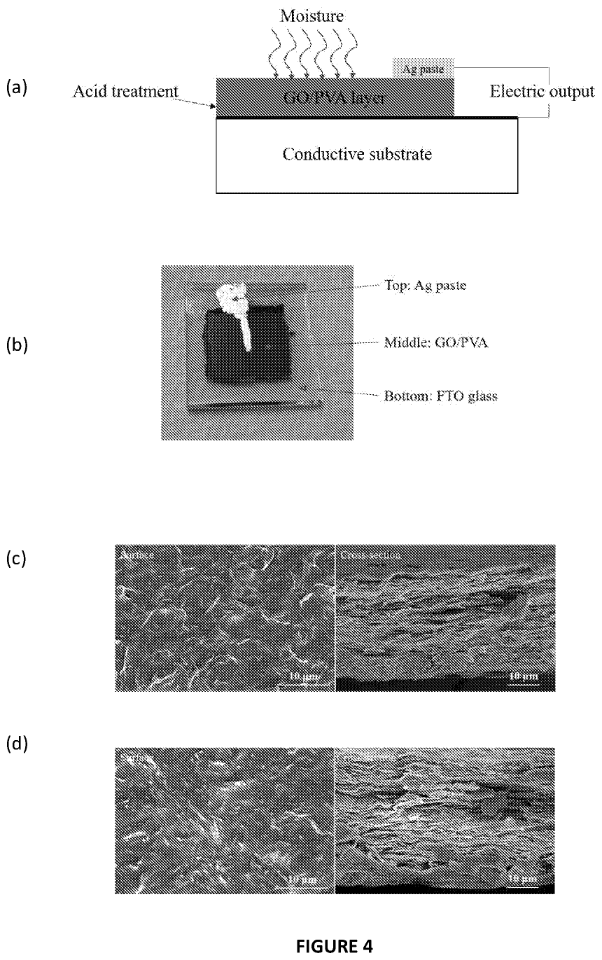

FIG. 4(a) shows a schematic cross-sectional representation showing the structure of a MEG battery cell. FIG. 4(b) shows a photograph of the MEG battery cell after acid treatment. GO/PVA layer is deposited onto conductive substrate so the bottom surface of the GO/PVA layer contacts the conductive substrate. In the example described above the conductive substrate is FTO coated glass. A top electrode is applied to the top surface of the GO/PVA layer. In the example the top electrode is Ag paste.

FIG. 12(a) shows the steps for applying the second (top) electrode onto the GO/PVA layer of the battery cell. FIG. 12(a) represents a top view of a sample for which GO/PVA film has been deposited onto FTO glass substrate and acidified. In the example of FIG. 12(a) the GO/PVA film partially covers the FTO glass substrate. In other embodiments the film may completely cover the substrate. In other embodiments the film may cover other proportion of the substrate.

Insulation is applied over part of the exposed substrate. The top electrode is then deposited onto the top layer of the film. The top electrode is insulated from the bottom electrode to avoid short circuiting the battery cell. In the example of FIG. 12, silver (Ag) paste is used for the top electrode.

The rest exposed area of FTO glass was cover by the insulative tape and spread Ag paste as the top electrode. This process is described in more detail below with reference to FIG. 12.

### Acid Treatment of MEG

The treat the MEG, MEG battery cell was immersed in hydrochloric acid for 10 mins. Then MEG battery cell was washed with distilled water for 10 mins. MEG was then dried at 50° C. for 12 h for electrical measurement. Various samples were immersed in hydrochloric acid having different concentrations and the electrical properties of each of the samples were then tested. Hydrochloric acid having concentration of 0.5%, 1%, 16% and 32 wt % were used.

Since the bottom surface of the GO/PVA layer was attached to the conductive substrate, it is expected that the bottom surface of the layer was not directly exposed to the hydrochloric acid.

An advantage of treating the MEG battery cell before applying the top electrode to the film is that after applying the top electrode to the film, the surface area of the film attached to the top electrode is protected from the acid treatment. Meaning that the surface area of the film to which the acid will contact, and change the oxygen groupings, is reduced. Acid will not make contact with that part of the surface connected to the top electrode.

### Electrical Test

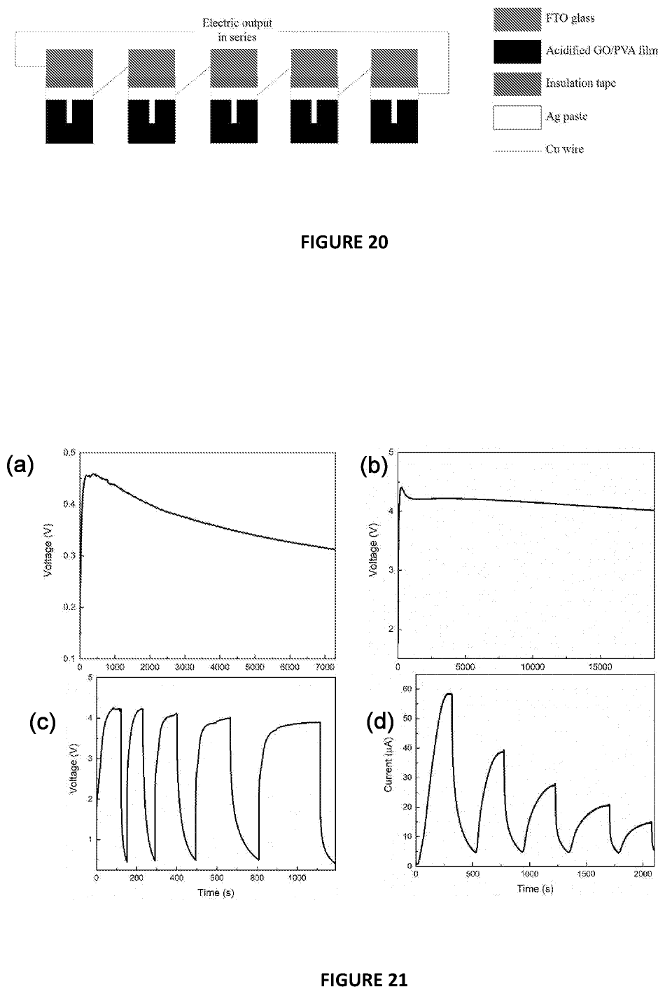

As an example, the top and bottom electrodes of MEG were connected to a precision source/measure unit for electric output measurement (FIG. 20(b)). In the example, a Keysight B2902A measurement unit was used.

Electrical measurements were taken on the battery cell in environments having different relative humidity (RH). Wet N₂ and dry N₂ were used to control the RH in the sample chamber. For electric retention measurement, moisture was input by wet N₂ to increase the RH (up to 75% RH) and electric output until it reached highest value and was stopped for retention measurement. For the measurement of an electric cycle, moisture was input by wet N₂ to increase the RH and electric output until it reached highest value and was eliminated by dry N₂ (Up to 0% RH) to decrease the RH and electric output until it reached the lowest value. The voltage and current output of multiple battery cells were measured by connecting the battery cells in series and parallel. Measurements are shown in FIG. 5 for the voltage retention for a battery washed in 32% HCl at 1%, 25% and 55% relative humidity. This shows that as the relative humidity increases, voltage output by the MEG battery cell increases.

### Result and Discussion

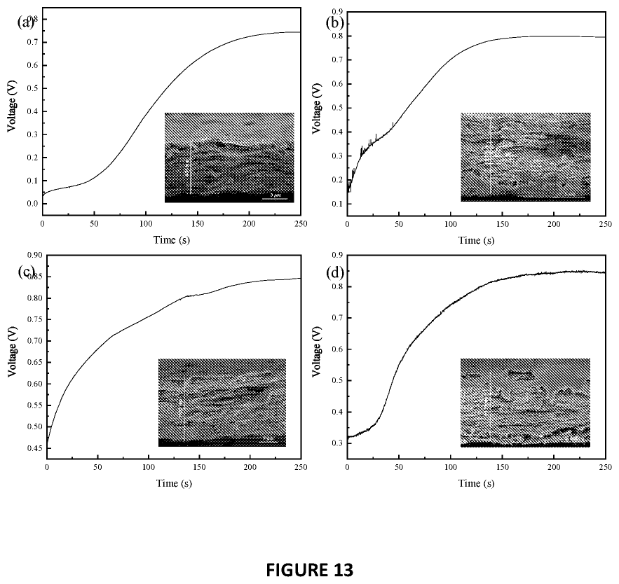

FIG. 4a shows the structure illustration of MEG, which is a relatively simple structure for the electric generation. The device photo in the FIG. 4b exhibits uniform surface and good attachment of GO/PVA film on the FTO glass compared with the GO film in FIG. 13a, which shows weak attachment and wrinkle. The morphology of GO/PVA films with a thickness of 15.53 μm after HCl acidification (FIG. 4d) shows smooth surface and dense layer-structure due to the addition of PVA, which is similar with the morphology of GO/PVA film before acid washing (FIG. 4c). The intact and uniform morphology of GO/PVA films contributes to the stable electric output in the long-term use.

The voltage output of GO/PVA film acidified by 32 wt. % HCl was recorded at different RH (FIG. 5). The max voltage of MEG is 0.01 V (Relative Humidity (RH)=1%), 0.25 V (RH=25%), 0.61 V (RH=55%), respectively. Thus, MEG shows almost no voltage output at RH=1% and increased voltage output at higher RH, which demonstrate that RH is closely related to the electric generation. The higher RH contributes to more absorbed water and greater H⁺ gradient in MEG, which leads to higher voltage output.

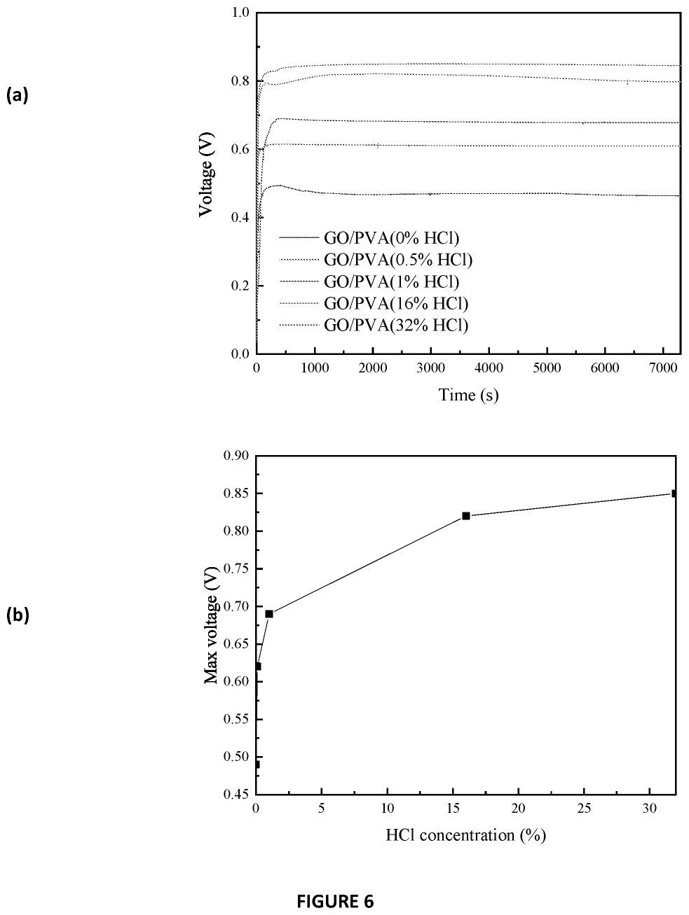

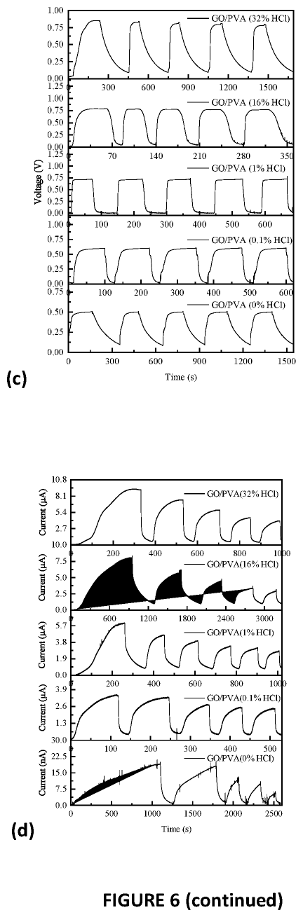

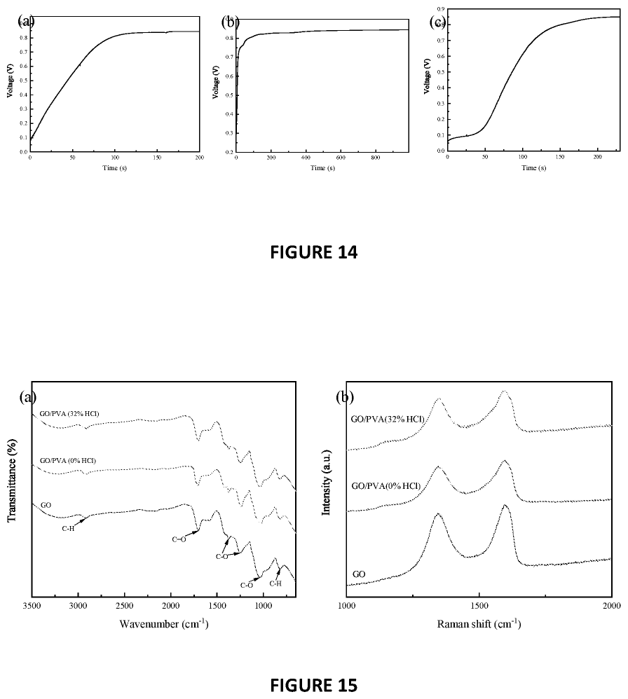

The voltage output of GO/PVA film acidified by HCl solution at different concentrations is shown in FIG. 6b. The max voltage increases with thickness (0.74 V, 0.8 V and 0.85 V for the films with a thickness of 6.21 μm, 12.23 μm, 15.53 μm, respectively) and shows no obvious increase for the films thicker than 15.53 μm (FIG. 13). The thin films facilitate water permeation and decrease H⁺ gradient across the Go/PVA layer, which leads to lower voltage output. Besides, GO/PVA films with different areas (0.5×0.5 cm², 1.0×1.0 cm², 1.5×1.5 cm²) show similar max voltage value (FIG. 14), which demonstrates that voltage is related to the charged ion gradient instead of film area and high voltage can be generated with very small area.

Voltage retention can be utilised to evaluate the long-term performance of the device (FIG. 6a). The voltage of GO/PVA film increases after exposing the film to the moisture and shows no obvious degradation over 2 h (RH=75%). These results exhibit better electric performance in generating stable and persistent voltage output compared with the performances in other GO-based MEG.

The max voltage of GO/PVA increases with HCl concentration and increases slowly when HCl concentration is higher than 16%. The max voltage of GO/PVA film without HCl acidification is about 0.49 V, which is almost same with the GO film without HCl acidification (FIG. 6b). The max voltage of GO/PVA film acidified with 32% HCl is 0.85 V, which is much higher than the max voltage of film without HCl acidification (0.49 V). Thus, the voltage output of acidified GO/PVA films is closely related to the HCl concentration. HCl acidification can be employed as a facile and effective approach to greatly improve the voltage output of GO/PVA film.

The voltage cycles of GO/PVA films have also been investigated to evaluate the stability of MEG (FIG. 6c). The voltage cycles of GO film (FIG. 12b) are not as stable as GO/PVA film because PVA can provide a stable structure and good attachment of film to the substrate. GO/PVA films show similar voltage output in each cycles and same max voltage output, which demonstrates the GO/PVA films can generate stable voltage output.

FIG. 6d exhibits short-circuits current (I_{sc}) of GO/PVA films, which increases with the concentration of HCl (I_{sc}=9.28 μA, 8.32 μA, 6.05 μA, 3.51 μA, 19.71 nA for films acidified with 32%, 16%, 1%, 0.5%, 0% HCl, respectively). The max current of GO/PVA films acidified with 32% HCl is about 9.28 μA and is significantly higher than the max current of films without HCl acidification (19.71 nA), which results from the resistance decrease after H⁺ introduction in HCl acidification. The GO/PVA films are supposed to be non-conductive due to the large amount of functional groups attached to the carbon plane. However, the resistivity of GO/PVA film after acidification with 32% HCl decreased to 0.9-1.2 MΩ, which is beneficial for better electric performance.

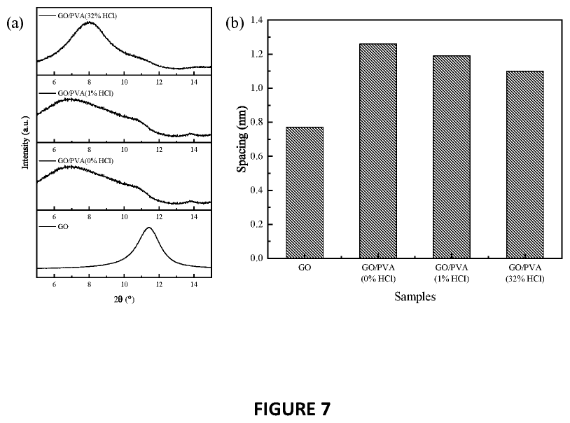

The diffraction peak of GO/PVA film shows a lower angle than that of GO films and shifts to the higher angle after increasing HCl concentration (FIG. 7a). The interlayer spacing of GO/PVA film can be calculated with diffraction angle (FIG. 7b).

The GO/PVA films shows a higher interlayer spacing than GO films, where spacing is 0.77 nm for GO film, 1.26 nm for GO/PVA film, 1.19 nm for GO/PVA (1% HCl) film, 1.10 nm for GO/PVA (32% HCl) film. The polymer molecules of PVA may enter into the interlayer of GO, where carboxyl groups from GO may react with hydroxyl groups in the crosslinking. The crosslinking between the GO and PVA bridges the adjacent GO sheets and enlarge interlayer spacing, which may explain GO/PVA films shows a higher interlayer spacing than GO films.

Besides, the spacing of GO/PVA films decreases after HCl acidification. The shortened spacing of GO/PVA film acidified with HCl may result from the charged ions (H⁺) induced by HCl acidification as H⁺ can be absorbed by the oxygen-based groups and inhibit crosslinking of GO and PVA. The FTIR spectra of GO/PVA film and GO/PVA (32% HCl) film are almost the same with the spectra of GO films (FIG. 15a). Due to the addition of PVA, the Raman spectra of GO/PVA film and GO/PVA (32% HCl) film are flatter than the spectra of GO films (FIG. 15b), which demonstrates that PVA is not washed off by the distilled water or HCl in our work.

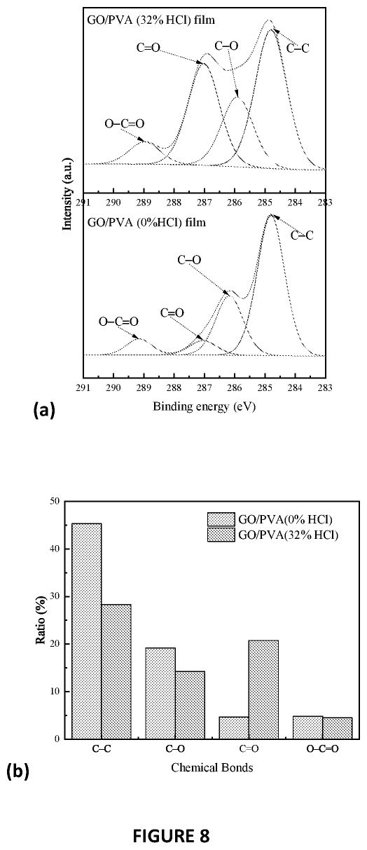

The oxygen-based functional groups are closely related to the moisture absorption and electric generation, which can be characterised with C 1s region in XPS. To investigate the effect of HCl acidification on the change of functional groups for the increased voltage output, the GO/PVA films with and without HCl acidification are analysed with in FIG. 8. The C 1s peaks in the GO/PVA (0% HCl) with binding energy of 284.8 eV, 286.2 eV, 287.0 eV, 289.2 eV represent C—C (45.29 at. %), C—O (19.18 at. %), C═O (4.67 at. %), O—C═O (4.84 at. %). The C is peaks in the GO/PVA (32% HCl) with binding energy of 284.8 eV, 285.9 eV, 287.0 eV, 289.0 eV represent C—C(28.30 at. %), C—O (14.26 at. %), C═O (20.75 at. %), O—C═O (4.49 at. %). Thus, the ratio of C—O bond decreases after HCl acidification, while the ratio of C═O bond increases after HCl acidification. The C/O ratio in the GO/PVA films decreases from 2.96 to 2.12 after 32% HCl acidification, which demonstrates an acid oxidization occurs in the acid washing. In HCl acidification, epoxy groups can be arranged in a line, which leads to the rupture of C—C bonds. The epoxy chain tends to be oxidized into epoxy pairs and convert into carbonyl pairs as carbonyl groups are more stable in this conditions. The C═O with stronger polarity are stronger than C—O in attracting H⁺ and forming hydrogen bonds. Thus, the higher voltage output could be attributed to more C═O bonds, which can attract more H⁺ for electric potential generation.

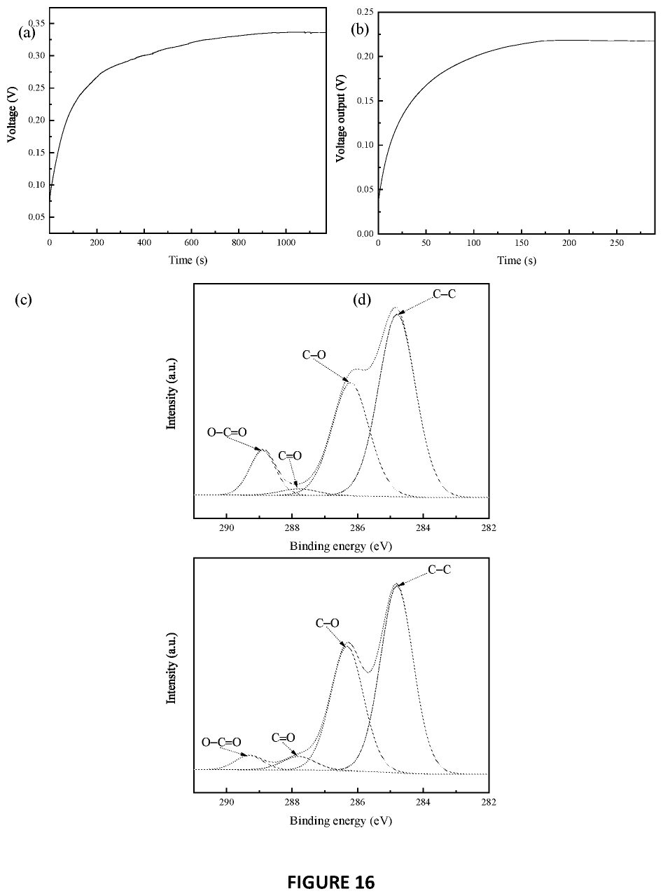

The oxygen-based groups in GO/PVA films washed with acetic acid and NaOH are also investigated in FIG. 16c and FIG. 16d, respectively. The GO/PVA films washed with acetic acid show C—C (35.96 at. %), C—O (22.28 at. %), C═O (1.27 at. %), O—C═O (6.13 at. %), while GO/PVA films washed with NaOH show C—C(37.86 at. %), C—O (25.24 at. %), C═O (2.74 at. %), 0-C═O (2.47 at. %). The max voltage of GO/PVA films washed with acetic acid and NaOH is 0.34 V and 0.22 V, respectively, which is relatively lower than max voltage of films acidified with HCl as the ratio of C═O in GO/PVA films washed with acetic acid and NaOH is lower. Thus, the ratio of C═O is related to the voltage output of GO/PVA films. Moreover, the higher C/O ratio in the acidified films contributes to the lower resistivity of GO/PVA films, which significantly enhances the current output (19.71 nA to 9.28 μA for one unit after acidification). Besides, the peak of C—O and O—C═O shifts slightly to the lower binding energy after HCl acidification.

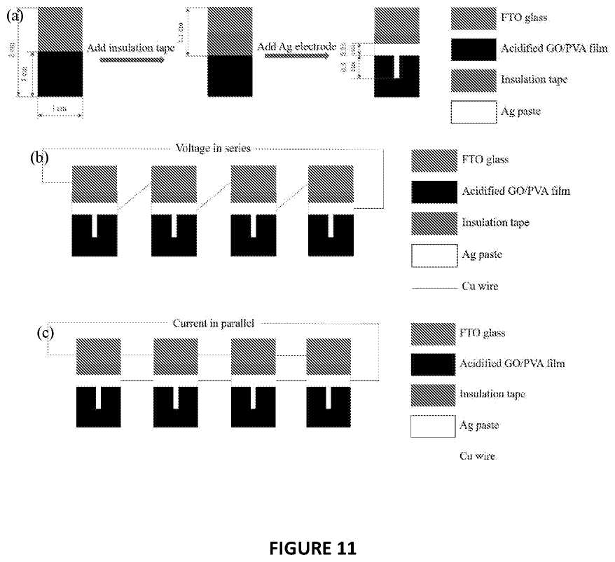

The GO/PVA MEG battery cells can be connected directly in series or in parallel to improve output of voltage or current. The schematic figures of FIGS. 11(b) and (c) show four battery cells connected in series for voltage measurements and four battery cells connected in parallel for current measurement, respectively.

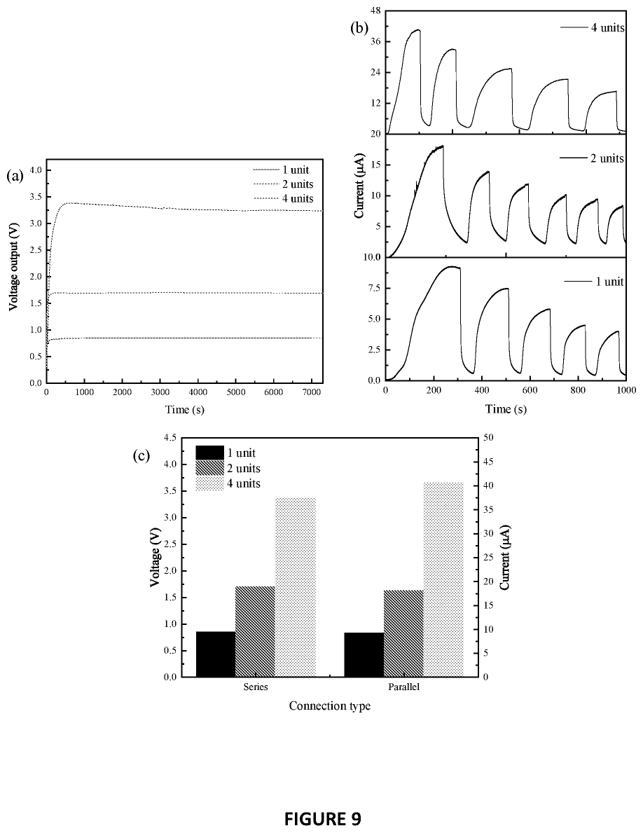

The voltage of two and four units in series show a good retention over 2 h without obvious decrease (FIG. 9a). The max voltage of units is 0.85 V, 1.70 V, 3.38 for one unit, two units, four units, respectively (FIG. 9c). The units in parallel also exhibit enhanced current output with more units involved (FIG. 9b). The max current of units is 9.28, 18.16, 40.69 for one unit, two units, four units, respectively. Thus, the voltage and current of MEG battery cells increases linearly with the output of one unit, which demonstrates a potential application in generating high electric output by simple assembly of units (battery cells).

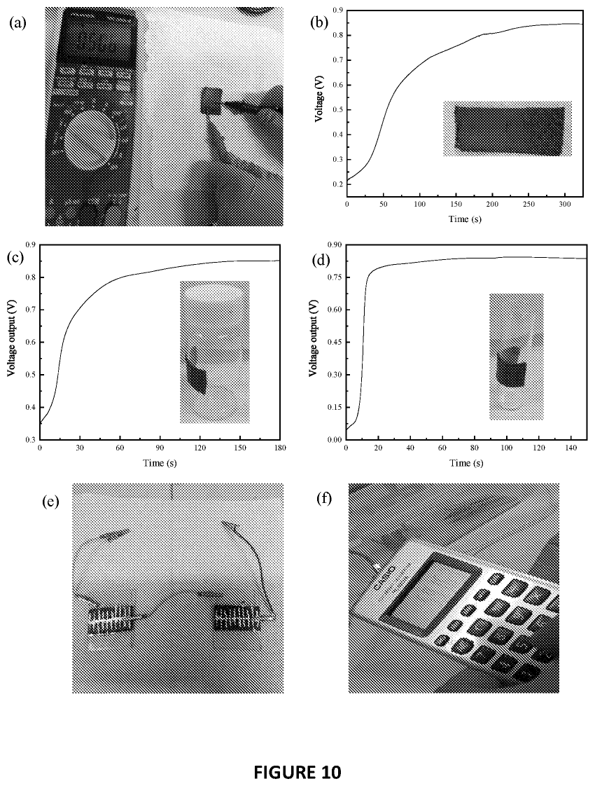

The GO/PVA films with 32% HCl acidification are also fabricated on the carbon cloth for the application of flexible device. The voltage of the film (1×1 cm²) can reach 0.506 V (FIG. 10b) in the room humidity (RH=45%).

The GO/PVA films are attached to the glass bottle with different radii to investigate the effect of film curvature on the voltage output of GO/PVA films. The voltage of films with different curvatures increases to max value in 150-300 s. The max voltage is 0.83 V, 0.85 V, 0.84 V for the films with a curvature of 0 cm⁻¹, 0.5 cm⁻¹, 1.0 cm⁻¹, respectively (FIG. 10b-10d). Thus, the voltage output of GO/PVA films with acidification on the carbon cloth shows stable voltage output on the surface with different curvature, which demonstrate a great potential in the fabrication of flexible device.

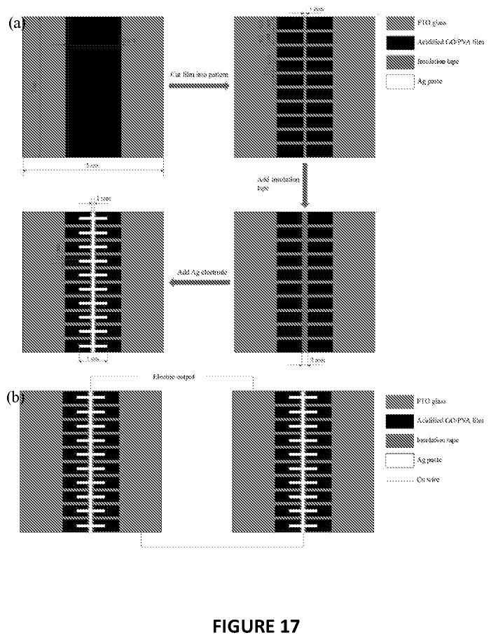

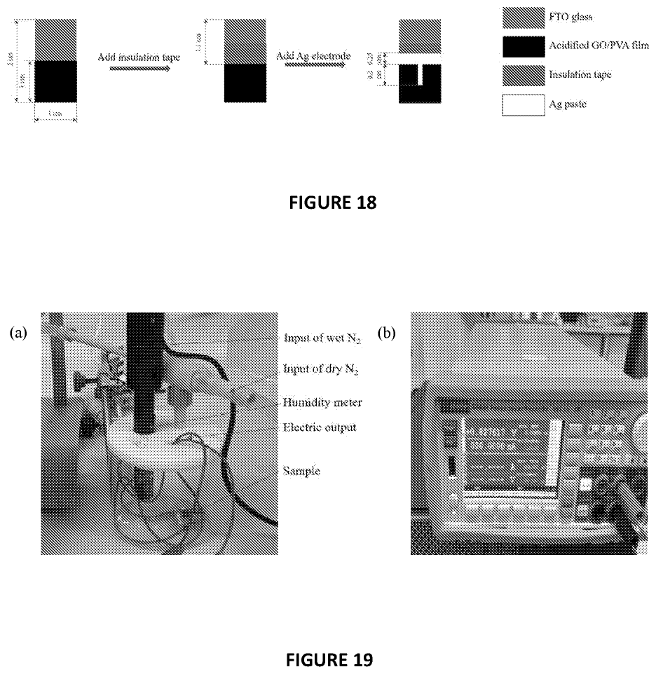

Moreover, the device array can be easily achieved by dividing the film into small pieces to supply practical devices (FIG. 10e). The acidified GO/PVA films was first fabricated on the FTO glass by the method above, followed by dividing the films into 20 cells in parallel and spread Ag paste as top electrode (FIG. 17a). The unit with 20 cells in parallel can be connected in series with other units to improve electric output (FIG. 17b). The arrays (2 in series×20 in parallel) can provide enough power to supply a calculator (FIG. 10f) In a further example, five battery cells were connected in series to test electrical output. The example is now described below with reference to FIGS. 18 to 21.

For a single cell, a mixed solution of GO and PVA (mass ratio=1:1) was dried at 50° C. for 12 h onto the FTO glass to form a GO/PVA film (thickness ˜15 μm; area ˜1×1 cm²), followed by acidification of 32% HCl (soaking the films in HCl solution for 10 mins). Then it was washed with distilled water for 10 mins and dried at 50° C. for 5 h. The top Ag electrode was fabricated by spreading the Ag paste on the films (area ˜0.1×0.5 cm²) and was dried at 50° C. for 10 mins (FIG. 18).

The relative humidity (RH) in the sample chamber was controlled by the input of wet N₂ and dry N₂ (FIG. 19a). The electric output was recorded in Keysight B2902A precision source/measure unit (FIG. 19b). The connection of five cells in series is illustrated in FIG. 20. For retention measurement, moisture was input by wet N₂ to increase the RH (up to 75% RH) and electric output until it reached highest value and was then stopped for retention measurement. For the measurement of a voltage/current cycle, moisture was input by wet N₂ to increase the RH and electric output until it reached highest value. The moisture was then eliminated by dry N₂ (up to 0% RH) to decrease the RH and electric output until it reached the lowest value.

A tabulation of full experiment results and data

TABLE 1
Details of experiment results and data.

| Active | | | RH | | Electric |
|---|---|---|---|---|---|
| material | Electrode | Structure | (%) | Output type | output |
| GO/PVA | Ag, FTO | Sandwiched | 75 | OC | >4.1 V after |
| | | | | | 20000 s |
| GO/PVA | Ag, FTO | Sandwiched | 75 | SC | ~58 uA |
| | | | | | (peak) |

For the humidity cycle experiment, calculations of the average time for the 5-cell in series voltage to return to 80% of its peak value when humidity level is re-introduced. The average time for 5 cells to return 80% peak value is 17.75 s.

Based on FIG. 21a, a voltage discharge curve of a single MEG battery cell was produced via connected the single MEG battery cell with a resistance load of (2000 k ohms) at RH=75%.

The MEG battery cell is observed to be discharging over 7000 s. Voltage retention of 5 connected MEG battery cell was measured over 5.3 hours and voltage output is stable showing >4.1V after 5.3 hours in FIG. 21b. Voltage cycles and current cycles were tested on the 5 connected MEG battery cell in FIG. 21 (c&d), with voltage peak returning to over 4V and current peaking at ˜58 uA.

### Conclusion

We have fabricated MEG battery cell of GO/PVA films treated with HCl, which can respond to the moisture and generate electricity without any other stimuli. By adding the PVA, the GO/PVA films shows better attachment to the substrate and more stable electric output. The voltage increasing from 0.49 V to 0.85 V and current increasing from 9.28 nA to 19.71 μA after 32% HCl acidification are recorded at RH=75%, which provides a facile approach to significantly improve electric performance. The voltage can achieve a retention over 2 h without obvious decrease, which demonstrate its stable electric output for long-term application. About 4.1V voltage or 58 μA (peak) current are easily generated by simple assembly of five MEG battery cell units in series or parallel connection, which shows a great potential in powering commercial devices. Besides, GO/PVA films are also fabricated on soft and flexible carbon cloth and generate a voltage higher than 0.8 V over 2 h, which demonstrates that it is applicable in the fabrication of flexible device.

We present an acidified film of GO and polyvinyl alcohol (PVA) for MEG battery cell. PVA with abundant hydroxyl group and good viscosity not only absorb moisture from the environment but also improves the attachment of film to the substrate, which lead to steady electric output. Besides, voltage and current output of GO/PVA film is greatly improved due to the optimisation of functional groups after acidification, which provides a facile approach to fabricate MEG with high and steady electric output. The single MEG battery cell unit can produce a high voltage of 0.85 V and a remarkable current of 9.28 μA at a relative humidity of 75%. The MEG battery cell shows a voltage retention over 2 h without obvious voltage decline. The MEG battery cell can also be connected in series and/or parallel to further improve its electric output. The voltage of five MEG battery cell in series reaches up to 4.1 V, which is high enough to power some practical electronic devices. Thus, this MEG battery cells provides a feasible approach for designing energy-harvesting from the abundant moisture in powering practical devices.

Due to the great demand for power supply, harvesting energy from the moisture is attracting growing interest in the practical application due to its abundant sources. In this paper, the electric performance of GO/PVA films is investigated, which is prepared by drop-casting followed with HCl acidification to enhance its electric output. The as-prepared GO/PVA films acidified with 32% HCl can generate an excellent voltage of 0.85 V and a high current of 9.28 μA at a relative humidity of 75%, which can get further improved by simple assembly (4.1 V or 58 μA (peak) for five units in series or parallel). The electric output is also achieved on the flexible carbon cloth, which present a facile and effective approach to generate enhanced electric performance for energy supply for flexible electronics.

The various embodiments of battery cells described above provide self-charging batteries providing large current and voltage outputs in humid environments. Such battery cells have applications in many electronic devices. In particular, the high current and voltage outputs and stable outputs of the MEG battery cells make embodiments suitable power sources for many wearable technologies which allow the battery cells to be positioned in high humidity environments, for example in contact with human skin, which has humidity of around 80% to 100%. These high humidity environments provide H₊ ions to maintain charge on the battery cells. Suitable applications include health wearables, including various body sensors and electronic skin patches. The voltage and current levels generated by the MEG battery cells enable Internet of Things (IoT) devices to be powered, which may include sensors and/or wireless communication module, for example Bluetooth radio transceivers.

### Section 2: Samples and Results

The following Section 2 describes a second series of samples and results:

An acidified GO film incorporated with a small amount of polyvinyl alcohol (PVA) for MEG application. PVA with hydroxyl group and good viscosity not only absorbs moisture from the environment but also improves the attachment of film to the substrate, which lead to stable device structure and steady electric output. Most importantly, electric output of GO/PVA film are greatly enhanced due to the optimization of functional groups and reduced film resistance after acidification, which provides a facile approach to fabricate MEG with high and steady electric output. The single unit can produce a high voltage of 0.85 V and a remarkable current of 9.28 μA (92.8 μA·cm²) at a RH of 75%, which are among the highest reported electric outputs of MEGs^{6,12}. The MEG shows a good voltage retention over 2 h without obvious decline. The MEG can also be connected in series or parallel to further improve its electric output. The voltage and current of four MEG units reach up to 3.38 V and 40.49 μA, respectively, which are high enough to power some practical electronic devices. Thus, this paper provides a feasible approach to modify functional groups in GO and produce enhanced electric outputs for powering practical electronic devices.

### Methods for Samples of Section 2

### Materials

Hydrochloric acid (HCl), acetic acid, sodium hydroxide (NaOH), polyvinyl alcohol (PVA) powders (Mw 13000-23000), Ag paste and silver nitrate were purchased from Sigma. GO powders were synthesized by the oxidation of graphite powders according to the Hummers method³³. 20 mg/mL GO dispersion was obtained by dispersing GO powders in distilled water with sonication for 30 min. 20 mg/mL PVA solution was obtained by dissolving PVA powders in distilled water with stirring at 90° C. for 30 min.

### Fabrication of MEG

The fluorine doped tin oxide (FTO) glass was cut into 1.0×2.0 cm² pieces and was used as substrate/bottom electrode. FTO glass was then cleaned with ethanol and deionized water, followed by ultraviolet radiation for 30 min. GO dispersion and PVA solution were mixed with a mass ratio of 1:1 (maximum ratio to achieve a good attachment of GO/PVA film onto the substrate) by sonication for 30 min and was then dried directly onto the FTO glass at 50° C. for 12 h to form a 1.0×1.0 cm² GO/PVA film. The edge of GO/PVA film was covered by the insulative tape to avoid short circuit and Ag paste was printed onto the film as the top electrode. For the films fabricated on the carbon cloth (substrate/bottom electrode), the carbon cloth was soaked in the above GO/PVA dispersion for 30 min and was then dried at 50° C. for 12 h.

### Chemical Treatments of MEG

As for MEG acidification, MEG was immersed in HCl solution with different concentrations for 10 min. Then MEG was washed with distilled water until no chloride ion was detected by silver nitrate solution. MEG was then dried at 50° C. for 24 h for electrical measurement and powering electronic devices. As for MEG washed with other reagents, MEG was immersed in the acetic acid or NaOH solution for 10 min and then washed with distilled water until pH=7.

### Electrical Measurement

The electrodes of MEG were connected to a Keysight B2902A precision source/measure unit directly for electric output measurements. The wet N₂ and dry N₂ were used to control RH in the sample chamber. Compressed N₂ was used as dry N₂ to decrease RH in the sample chamber. Wet N₂ was obtained by flowing dry N₂ through the deionized water to increase RH in the sample chamber. For electric output retention measurement, moisture was input by wet N₂ to increase RH and electric output until electric measurement ended. For the measurement of an electric output cycle, moisture was input by wet N₂ to increase RH and electric output until it reached highest value, and then it was eliminated by dry N₂ to decrease RH and electric output. The voltage and current output of multiple units were measured by connecting the units in series and parallel, respectively.

### Electric Output of MEGs

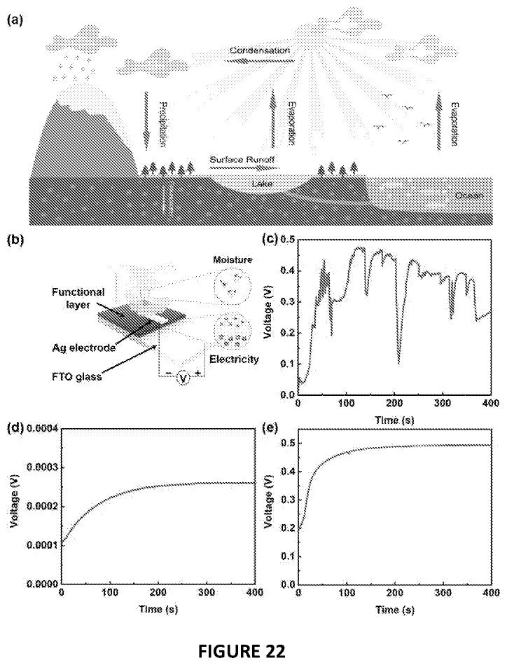

Moisture from water evaporation is an abundant and sustainable resource on the earth (FIG. 22a), which can be harvested by MEG and incorporated into self-powered system. FIG. 22b shows the schematic structure of MEG, where carbon-based materials serve as functional layer, and Ag paste and fluorine doped tin oxide (FTO) glass serve as top electrode, bottom electrode, respectively. Moisture from the environment is absorbed by the hydrophilic functional layer and facilitates charge separation between top/bottom electrode to achieve electric generation. To optimize the functional layers, three types of materials (GO, PVA and GO/PVA) were used to fabricate the devices, which were tested at RH=75%. As shown in FIG. 22c-e, the maximum voltage (Vₘₐₓ) outputs are 0.48 V for GO, 0.26 mV for PVA and 0.50 V for GO/PVA, respectively. Clearly, GO film outperforms PVA film in generating a high voltage output, but an obvious fluctuation of the voltage was observed (FIG. 22c). During the electric measurement, GO film could not be tightly attached to FTO glass due to the poor interface adhesion, which reduced the stability and reproducibility of voltage output. Differently, GO/PVA exhibited a high and stable voltage output as the PVA could act as binder to greatly improve the interface adhesion (FIG. 22e). Therefore, GO/PVA is selected as the functional layer to fabricate MEG with a high and stable electric output.

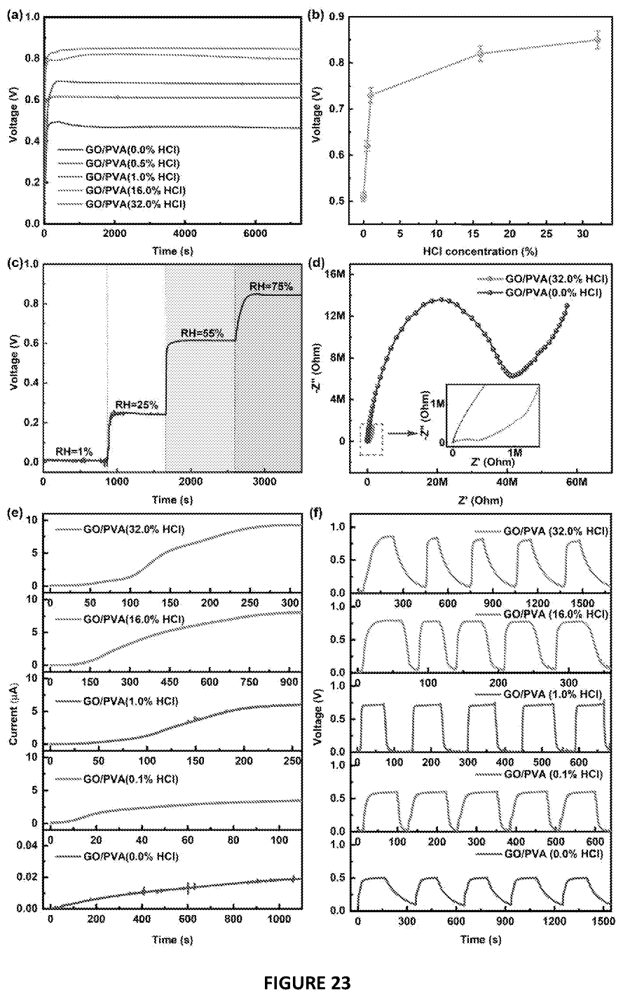

The proton concentration gradient across the functional layer is essential for the proton migration, thus dominating the voltage output. Generally, a higher concentration gradient can generate a higher voltage, which can be obtained from a higher RH and enhanced protonation ability of functional layer. Gao et al. reported that the number of surface protons increased in acidification, thus leading to improved electric output of paper-based MEG¹³. Here, we used hydrochloric acid (HCl) solution with different concentrations including 32.0%, 16.0%, 1.0%, 0.5% and 0.0% to treat GO/PVA films to tune the functional group density. As shown in FIG. 23a-b, the corresponding Vₘₐₓ of the GO/PVA films are 0.85 V, 0.82 V, 0.69V, 0.61V, and 0.50 V, respectively, which show a good retention over 2 h. Specifically, the Vₘₐₓ of 32.0% HCl treated device is 0.85 V, which is among the highest reported voltages for a single MEG. Clearly, acidification can greatly improve the voltage output because it can enhance the protonation ability, leading to a larger protonation gradient. The electric output of MEG acidified by 32.0% HCl in an external sweep voltage is investigated. The current output of MEG in positive external voltage is significantly higher than that of MEG in negative external voltage. It results from the difference of MEG resistance, which is 0.02-0.26 MΩ in positive external voltage and 0.35-2.19 MΩ in negative external voltage. It demonstrates that acidified GO/PVA films generate great protonation gradient between top and bottom surfaces. After soaking the films (acidified by 0.0% and 32.0% HCl, respectively) in 1 mL distilled water for 10 min, the pH of the water soaking different films shows same value. Thus, the dissociation of functional group, instead of ionized H⁺ from HCl solution, leads to the protonation gradient.

To exclude the other variants, surface morphology was characterized on the GO/PVA film with 0.0% and 32.0% HCl acidification using scanning electron microscopy (SEM). FIG. 32 shows that the morphologies of both films demonstrate no noticeable change. Meanwhile the cross-sectional SEM images exhibit that both film microstructure and thickness remain unchanged. Furthermore, the voltage output was measured on the devices with different film areas such as 0.5×0.5, 1.0×1.0 and 1.5×1.5 cm², showing that voltage remained roughly the same. In addition, the Vₘₐₓ of PVA films acidified by 32.0% HCl is 0.49 V, which is much lower than that of GO/PVA films acidified by 32.0% HCl. Thus, the acidified GO, instead of acidified PVA, contributes to the high voltage output (Vₘₐₓ=0.85 V). Therefore, these results exclude the effects of film morphology, film area and PVA on the high voltage output of the acidified GO/PVA film.

To further confirm that the proton concentration across the films induced the electric potential, different RH of 1%, 25%, 55% and 75% were performed on the top surface of the device. As shown in FIG. 23c, the corresponding Vₘₐₓ is 0.02 V, 0.22 V, 0.60 V and 0.85 V. Besides, the Vₘₐₓ of the acidified film with top/bottom and top/top electrodes at RH=75% is 0.85 V and 0.02 V, respectively. MEG with two top electrodes shows almost no voltage output due to negligible protonation gradient between two top sides of GO/PVA films. Thus, protonation gradient is closely related to the voltage output of MEG. Additionally, we investigated the effect of film thickness on the voltage output of GO/PVA films acidified by 32.0% HCl. The GO/PVA films with different thickness of 23.73 μm, 15.33 μm, 12.23 μm and 6.21 μm could produce 0.85 V, 0.85 V, 0.80 V and 0.75 V, respectively. The MEGs with thinner GO/PVA films facilitate water migration toward inner layer and lead to lower gradient of absorbed water between top and bottom sides, which reduce protonation gradient and voltage output. The above results clearly indicate that RH and functional group density in the GO/PVA device co-determine the protonation gradient and voltage output.

It is noted that RH is normally an uncontrollable condition for the MEG to produce a high voltage in practical applications. Therefore, optimizing functional group density of functional layers is particularly important to obtain desirable voltage and current output. As demonstrated in FIG. 23a, HCl treatments can tune the density of functional groups, which thereby generates various voltage output. Meanwhile, cycle stability is another key parameter determining MEG performance. The moisture was carried by the N₂ gas to the top surface of the device to produce an electric output. When the moisture was extracted by dry N₂, the electric output sharply decreased. The electrochemical impedance spectroscopy (EIS) of GO/PVA with and without HCl acidification was carried out in room humidity to analyse conductivity of different MEGs (FIG. 23d). The GO/PVA with HCl acidification shows much lower resistance than GO/PVA without HCl acidification, which results from the more mobilized ions in acidified GO/PVA and is good for achieving high current output. Specifically, the maximum current output of MEG increases from 19.71 nA (197.1 nA-cm²) to 9.28 μA (92.8 μA-cm²) after 32.0% HCl acidification, which exhibits a significant improvement by acidification (FIG. 23e). FIG. 23f shows the cycling voltage output of MEG acidified with different HCl concentration. Clearly, with increasing HCl concentration, the devices produce gradually increased voltage, and demonstrate excellent cycling stability without obvious degradation in each cycle, which also exhibit a great potential in the application of humidity sensor. The electric outputs of recent reported MEGs are summarized in Table 1. Obviously, MEG with acidified GO/PVA in this work exhibits a more comprehensive electric output than the reported MEGs.

TABLE 2
Summary and comparison of MEGs

| Functional | | RH | Output | Electric | |
|---|---|---|---|---|---|
| material | Electrode | (%) | type | output | Refs. |
| Protein | Au/Au | 50 | Continuous | 0.5 V, 17 | 8 |
| | | | | μA · cm⁻² | |
| TiO₂ | Al/ITO | 85 | Transient | 0.5 V, 10 | 9 |
| | | | | μA · cm⁻² | |
| Cellulose | Au/ITO | 70 | Transient | 0.25 V, 10 | 13 |
| paper | | | | nA · cm⁻² | |
| GO/sodium | Au/Ag | 80 | Continuous | 0.6 V, >1 | 10 |
| polyacrylate | | | | μA · cm⁻² | |
| GO | Au/Au | 30 | Transient | 0.02 V, 5 | 14 |
| | | | | μA · cm⁻² | |
| Graphitic | Cu/Ag | 82 | Continuous | 0.83 V, 5.93 | 16 |
| carbon | | | | μA · cm⁻² | |
| Reduced | Au/Au | 85 | Continuous | 0.45 V, 0.9 | 17 |
| GO/GO | | | | μA · cm⁻² | |
| GO | Au/Au | 70 | Transient | 0.4 V, 2 | 18 |
| | | | | μA · cm⁻² | |
| GO/PVA | Ag/FTO | 75 | Continuous | 0.85 V, 92.8 | This |
| | | | | μA · cm⁻² | patent |

### Working Mechanism

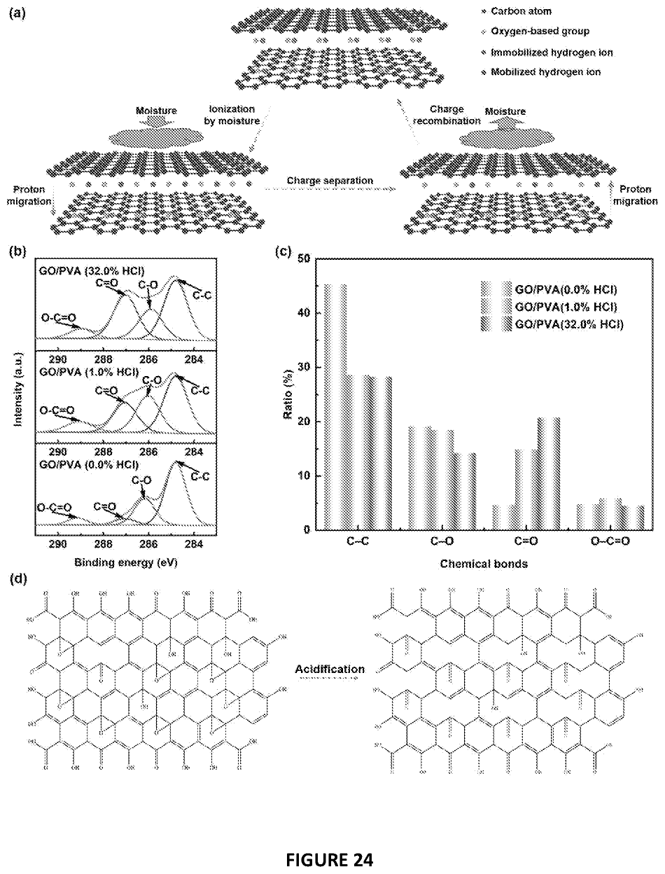

The proposed mechanism of power generation for acidified GO/PVA MEG is illustrated in FIG. 24a. which includes ionization, charge separation and charge recombination¹⁸. The protons in the functional groups are immobilized without absorbed water from moisture. During ionization, the moisture on the top side of GO/PVA films facilitate dissociation of functional groups (—OH and —COOH), which releases mobilized H⁺ as charge carrier for electric generation. Then, H⁺ migrates from top side to the bottom side as the concentration of mobilized H⁺ is higher on the top side exposed to the moisture, which achieves charge separation and voltage generation. After moisture removal, the mobilized H⁺ migrates in the direction of water migration toward top sides and leads to charge recombination¹¹. Thus, the charge and discharge process are triggered by the moisture directly instead of complex chemical reactions so that MEG can be charged quickly and exhibits a stable electric output by harvesting this clean energy.

To verify the improved MEG device performance resulting from increased group density after HCl treatment, materials characterizations such as X-ray diffraction (XRD) and X-ray photoelectron spectroscopy (XPS) were analysed on the film with and without acidification. The diffraction peak of GO/PVA film shows a lower diffraction angle (14.4° to 6.6°) than that of GO films and shifts to a higher diffraction angle (6.6° to 8.0°) after increasing HCl concentration. The interlayer spacing of GO/PVA film can be calculated by Bragg's law. GO/PVA films show a higher interlayer spacing than GO films, where interlayer spacing is 0.77 nm for GO film, 1.26 nm for GO/PVA film (0.0% HCl), 1.19 nm for GO/PVA film (1.0% HCl), and 1.10 nm for GO/PVA film (32.0% HCl). The polymer molecules of PVA can enter into the GO interlayer and enlarge interlayer spacing, which may explain GO/PVA films show a higher interlayer spacing than GO films. The crosslinking between the GO and PVA bridges the adjacent GO sheets as carboxyl groups from GO can react with hydroxyl groups in the crosslinking²³, which contributes to a more uniform and stable structure. Besides, the interlayer spacing of GO/PVA films decreases after HCl acidification. The shorten spacing of GO/PVA film with HCl acidification may result from the H⁺ introduced in HCl acidification as H⁺ can be absorbed by the oxygen-based groups and inhibit the crosslinking of GO and PVA.

FIG. 24b-c show XPS spectrum of C 1s region in the GO/PVA films acidified by 0.0% HCl, 1.0% HCl and 32.0% HCl. The C 1s peaks in the GO/PVA (0.0% HCl) with binding energies of 284.8 eV, 286.2 eV, 287.0 eV, and 289.2 eV represent C—C(45.29 at. %), C—O (19.18 at. %), C═O (4.67 at. %), and O—C═O (4.84 at. %), respectively. The C 1s peaks in the GO/PVA (1.0% HCl) with binding energies of 284.8 eV, 286.0 eV, 287.0 eV, and 289.1 eV represent C—C (28.61 at. %), C—O (18.50 at. %), C═O (14.91 at. %), and O—C═O (5.96 at. %), respectively. The C 1s peaks in the GO/PVA (32% HCl) with binding energies of 284.8 eV, 285.9 eV, 287.0 eV, and 289.0 eV represent C—C(28.30 at. %), C—O (14.26 at. %), C═O (20.75 at. %), and O—C═O (4.49 at. %), respectively. Thus, the ratio of C—O bond decreases after HCl acidification, while the ratio of C═O bond increases after HCl acidification. It has been reported that the film with more C═O bonds exhibits a higher work function and surface potential. The surface potential of GO/PVA films, analysed by Kelvin probe force microscopy (KPFM) under room humidity (RH=55%), increases after acidification, which can be ascribed to the increase ratio of C═O bonds after HCl acidification.

After HCl acidification, epoxy groups can be arranged in a line, which leads to the rupture of C—C bonds. The epoxy chain tends to be oxidized into epoxy pairs and converted into carbonyl pairs as carbonyl groups are more stable in this condition (FIG. 24d). The C═O with stronger polarity is better than C—O in attracting H⁺ and forming hydrogen bonds⁸. Thus, the higher voltage output can be attributed to more C═O bonds, which attract more H⁺ from the dissociation of functional groups (—OH and —COOH) and lead to greater protonation gradient for the excellent electric output. Moreover, the carrier (H⁺) density in the MEG increases after acidification due to the more dissociated H⁺ in the films exposed to the moisture, which leads to the decrease of the film resistance and increase of the current output. To confirm the exact functional groups that contributes to the improvement of voltage output, the oxygen-based groups in the GO/PVA films washed with acetic acid and NaOH are also investigated. The GO/PVA films washed with acetic acid show C—C(35.96 at. %), C—O (22.28 at. %), C═O (1.27 at. %), and O—C═O (6.13 at. %), while GO/PVA films washed with NaOH show C—C(37.86 at. %), C—O (25.24 at. %), C═O (2.74 at. %), and O—C═O (2.47 at. %). The Vₘₐₓ of GO/PVA films washed with acetic acid and NaOH is 0.34 V and 0.22 V, respectively, which are much lower than that of films acidified by HCl as the ratio of C═O in the GO/PVA films washed with acetic acid and NaOH is much lower. Thus, the ratio of C═O is closely related to the electric output of GO/PVA films.

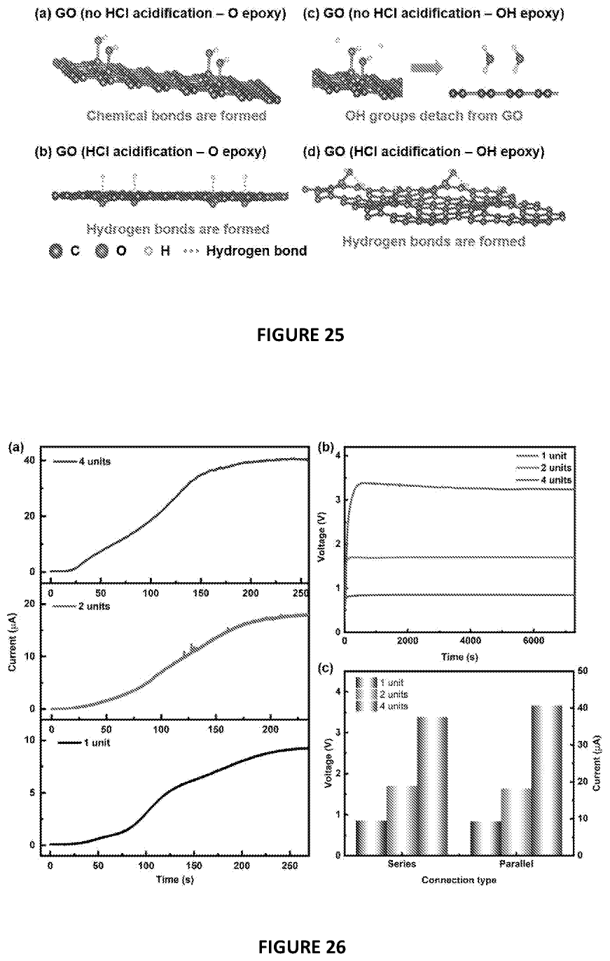

First-principles calculations based on density functional theory (DFT) were performed to provide atomistic insights into the observed enhancement effect of electric output induced by HCl acidification of graphene oxide. Specifically, we simulated proton-binding processes for O- and OH-surface functionalized graphene oxide in the presence and absence of carbon vacancies generated by the acidification. Our theoretical DFT results show that the formation of hydrogen bonds between mobile protons and surface immobilized functional groups is significantly increased by the presence of carbon vacancies, a simulation outcome that may explain the enhancement effect of electric output observed in the experiments. A summary of our theoretical DFT results is provided in FIG. 25.

In the absence of carbon vacancies (V_{C}), mobile protons tend to form strong chemical bonds with the O atoms on the carbon surface (FIG. 25a). In this case, the energy corresponding to proton binding amounts to 1.12 eV/H, which renders H chemisorption and therefore is detrimental for proton migration (i.e., the interactions between O and H turn out to be too strong). Meanwhile, the interactions between mobile protons and surface O atoms become much less intense (i.e., of the order of 0.1 eV) in the presence of V_{C} defects because the latter are already strongly adsorbed on graphene oxide. Thus, they are not prone to exchange charge with the mobile H⁺ ions (FIG. 25b). Consequently, numerous hydrogen bonds involving electrostatic attraction rather fully covalent interactions are formed on the carbon surface, which turns out to be beneficial for proton migration to achieve higher electric outputs.

In the case of considering functional group (—OH) on the carbon surface, the general conclusions are very similar to those reported in the paragraph above. It is found that —OH spontaneously detach from the carbon surface upon H binding when V_{C} are sparse (FIG. 25c). The —OH detachment effect is driven by the formation of water molecules, which relies on charge transfers from the relatively weak C—O surface bonds (i.e., E_{O—C}≈0.1 eV) to O—H molecular bonds, and obviously is not desirable for charge-discharge cycling purposes. Conversely, in the presence of abundant carbon vacancies, the —OH that are immobilized near the V_{C} tend to establish mild hydrogen bonds with the mobile protons (FIG. 25d). In this latter case, it is energetically not favorable to transfer electrons from the very stable C—O surface bonds (i.e., E_{O—C}≈3.7 eV) to covalent O—H bonds and thus the mobile H ions are captured by the functional group (—OH) via moderate electrostatic forces.

Overall, our theoretical DFT simulations reproduce the enhancement effect of electric output induced by HCl acidification of graphene oxide observed in the experiments. The point to the increase in the formation of hydrogen bonds is the underlying cause of it.

### Demonstration of Application

The MEGs with a high voltage and current can directly power electronic devices, such as memristor and sensors, which significantly improve their practical applications. To further enhance the voltage or current output, MEG units were connected directly in series or parallel. The maximum currents are 9.28 μA, 18.16 μA and 40.69 μA for one unit, two units and four units, respectively (FIG. 26a). In addition, the Vₘₐₓ is 0.85 V, 1.70 V and 3.38 V for one unit, two units and four units, respectively (FIG. 26b). Thus, the voltage and current of MEG increase almost linearly with the electric output of one unit (FIG. 26c), which demonstrates a great potential in generating high electric output by simple assembly of units in series or parallel. The enhanced electricity generation performance can further widen their potential applications such as hydrogen catalysis.

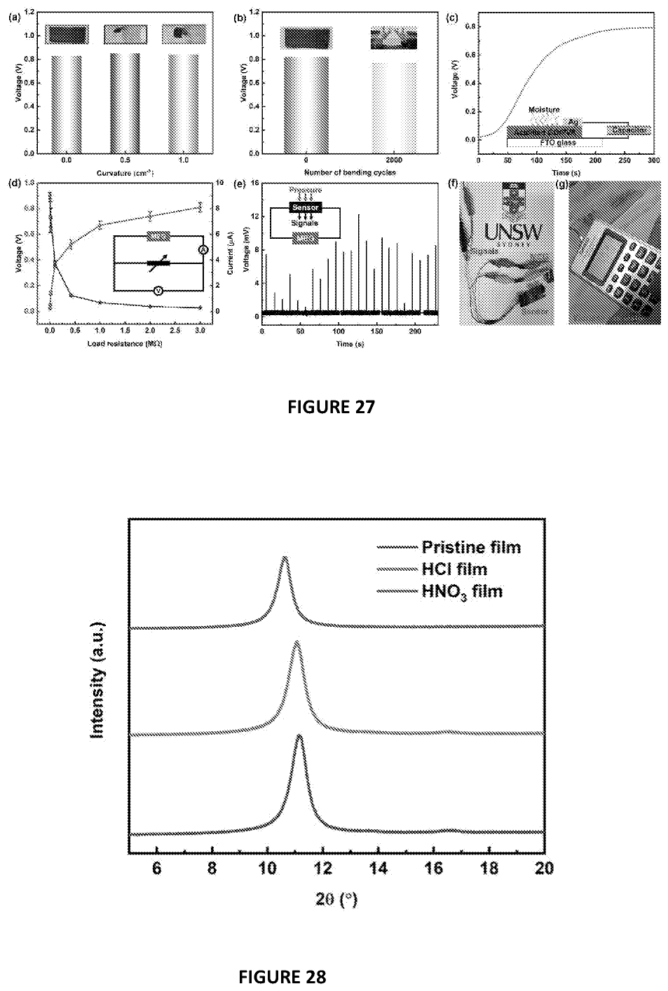

The GO/PVA films with 32.0% HCl acidification are also fabricated on the carbon cloth for flexible device applications. The acidified GO/PVA films on the carbon cloth are attached to the glass bottles with different radii to investigate the effect of film curvature on the voltage output of GO/PVA films. Vₘₐₓ is 0.83 V, 0.85 V and 0.84 V for the films with a curvature of 0.0 cm⁻¹, 0.5 cm⁻¹ and 1.0 cm⁻¹, respectively (FIG. 27a). Thus, the acidified GO/PVA films show stable voltage outputs on the flexible substrates with different curvatures, which demonstrate great potential in flexible electronics. To incorporate GO/PVA film into flexible and wearable application, the film is supposed to show a good electric output in mechanical motion such as bending. The acidified GO/PVA film on the carbon cloth was bent from 0° to 120° in one second. The flexible MEG can withstand bending deformation for 2000 times without significant Vₘₐₓ decline, which shows a great potential in flexible and wearable application (FIG. 27b).

Besides, MEG shows a good stability of charge and discharge cycles. The MEG can be charged by moisture directly and discharged at a current density of 20 μA-cm⁻². The MEG exhibits similar charge/discharge process with a good stability in each cycle. The power harvested by MEG from the moisture can also charge the power storage device directly, such as a commercial capacitor (20 pF) charged to 0.80 V in 300 s (FIG. 27c), which exhibits a great potential in energy conversion and storage at the same time. The electric output of external device powered by MEG was investigated by connecting loaded resistors with different resistances (FIG. 27d). As load increased from 1 kΩ to 3 MΩ, the voltage of resistor increased from 0.01 V to 0.81 V, whereas the current decreased from 8.55 μA to 0.27 μA. The highest output power of loaded resistor was 1.36 μW with a resistance of 0.1 MΩ. Besides, the commercial pressure sensor can be powered by a single MEG at room humidity (55%) directly and generates electric signals according to the external pressure stimulation (FIG. 27e-f), which demonstrates a great potential in supplying practical device in room humidity. Moreover, the device array can be easily achieved by dividing the film into small pieces to supply practical devices as the electric output is unrelated to the film area. The acidified GO/PVA film pattern was fabricated on the FTO glass by the method above, followed by dividing the films into 20 units in parallel and coating Ag paste on the top sides of all units as the top electrodes to increase its current output. The pattern with 20 units in parallel could also be connected in series to improve the voltage output. The arrays (2 in series×20 in parallel) could provide enough power to supply a commercial calculator (FIG. 27g).

### Conclusion

In summary, we use HCl treated GO/PVA to fabricate the MEG because HCl acidification and PVA addition can improve the protonation gradient of MEG and microstructure stability of acidified film on the substrate, respectively, which are beneficial for achieving a high electric output with a good stability. The top surface of acidified GO/PVA film is exposed to moisture directly. While the bottom side is closely sticked with FTO glass, thus robustly blocking the moisture penetration. Driven by this moisture asymmetry, the electric output is generated between top and bottom side of GO/PVA films. The GO/PVA films, as functional layer, outperform GO films and PVA films by a high and stable voltage output. The voltage output is closely related to the protonation gradient, which can get improved by HCl acidification and high RH. A high voltage of 0.85 V and an excellent current of 9.28 μA (92.8 μA-cm²) are generated at RH=75% by GO/PVA films with 32.0% HCl acidification, which can be easily enhanced by connection in series or parallel (3.38 V or 40.49 μA for four units in series or parallel). The voltage of acidified GO/PVA film on flexible carbon cloth shows no obvious decline with film curvatures and bending cycles, which demonstrates a great potential in flexible and wearable application. The acidified GO/PVA films can also be easily divided into pattern for higher electric performance and power a commercial calculator successfully, which is promising in harvesting energy from moisture and powering various practical devices.

### Section 3: Samples and Results

The following Section 3 describes a third series of samples and results:

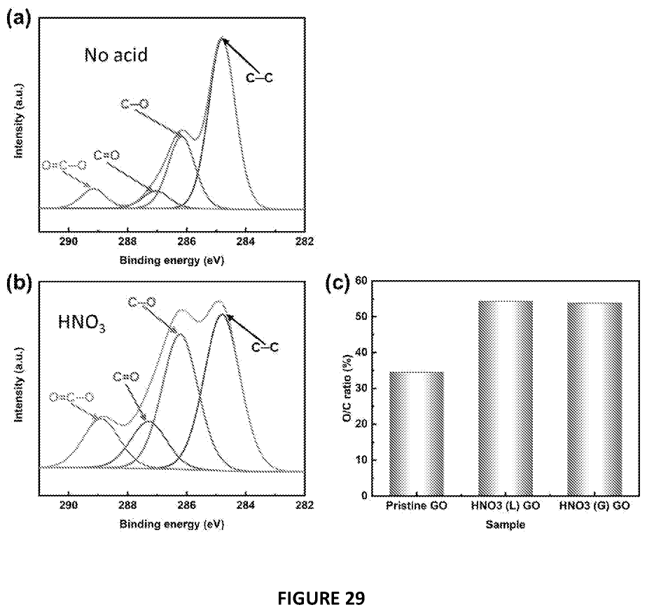

The results shown in FIGS. 28, 29, 30 and 31 relate to HNO3 treated MEG samples. The MEG samples include a functional layer comprising graphene oxide and PVA film on FTO glass. The samples were tested (a) without acidification; (b) acidified by HNO3 solution; and, (c) acidified by HNO3 vapour.

In a first method, for the liquid acid treatment, the GO/PVA layer is immersed in HNO3 solution (70 wt %) for 10 mins. Then the device is washed with distilled water for 10 mins, and dried at 50° C. for 12h.

In a second method, for the vapour treatment, the GO/PVA layer is hanged over HNO3 solution (70 wt %) in a sealed chamber. Then the device is washed with distilled water for 10 mins, and dried at 50° C. for 12h.

Interlayer spacing was found to increase after acidification (7.92 Å for GO, 7.99 Å for HCl GO, 8.32 Å for HNO3 GO). Higher interlayer spacing contributes to faster water migration.

The O/C ratio in pristine (non-acidified) GO film is 34.52%.

The O/C ratio in GO film acidified by HNO3 solution and HNO3 vapor is 54.31% and 53.80%, respectively. These results demonstrate that the C═O bond has been significantly increased through HNO3 treating.

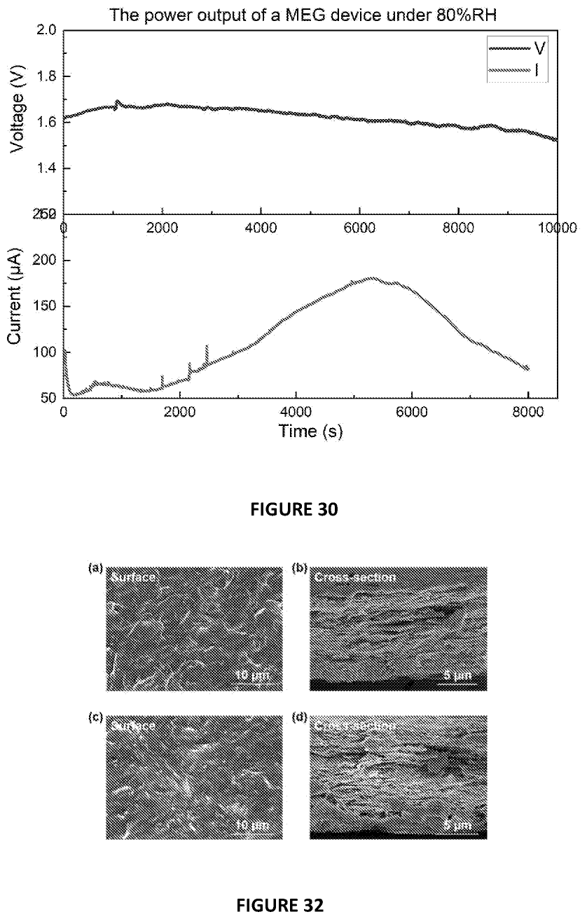

The power output of a device at 80% relative humidity is shown in FIG. 30. The sample has a zinc top electrode and carbon nano tube (CNT) bottom electrode, having an area of around 0.5 cm2. The sample has an area of around 1 cm2 and the functional layer is treated by 70% HNO3. The bottom electrode is MW Carbon nano tubes. For Zn foil device, it can be seen that the voltage is very high (˜1.6V), which is contributed by the redox behaviour of Zn. The current is limited the contact area of Zn with GO.

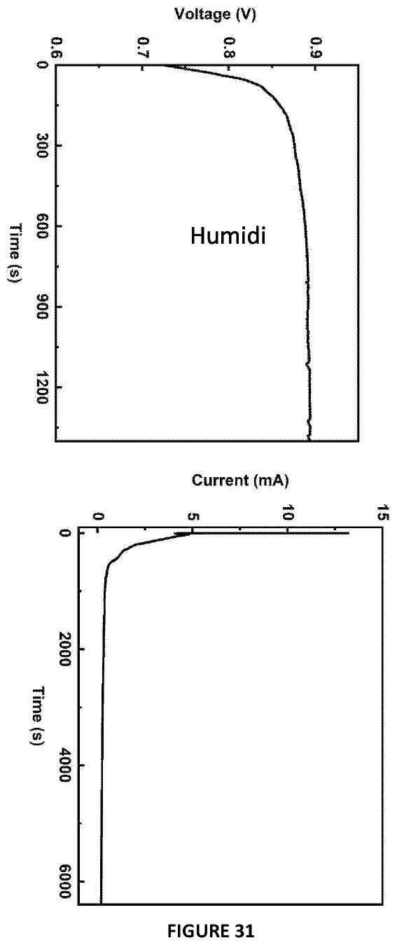

The results of FIG. 31 show the voltage/current curves at 70% humidity for a sample having a top electrode of Ag paste having an area of 0.6 cm2. Vmax is 0.89 V; Imax is 13.21 mA. Current=0.19 mA after 100 min operation.

### Section 4: Meg Device Having Layered Structure

The following Section 4 describes a fourth series of samples and results:

The following description describes further electricity generating cells (also referred to as Moisture Electric Generator (MEG) cells, or moisture electric generating device, or MEG device) with reference to the accompanying figures.

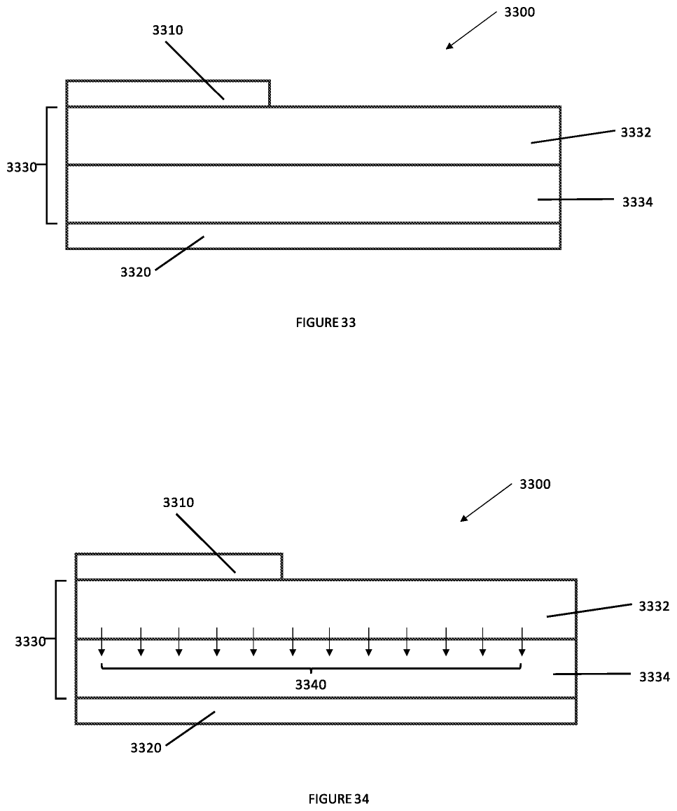

Referring now to FIG. 33, a moisture electric generating device 3300 includes a first electrode 3310 and a second electrode 3320. Disposed between the first electrode 3310 and the second electrode 3330 is a functional layer, which releases electrical charge carriers to the first and second electrodes. A functional layer may also be referred to as an active layer.

Functional layer 3330 includes sub layers. In the MEG cell shown in FIG. 33, layer 3330 includes a first sub layer 3312 and a second sub layer 3314. First sub layer 3332 can provide moisture to second sublayer 3334. Moisture includes water molecules. Water molecules may be present in liquid or water vapour and in humid environments. First sub layer 3332 acts as a moisture reservoir to the second sublayer 3334. Second sublayer 3334 is a functional sublayer which releases electrical charge carriers as a function of moisture available from the first sub layer. The first sub layer which acts as a moisture reservoir may be referred to as a moisture sub layer, or moisture reservoir sub layer, or hydration sub layer. Typically the functional layer includes functional groups that produce charge carriers on exposure to moisture by dissociating water molecules. The first sub layer 3332 can provide moisture to the second sub layer 3334, and the second sub layer 3334 produces electrical charge carriers as a function of the moisture received from first sublayer 3332.

For example, if the second sub layer includes carbon based nanomaterials, the oxygen containing functional groups in the surface of carbon based nanomaterials interact with water molecules from the moisture and dissociate the water molecule to generate mobile hydrogen ions.

A moisture reservoir sub layer has the properties of absorbing and storing moisture. A moisture reservoir sub layer can be hydrated. A moisture reservoir sub layer can provide moisture to other sub layers of the moisture electric generating device.

The inclusion of a moisture reservoir (or water reservoir) sub layer within the moisture electric generating (MEG) device helps to control delivery of moisture to the functional sub-layer. The functional sub layer disassociates electrical charge carriers when it absorbs moisture. For example, the functional groups of the functional layer produce charge carriers by disassociating water molecules from the moisture. Moisture is transferred from the moisture reservoir sub layer to the functional sub layer. The moisture reservoir provides moisture into the functional sub layer. By providing moisture to the functional sub layer 3334 from the first sub layer 3332, functional sub layer 3334 is less dependent on absorbing moisture from environmental conditions as it can absorb water molecules from the sub layer acting as a moisture reservoir. The second sub layer 3334 may additionally absorb moisture directly from the environment, via any surfaces which are exposed to the environment, but the second sub layer is provided with moisture from the first functional layer.

Since the second sub layer is less dependent on the environment as its only source of moisture, the moisture electric generating device may generate electric charge in both low and high humidity conditions, assuming that moisture is provided to the second sub layer from the first sub layer. This results in the performance of the MEG device being less variable in changing environmental moisture conditions because moisture delivery to the second sub layer can be maintained from the first sub layer. The water in the reservoir sub layer will evaporate at low humidity, and it will adsorb water from the environment in high humidity environments.

The moisture sub layer acts as a dampener and acts as a buffer between the second sublayer (the functional sub layer) and the environmental conditions. The presence of a moisture sub layer produces more consistent moisture delivery to the functional sub layer than if the functional sub layer relied completely on moisture from the environmental conditions. The presence of the moisture sub layer allows the functional sub layer to receive moisture irrespective of the environmental conditions that the moisture electric generating device is exposed to (assuming that the moisture sub layer is adequately hydrated).

The sub layer acting as a moisture reservoir is able to retain moisture and it can act as a pool to other layers in the moisture electric generating device by providing moisture to those other layers. The sub layer may also be referred to as a hydration layer since it can release moisture to other sub layers to hydrate those other sub layers. The first sub layer acting as a moisture reservoir to the second sub layer provides can hydrate the second sub layer. Moisture can be provided to the second sub layer from the first sub layer, meaning that the second sub layer can be hydrated even in low humidity environmental conditions, assuming that adequate moisture is available from the first sub layer. Thus, a the first sub layer can hydrate the second sub layer at ambient or even the extreme condition (Relative Humidity (RH) of 0%).

The first sub layer acting as a moisture reservoir to a second sublayer, to provide moisture to the second sublayer, is more hydrophilic than the second sub layer.

FIG. 34 illustrates the movement of moisture 3400 from first sublayer 3332 to second sub layer 3334.

In some moisture electric generating devices, the first sub layer 3332 is a polymer.

Some polymers are hydrophilic polymers. Hydrophilic polymers include hydrophilic functional groups. These hydrophilic polymers can be hydrated.

Hydrophilic polymers can be efficient moisture absorbers, meaning that polymers can absorb moisture from the environment even in low humidity environments. Moisture electric generating devices including a polymer exposed to the environment absorb moisture into the moisture electric generating device even in low humidity environments. This allows moisture to be absorbed into the moisture electric generating device by the polymer sub layer. This allows the moisture electric generating device to absorb moisture more readily than a device with a single non-polymer functional layer, for example GO. The efficient moisture absorption property allows the moisture electric generating device to absorb water in low humidity environments. This can improve the electrical performance of the device in low humidity environments.

Polymers can be hydrated. They can absorb and hold water. A sufficiently hydrated polymer layer can provide moisture into other layers of the moisture electric generating device. Hydrated polymer layers can contain abundant water that keeps the second sub layer hydrated. This property allows a polymer layer to provide moisture to other layers of the electric generating device in different environmental conditions. Assuming that the polymer is sufficiently hydrated, the polymer layer can provide moisture to other layers of the moisture electric generating device, regardless of the environmental humidity conditions. For example, the polymer can provide moisture to other layers of the moisture electric generating device in low relative humidity (RH) conditions (for example, 0%) and also up to high relative humidity conditions (for example 100%).

Examples of polymers include 4-styrensulfonic acid (PSSA), PSSNa, PAA, PVA, PSSLi, PSSK, PSSNH4, PSSMg2, PSSAI3, PSSH, chitin, chitosan, cellulose, starch, gums, alginate, and carrageenan, polyamides, polyphenols, organic polyesters, inorganic polyesters, and polyanhydrides. Polymers include hydrogels.

Physical properties of certain polymers can make them suitable for moisture electric generating device fabrication, including being flexible, stretchable, and easy for device fabrication, cost-effective, semi-transparent, workable at low humidity.

In some moisture electric generating devices, the first electrode 3310, the second electrode 3320 and the functional layer 3330 are arranged in a stacked orientation.

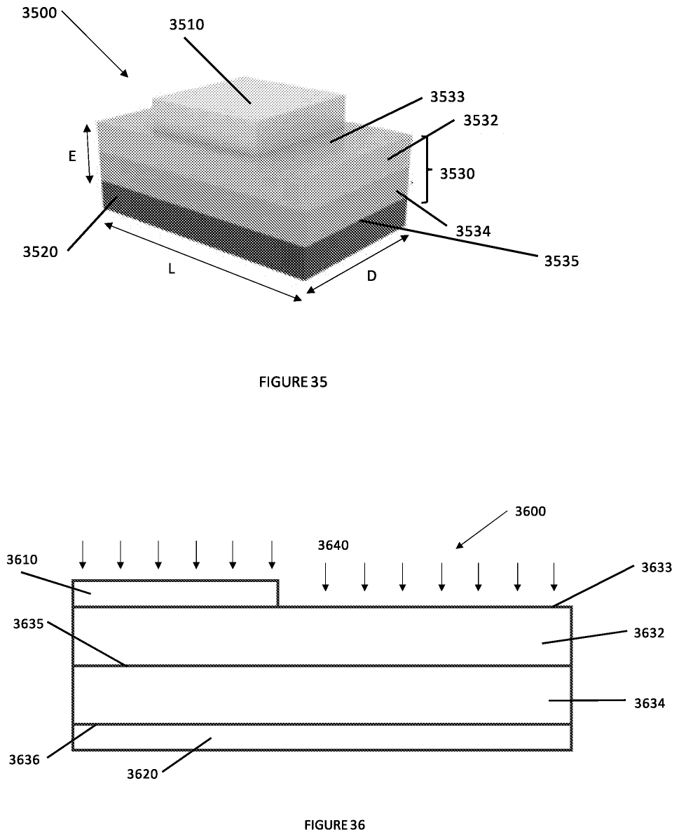

Referring now to FIG. 35, FIG. 35 shows an elevated perspective of a moisture electric generating device. FIG. 35 is shown for the purposes of illustration only and is not to scale.

In FIG. 35, the moisture electric generating device 3500 includes first electrode 3510 (also referred to as top electrode), second electrode 3520 (also referred to as bottom electrode) and functional layer 3530. Functional layer 3530 includes first sub layer 3532 and second sub layer 3534. In the device shown in FIG. 35, first electrode 3510 is attached to a surface 3533 of the first sub layer. Second electrode 3520 is attached to a surface 3535 of the second sub layer. In the device of FIG. 35, faces 3533 and 3535 are opposite faces of the functional layer. It is clear that the orientation of the device is not limiting and that these labels are used for the purposes of description only.

The functional layer 3530 has a length dimension (L) and a depth dimension (D) much greater than the dimension of the thickness dimension (E). For example, the thickness of functional layer may be around 0.5 mm, the length may be around 1 cm and the depth may be around 1 cm. The surface area of surfaces 3533 and 3535 are large compared with the cross sectional surface area of the layers. The surface area defined by the length (L) and depth (D) dimensions can be referred to as the in-plane surface. The bottom electrode 3520, second sublayer 3534, first layer 3532 and top electrode 3510 are stacked vertically with the large surface areas of the faces being connected (rather than the layers being connected in an end to end configuration).

The stacked configuration, with the layers being stacked vertically, is beneficial because the interface between the layers has a large surface area (i.e. a much greater surface area compared with the cross-sectional surface area of the layers that would be used in an end-to-end interface connection between the layers). This large interface area reduces internal resistance of the moisture electric generating device. The large interface surface area provides opportunity a greater flow of charge carriers.

The sub layers are vertically stacked to form the functional layer. In the devices of FIGS. 33 and 35, the sub layers are adjacent. The adjacent layers are connected electrically.

By positioning the sub layers in an adjacent arrangement, an electrical interface is provided between the first sublayer and the second sub layer. The electrical interface facilitates direct movement of charge carriers between the first sub layer and second sub layer. The adjacent arrange provides. The adjacent sub layer arrangement also allows movement of moisture directly between the layers.

In some examples the functional layer is a bi-layer structure having two sub layers, namely the first sub layer acting as a moisture reservoir to the second sub layer, the second sublayer being a functional sub layer. Other devices may include more than two sublayers. In some devices the first sub layer and second sublayer may not be adjacent.

In some devices the first sub layer contributes electrical charge to the moisture electric generating device. In some moisture electric generating devices, the first sub layer may release electrical charge carriers when the moisture electric generating cell is exposed to moisture. The first sub layer may have MEG properties and release charge carriers when it is exposed to moisture. An advantage is that both the second sub layer and the first sub layer are MEG layers. This provides the advantage that charge carriers can be provided to the moisture electric generating device by the first sub layer when the device is exposed to moisture, in addition to the charge carriers provided by the second sub layer sublayer. This increase in the number of electrical charge carriers may increase the electrical performance of the device (such as electrical voltage) compared with a single layer MEG device.

In some moisture electric generating devices, the second sublayer has a net electric charge which is opposite to the charge of the electrical charge carriers released in the first sub layer. For example, if protons tend to be released from the first sub layer then the second sub layer can be selected to have a net negative electric charge. Graphene oxide is a candidate material for the second sub layer in this case as it has a net negative charge (graphene oxide is also a functional layer). The net negative charge of the second sublayer is advantageous to attract positive charge carriers from the first sub layer. This charge attraction can help to increase charge flow through the MEG device, which may improve the electrical properties of the MEG device. Examples may include increasing voltage and electric current of the moisture electric charge device.

The second sublayer may be a carbon-based material. For example, the second sub layer may be graphene oxide (GO). Graphene oxide includes multiple functional groups and disassociates H₊ ions when it absorbs moisture. Graphene oxide has a higher density than other more porous materials, for example Mxene.

Graphene oxide is a good candidate material for the second sub layer as it is it can adsorb excessive water from the polymer layer. GO is also negatively charged so it can attract generated proton from the polymer layer.

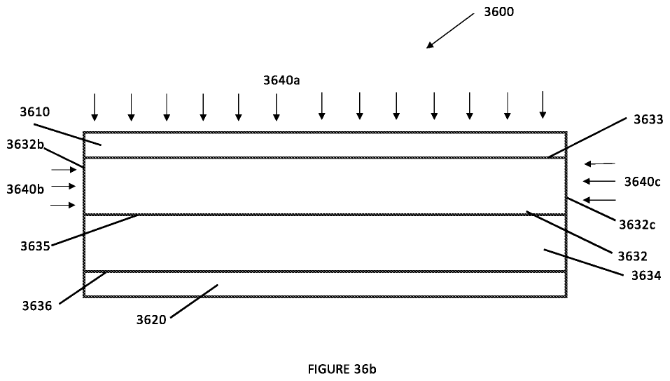

The MEG device 3600 of FIG. 36 is arranged to create a moisture gradient across the device. In the MEG device 3600 the second sublayer 3634 is positioned between the first layer 3632 and the second electrode 3620. The top surface 3632 of the second sub layer 3634, faces towards the first sub layer 3632. In the device 3600 the top surface of the second sublayer interfaces with the first sub layer. The bottom surface 3636 of the second sub layer 3634 faces towards the second electrode 3620. Device 3600 is arranged to resist the ingress of moisture into the bottom surface of the second sub layer.

In FIG. 36 electrode 3620 extends across the bottom surface of the second sub layer. Electrode 3620 covers the bottom surface of the second sub layer 3634. Examples of suitable material for the bottom electrode include carbon based materials, for example carbon nanotubes or graphene. Other suitable materials for the bottom electrode include FTO, ITO, MXene, Au, Pt and carbon black.

By covering the bottom surface, electrode 3620 reduces the penetration of moisture into the second sub layer through electrode 3620. Preferably electrode 3620 prevents penetration of moisture into the second sub layer. Preferred electrodes have moisture insulating properties to resist penetration of moisture into the second sub layer.

Additional resistance to moisture penetration can be provided by mounting the bottom electrode 3620 onto a separate substrate. This can improve the moisture resistive properties of the bottom layer by requiring that any moisture penetrating into the second sub layer of the functional layer must first penetrate through the substrate and then penetrate through the first electrode 3620 in order to penetrate into the second sub layer.

In the example of FIG. 36, electrode 3620 covers the surface of the second sub layer 3634. As shown in FIG. 36 the bottom electrode 3620 extends across the full bottom surface of the second sub layer. This configuration covers the entire surface from direct contact with moisture. As described above this helps reduce the penetration of moisture across the entire bottom surface of the device.

An advantage of resisting the ingress of moisture into the bottom surface of the second sub layer is that a moisture gradient can be created across the moisture generating electricity device.

In the example of FIG. 36 MEG device 3600 is configured to promote absorption of moisture into the top surface 3633 of the first sub layer. This configuration helps to create a moisture absorption differential between the surfaces of the functional layer when the device is placed in a humid environment. This promotes an abundance of moisture absorbed into the top surface of the functional layer 3633 and lack of moisture absorbed into the bottom surface of the functional layer 3636.

In the embodiment of FIG. 36 first electrode 3610 is configured to cover only a portion of top surface 3633 of the first sub layer 3632. The electrode 3610 does not fully cover the top surface 3633. The electrode 3610 partially covers the top surface 3633. The remainder of the top surface 3633 of the first sub layer is left uncovered. The uncovered portion of the top surface 3633 is exposed to environmental conditions. This allows direct contact of moisture 3640 onto the top surface 3633. Larger top electrodes can result in larger current carrying capacity through the electrode.

In some devices, electrode 3610 may cover the whole of the top surface 3633 of the first sub layer. FIG. 36b illustrates a moisture electric generating device similar to that described above with reference to FIG. 36 but in the device of FIG. 36b the top electrode 3610 covers the top surface 3633 of the first sub layer. Preferably, such top electrodes should be moisture absorbent and allow moisture to penetrate through the electrode and onto the functional layer. Such electrodes may be porous. Such electrodes may be silver nanowires.

Larger top electrodes, having greater contact area (interface) with the functional layer, can result in larger current carrying capacity through the electrode joint. However, if the electrode is too large then water can be prevented from escaping from the functional layer and also moisture may be prevented from contacting the surface through the electrode.

Porous top electrodes 3610 allow moisture to penetrate through the electrode and into the top surface 3633 of the functional layer. Consequently, if the top electrode 3610 is porous, a larger top electrode can be used which covers a greater portion of the top surface of functional layer but still allows absorption of moisture into the top surface 3633 of the functional layer. The moisture is absorbed into and passes through top electrode 3610 and into the surface of the functional layer. Porous electrodes allow an increase the contact area between the electrode and the surface of the functional layer to help achieve higher current. An example of a porous electrode that may be suitable for use as a top electrode is a silver nanowire based electrode.

More generally, examples of a porous electrodes include electrodes containing metal nanowires. Preferably, the metals should have a good resistance to corrosion if it is for long term use. The metal nanowires have a network structure so moisture can penetrate through the electrode and into the functional layer.

If the top electrode fully covers the top surface of the first sublayer (as shown in FIG. 36b) and is not porous, it will prevent moisture from being absorbed into the top surface of the first sub layer. In such devices moisture may be absorbed into the first sub layer from the sides of the device (and any other parts of the first sub layer which are exposed to environmental conditions). In FIG. 36b moisture 3640b and 3640c may be absorbed through the surface area of sides 3632c and 3236b of the first sub layer. In these cases the surface area of the first sub layer which is able to absorb moisture from the environment is significantly reduced compared with devices with electrodes which partially cover the top surface of the first sub layer and/or porous electrodes. This reduces the amount of moisture which may be absorbed from the environment compared with the devices with electrodes which partially cover the top surface of the first sub layer and/or porous electrodes.

The sub layer acting as a moisture reservoir, for example a polymer layer, may include ionic salts. The concentration of salt plays a significant role in the device performance. The presence of ionic salts in the polymer layer provides mobile ions that could serve as the media to strengthen the ion concentration gradient across the device. MEG devices including ionic salt within the polymer layer may possess a higher voltage output than the device without the ionic salt. Such free ions significantly enhance the conductivity of the polymer layer. Salts include NaCl and Kcl. Li, Na and K are considered Group 1 alkaline metals.

There are several advantages of the presence of ionic salts in the polymer layer. 1) Ionic salts decrease the internal resistance through introducing mobile ions, which will enhance the power output; 2) the salts will enhance the water adsorption capability of the water reservoir sub layer; 3) the ions will response to the change of humidity: at low humidity, ions at the air-exposed interface are activated due to the loss of bound water molecules, and their ion-hydration energy is greater than that of the ions at the hydrogel's bottom region. The momentum for ion migration is developed by such energy difference.

The sub layer acting as a moisture reservoir may be a hydrogel layer. Hydrogels are three-dimensional networks of polymer chains. Hydrogels are hydrophilic and can absorb large amounts of water. Advantages of the use of hydrogels are that they have good moisture absorption properties. They can absorb moisture even in low humidity environments. Hydrogels can be hydrated and provide a source of moisture to adjacent sub layers. This makes them effective for use as a moisture reservoir layer (hydration layer).

Hydrogels have three-dimensional frameworks. This structure provides operational durability as the structural integrity of the hydrogel layer can be maintained even in humid environments as the hydrogel is hydrated. This allows the MEG device to maintain performance. Hydrogels are also versatile in the materials that can be doped with various ions. These are ionic hydrogels. For examples, metal ions, salts can be injected into the hydrogel. This provides flexibility of charge carriers when designing a MEG device.

Hydrogels provide excellent water retention capability. Hydrogels can contain mobile ions caused. The hydrophilic properties of hydrogels having efficient moisture absorption capabilities mean that the device is less restricted by the humidity conditions of the environment compared with single layer, conventional, MEGs, and it can still produce electricity under low humidity environments,

The first sub layer may be doped with charge carriers. Introducing additional charge carriers enables the electrical performance of the moisture electric generating device to be improved.

In high humidity environments in which there is an abundance of moisture and an abundance of H₊ ions from the disassociation of H₊ ions from moisture, the dominant charge carrier is H₊ ions. In lower humidity environments, fewer H₊ ions are dissociated due to a reduced amount of moisture but the metal ions from the first sub layer remain mobile and so metal ions can contribute to the electrical performance of the MEG device.

### Section 5: Meg Device Having Layered Structure and Including Polymer:

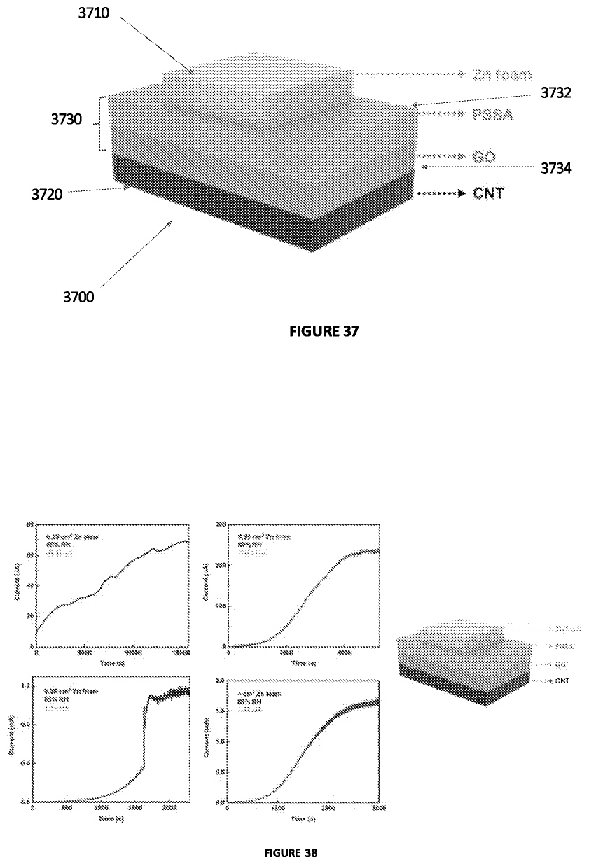

Referring now to FIG. 37, electricity generating cell 3700 includes a first electrode 3710 and a second electrode 3730. Located between the first and second electrodes is a functional layer 3730. The functional layer releases electrical charge carriers when the electricity generating cell 3700 is exposed to moisture. The functional layer has moisture electric generator (MEG) properties. Moisture includes water molecules. Water molecules may be present in liquid or water vapour and in humid environments. MEG properties include functional groups that produce charge carriers by dissociating water molecules.

In the example of FIG. 37, functional layer 3730 includes two sub-layers 3732 and 3734. Further embodiments may include more than two sublayers. The sublayers are stacked between the first electrode 3710 and the bottom electrode 3720. In the example of FIG. 37, both of the sublayers release electrical charge carriers when the electricity generating cell 3700 is exposed to moisture. Both layers have MEG properties. In FIG. 37 sublayers 3732 and 3734 comprise different materials. The sublayers may release the same type of charge carriers.

Sub layer 3732 is a polymer sub layer. In the example of FIG. 37, the polymer is 4-styrensulfonic acid (PSSA). Alternative polymer materials suitable for the polymer layer include PSSNa, PAA, PVA, PSSLi, PSSK, PSSNH4, PSSMg2, PSSAI3, PSSH.

PSSA is acidic and can be corrosive. Advantages of other polymer salt based materials, including PSSNa are that the material is neutral and non acidic. Giving this structure an advantage to be implemented into wearable technologies.

Sublayer 3734 releases electrical charge carriers on exposure to moisture. That moisture may be received from polymer layer 3732. Polymer layer 3732 acts as a moisture reservoir.

It provides moisture and hydrates layer 3734. In the example of FIG. 37, sublayer 3734 is a graphene oxide (GO) sublayer. GO has advantages over other materials owing to it rich functional groups. In other examples, sublayer 3734 may be a carbon-based material. In further examples, sublayer 3734 may be a polymer layer. Examples of suitable polymers include, PVA, PAA.

MXene and oxidised MXene may also be used as sublayers.

Sublayer 3732 is adjacent to sublayer 3734 and is electrically connected to sublayer 3734. The surface areas of the sublayer form an interface.

First electrode 3710 is adjacent to polymer sublayer 3732. First electrode 3710 is electrically connected to polymer sublayer 3732.

In the example of FIG. 37, first electrode 3710 is porous to moisture. Moisture may permeate through electrode 3710 and into the polymer layer 3732. In the example of FIG. 37, first electrode 3710 partially covers polymer layer 3732. In further embodiments, first electrode may completely cover the top surface of the polymer layer 3732. When electricity generating cell 3700 is exposed to moisture, moisture may permeate directly into the polymer sublayer 3732 through those parts of the sublayer which are directly exposed to moisture. Moisture may also permeate into the polymer layer 3732 through the first electrode 3710.

In the example of FIG. 37 the first electrode 3710 is Zn foam. In other examples, the first electrode may comprise Ag, Zn, Zn plate, Zn foam, Al, Mg, Cu, Ni, Fe, or Ti.

Sublayer 3734 is adjacent to the second electrode 3720 and is electrically connected to the second electrode 3720. In the example of FIG. 37, second electrode 3720 is carbon nanotube. Electrode 3720 covers the surface of sublayer 3734. In the example of FIG. 37, the second electrode 3720 is insulating to moisture. The second electrode 3720 repels moisture. Moisture is unable to penetrate through second electrode 3720 into sublayer 3734.

In the example embodiment the second electrode is carbon nanotube (CNT).

An advantage of the stacked structure of electricity generating cell 3700 and the electrode configuration is that when electricity generating cell 3700 is exposed to moisture, moisture is able to penetrate into the polymer sublayer 3732 either through the first electrode 3710 or directly via contact with the surface of sublayer 3732. But moisture is prevented from penetrating into sublayer 3734 via the second electrode. This configuration creates a moisture gradient across the electricity generating cell. In particular, a moisture gradient is created across the function layer 3730.

Sub layer 3732 is more hydrophilic than sub layer 3734. By positioning polymer layer 3732 in in ambient (environmental) conditions in preference to GO layer 3734, the moisture electric generating device 3700 absorbs more moisture from the environment, compared with GO layer being in ambient conditions. This improves the moisture absorption efficiency of the moisture electric generating device 3700.

Another advantage is this stacked structure can have much higher voltage output compared with single layered MEG. Also the combination of two layers with different moisture absorption properties will prolong the life time of the MEG.

The sublayers 3732 3734 may have different moisture absorption properties. In the example of FIG. 37 sublayer 3732 has greater moisture absorption properties than sublayer 3734 (i.e. sub layer 3732 is more hydrophilic than sub layer 3734).

The advantage of sublayer 3732 having greater moisture absorption properties compared with sublayer 3734 is that, when the electricity generating cell 3700 is exposed to moisture, sublayer 3732 can act as a moisture reservoir to sublayer 3734. So moisture is absorbed into the PSSA sublayer 3732. The absorbed moisture can penetrate through the PSSA sublayer 3732 and penetrate into GO sublayer 3734 via the interface between the sublayers.

This enables the layer to work at low humidity. The device can work at low humidity because sub layer 3732 is more hydrophilic and so is able to absorb moisture from the environment, in even in a low humidity environment. In this configuration, the moisture source for sub layer 3734 is sub layer 3732. This means, the hydration of 3734 is reliant on the moisture from sublayer 3732, not the environment (except for those parts of the sub layer 3734 which are exposed to the environment, for example uncovered sections or end, in these cases some moisture may be received directly from the environment in addition to that received from the sub layer 3732).

In the embodiment of FIG. 37 the first electrode 3710 exhibits an electrochemical reaction when exposed to moisture. This electrochemical reaction can increase the voltage across the electricity generating cell 3700. The electrochemical reaction can improve the electrical properties of the electricity generating cell.

Some advantages of polymer based MEG devices include that they are flexible, stretchable, and easy for device fabrication, cost-effective, semi-transparent, workable at low humidity.

Advantages of this structure include working at both low and high humidity, and high voltage and current output.

### Fabrication Technique:

These electricity generating cells were fabricated using the following technique:
Carbon nanotube (CNT), graphene oxide (GO), and Poly(sodium 4-styrenesulfonate) (PSSNa) were each separately dispersed in distilled water by sonification for 30 min. Then, 400 μL 20 wt. % CNT dispersion was dried on PET (1×2 cm2) at 50° C. for 2 h to work as bottom electrode. 200 μL 2 wt. % GO dispersion was dried on CNT film at 50° C. for 2 h (1×1 cm2). Glycerol was mixed with 5 wt. % PSSNa solution in distilled water by sonification for 30 min (PSSNa:glycerol=5:2). The 200 μL mixed solution was dried on PET (1×1 cm2) at 50° C. for 2 h, which was then peeled off to obtain a free-standing polymer film. The polymer film was stacked on the top of GO film with 0.5×0.5 cm2 Zn foam as top electrode.

### Results

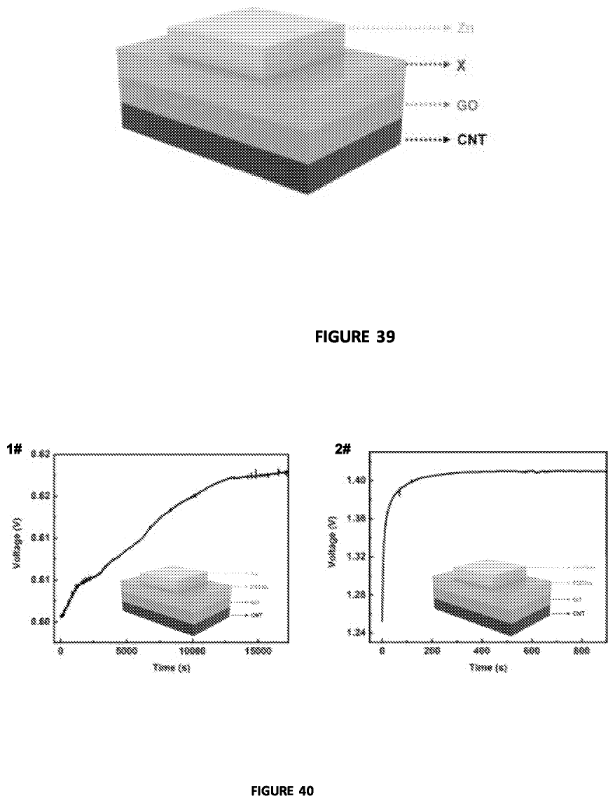

FIG. 38 shows the current characteristics of various samples of electricity generating cells. The performance of the cells is measured in different humidity environments (RH %). FIG. 38 shows the current vs time graphs for moisture electric generating cells having different types of top electrode (Zn plate and Zn foam) and operating in different relative humidity environments (60% RH and 85% RH). The samples show mA range current output. High humidity and large-size electrode lead to good current output FIG. 39 shows the short circuit current of various electricity generating cells. The samples shown in FIG. 39 and Table 3 include different sublayers X in combination with a GO sublayer. Table 3 (below) shows the short circuit current of samples having different first sublayers. The sample size is 0.25 cm2 operating in 85% RH. PSSNa shows better water absorption and lower resistance, which leads to a significantly higher current output. The better water adsorption rate results in higher current output.

TABLE 3
Short-circuit current of device with different functional layer.

| X | PAA | PVA | GO | PSSNa |
|---|---|---|---|---|
| I_{sc}(RH = 85%) | 2.5 μA | 1.1 μA | 2.1 μA | 1.1 mA |

FIG. 40 shows voltage characteristics against time for a first sample #1 having a silver (Ag) first electrode and a second sample #2 having a Zn plate first electrode. The samples include a bottom electrode of carbon nanotube (CNT), first sublayer of PSSNa and second sub layer of GO. The sample with the Zn plate electrode showed increased voltage of 1.44 V compared to 0.62 V from the sample having the Ag electrode at 85% relative humidity (RH). By using an active metal as top electrode, MEG/battery functions can be realized in single device.

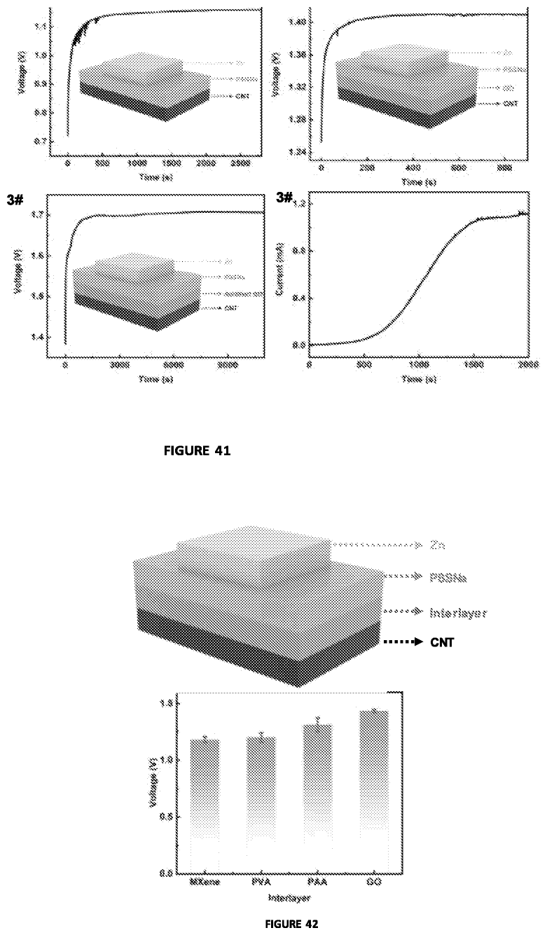

In FIG. 41, sample 1 includes a single functional layer of PSSNa. Sample #2 includes a first sub layer of PSSNa and a second sub layer of GO. Sample #3 includes a PSSNa first sub layer an acidified GO second sub layer. The combination of PSSNa and acidified GO can achieve high voltage and current. CNT and Zn as bottom/top electrodes. GO film was drop-coating on CNT; PSSNa film was free-standing film on GO.

The electrical performance of the samples of FIG. 41 is shown in Table 4 below:

TABLE 4
The electrical performance of the samples of FIG. 41.

| | 1# | 2# | 3# |
|---|---|---|---|
| CNT | ✓ | ✓ | ✓ |
| GO | x | ✓ | ✓ |
| GO acidification | x | x | ✓ |
| PSSNa | ✓ | ✓ | ✓ |
| Zn | ✓ | ✓ | ✓ |
| V(I) | 1.16 V | 1.44 V | 1.71 V (1.11 mA) |

In FIG. 42 the voltages of electric generating devices are shown having different second sub layers. The voltages for devices having a ZN top electrode, PSSNa first sub layer, CNT bottom electrode and second sub layers of MXene, PVA, PAA and GO, are shown. Voltage: MXene(1.18V)<PVA(1.20V)<PAA(1.31V)<GO (1.44V). GO shows the highest voltage. GO has advantages over other materials owing to it rich functional groups.

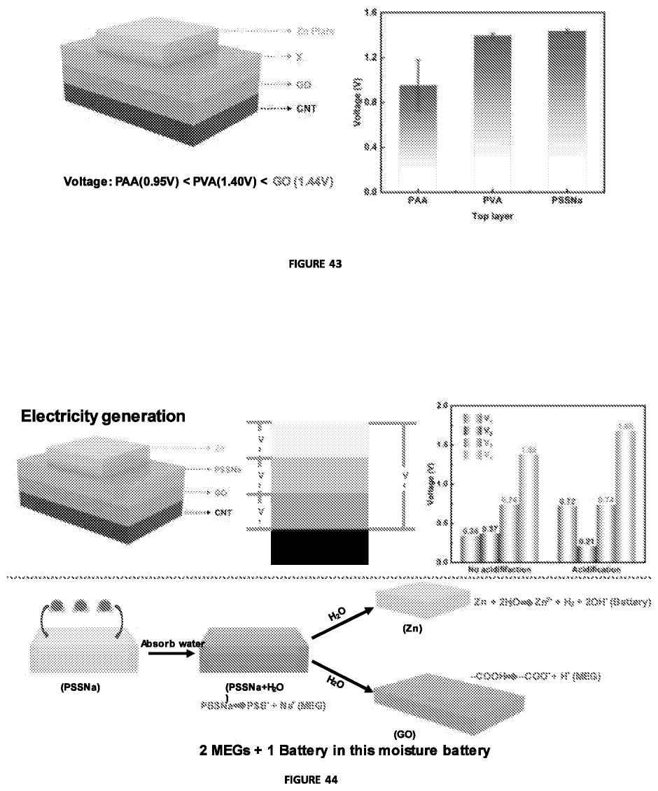

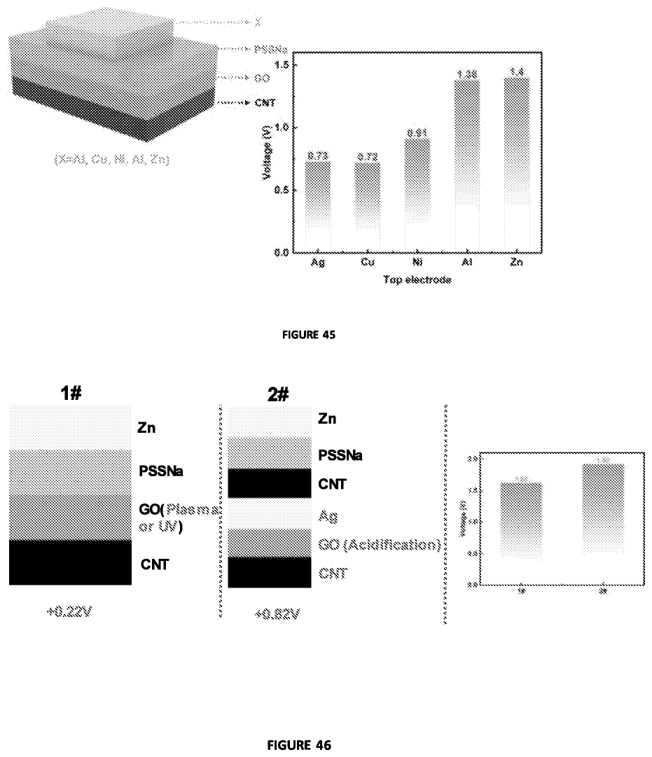

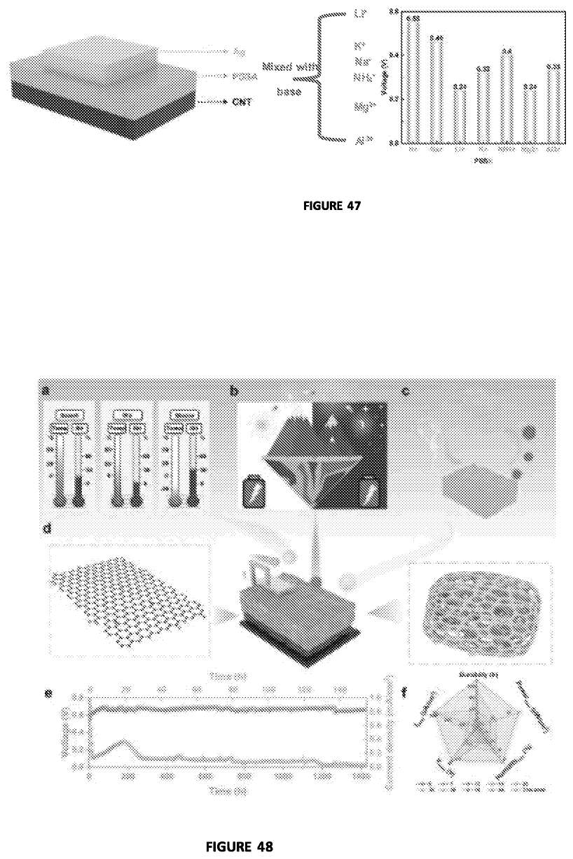

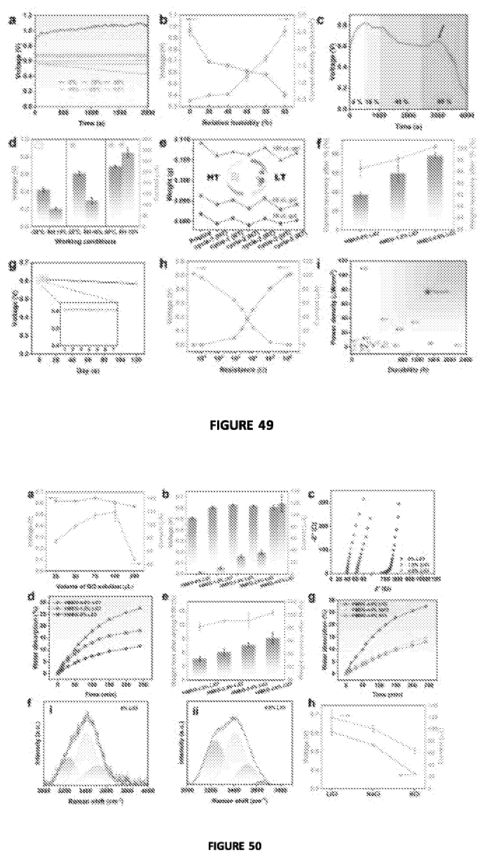

FIG. 43 shows the voltage across top layers of various dual layer moisture electric generating devices.

FIG. 44 shows the voltage across the different sublayers in a electricity generating cell for a cell including a GO sublayer and a cell including an acidified GO sublayer. The samples of FIG. 44 include a Zn electrode and a CNT electrode.

We believe the PSSNa layer acts as a MEG and on absorption of water PSSNa+H2O→PSS−+Na+ (MEG).

We believe the Zn foam electrode acts as a battery according to Zn+2H2O→Zn2++H2+2OH— (Battery).

We believe the GO layer acts as a MEG on absorption of water —COOH→—COO—+H+ (MEG).

FIG. 45 shows the electrical performance of various moisture electricity generating cells having different top electrodes. All samples include PSSNa and GO sublayers and a CNT bottom electrode. The sample with a Zn top electrode exhibits the highest Voltage at 1.4 V. 2 MEGs+1 Battery are demonstrated as well.

FIG. 46 shows the voltage results for further samples. Sample #1 includes a PSSNa sublayer and a GO sublayer treated with plasma or UV. The top electrode is Zn and bottom electrode is CNT. Sample 2 is a stacked MEG with PSSNa and GO dual layers. GO typically only has low power output at low humidity, while PSSNa can work at low humidity. Therefore the combination of the two materials in a single MEG cell enables the effective working at both low and high humidity. On the other hand, the polymer may deform at high humidity so the excessive moisture in polymer should be transferred to other place to prolong the retention. Sample #2 includes a Zn top electrode and CNT bottom electrode.

In the example of FIG. 47 a single functional layer is located between an Ag top electrode and a CNT bottom electrode. Various samples were tested using different PSSX polymers. Voltage is shown to decrease after replacing H₊ with other ions.

### Section 6: Meg Device Having Layered Structure and Including Hydrogel Layer:

A high-performance MEG with a bilayer structure is now described, in which a hydrogel layer with hygroscopic LiCl is included to boost the electrical output performance as well as the long-term operational durability of the moisture electric generating device. The hydrogel layer forms the first sub layer of the functional layer of the device. Referring to the MEG device structure shown in FIG. 36, in the following examples, the first sublayer 3632 is a hydrogel layer with hygroscopic LiCl, the second sub layer (functional layer) 3634 is a graphene oxide layer. The bottom electrode 3620 is carbon nanotube. The top electrode 3610 is Ni foam. The fabrication process is as follows. Carbon nanotube (CNT) dispersion was coated on polyethylene terephthalate (PET) film (1 cm×2 cm) as the bottom electrode. A GO layer (1 cm×1 cm) over the CNT substrate was obtained by drying 100 μL of 2 wt % GO dispersion at 50° C. The upper hydrogel layer was obtained by drop-coating the as-prepared hydrogel solution over the GO layer. After the gelation is completed, a piece of Ni foam (0.2 cm×0.5 cm) is placed on the hydrogel as the top electrode.

The ionic hydrogel-based MEG (HMEG) can maintain a continuous open-circuit voltage (V_{oc}) of 0.6 V for more than 1400 h at room condition, and generate a high short-circuit current (I_{sc}) of 1.2 mA/cm² and a maximum power density of 71.7 μW cm⁻² owing to the excellent water retention capability and mobile ions caused by the designed hydrogel. The device is less restricted by the working conditions than conventional MEGs, and it can still produce electricity under harsh environments, such as 50° C. (15% RH) and −20° C. (10% RH). Furthermore, the HMEG can even deliver an ultrahigh voltage of 1.2 V at 0% RH for more than 10 h.

### Results

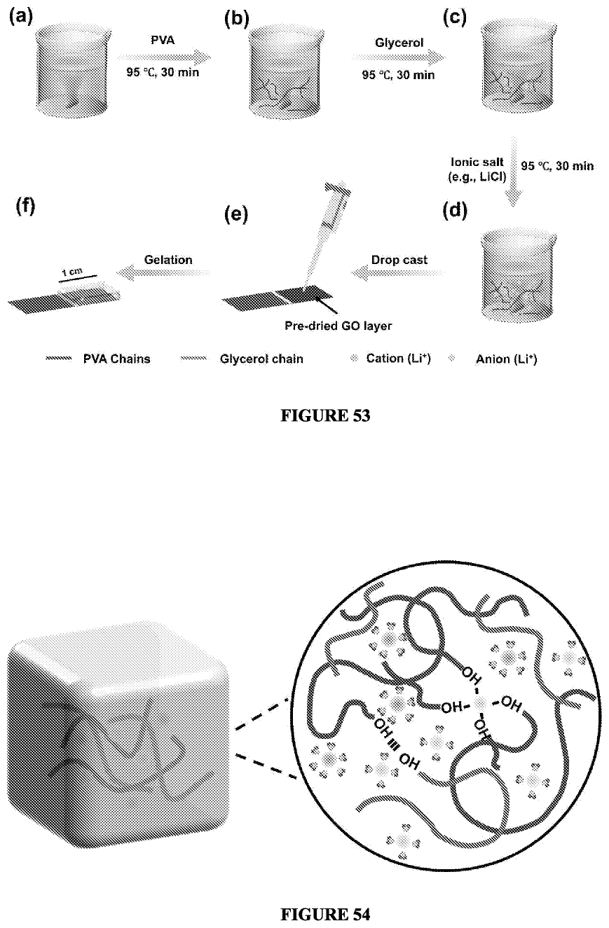

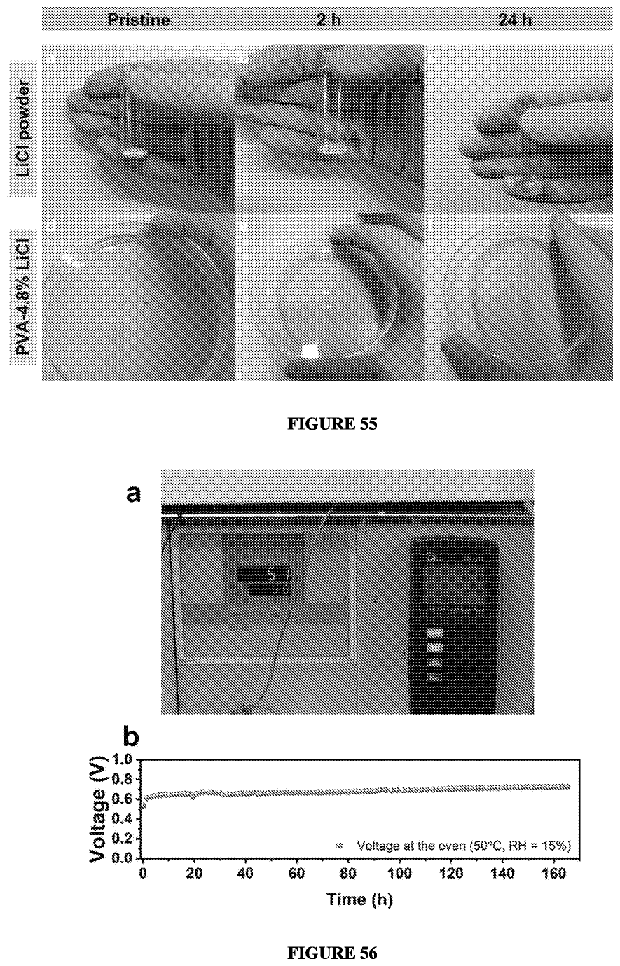

Performance in electricity generation. The HMEG can work at complex environments (e.g., hot, dry, and cold), and exhibits durable output performance and self-restoration (FIG. 48a-c). The functional layer consists of two sub layers, namely the GO bottom layer (second sub layer) and the hydrogel upper layer (first sub layer) (FIG. 48d). The layers are prepared by a facile drop-coating method. Specifically, the as-prepared hydrogel solution is dropped over the bottom layer (FIG. 53). The precursor self-gelated through the formation of hydrogen bond between the hydroxyl groups of PVA and glycerol and coordination bond between the hydroxyl groups and the added ions (FIG. 54). Unlike deliquescent LiCl powder, the PVA-LiCl hydrogel exhibits no physical changes upon exposure to ambient conditions, which indicates the PVA-LiCl hydrogel could be suitable for long-term usage (FIG. 55). In addition, the formed hydrogel contains abundant water that keeps the underlayer GO hydrated (FIG. 48d). As shown in FIG. 48e, the proposed HMEG exhibits outstanding stability in long-term output performance, which could sustain an open-circuit voltage (V_{oc}) of >0.6 V for more than 1400 h and continuously produce a current for more than 140 h at RH of 45%±10%. The variation of the electrical signal in the curves is mainly ascribed to the environmental fluctuation at ambient condition during the long-term measurement. The HMEG demonstrates superior overall performance (FIG. 48f). More surprisingly, the device is also capable of generating electrical signal at high temperature and low humidity (50° C., 15% RH) for more than 150 h (FIG. 56).

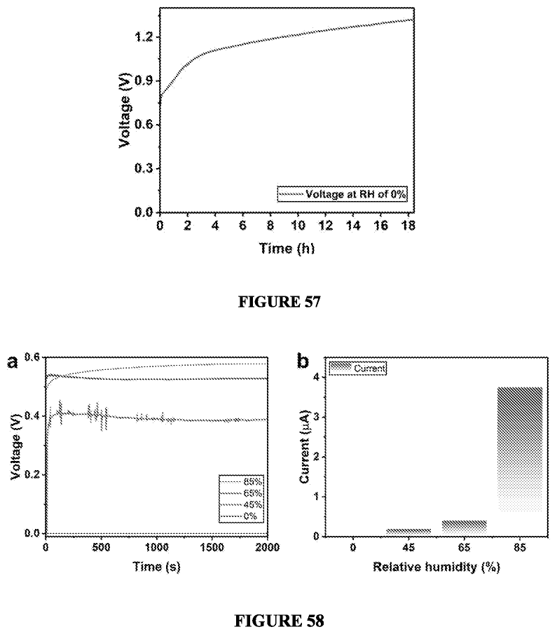

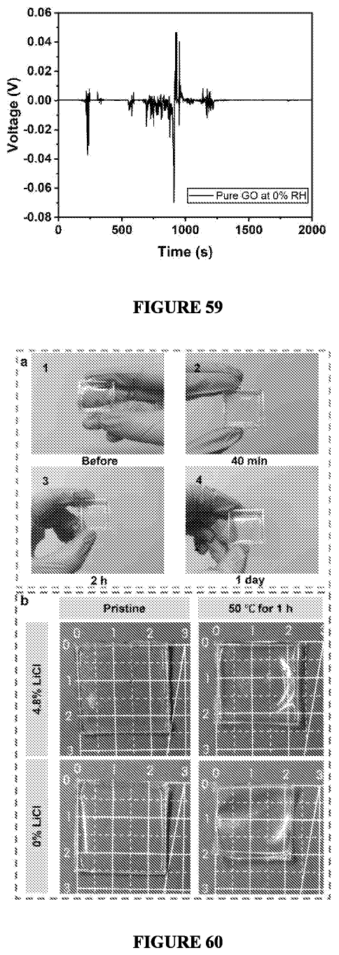

Similar to other conventional MEGs, RH is a key factor on the electricity generation performance of the HMEG. However, the HMEG performs distinctively in response to RH variation. As shown in FIG. 49a, b, the voltage output is inversely proportional to RH while a higher current output could be realized by increasing RH. Degradation in voltage could be observed if RH is above 65%. Interestingly, the maximum V_{oc} is recorded at RH of 0% (FIG. 49a, b), and the voltage gradually reaches and maintains above 1 V for more than 10 h (FIG. 57). On the other hand, dynamic monitoring of the voltage output under varied RH is shown in FIG. 49c, and it is noted that a small burst on the voltage (indicated by the arrow) is observed when RH reaches at 85%. This is ascribed to the instantaneous accumulation of water within the hydrogel that facilitates the hydrolysis of PVA into mobile ions (H⁺), thus, boosting the device performance in a short period. However, excessive ions could lead to the collapse of ion concentration gradient, resulting in a continuous degradation of performance. As a control experiment, both current and voltage outputs of the device composed of a sole GO layer show a positive relationship to the increased RH (FIG. 58). In particular, negligible electricity generation is observed at the harsh condition of 0% RH (FIGS. 58 and 59). Since the dried GO layer intrinsically possesses no water, a substantial RH is required to initiate the ionization of the functional groups (e.g., —COOH) within the GO to release the mobile H⁺. This result strongly indicates that the hydration status of the GO layer determines the device performance. Thus, an additional layer of the ionic hydrogel could significantly assist in hydrating the GO layer at ambient or even the extreme condition (RH of 0%) owing to the abundant water within the hydrogel.

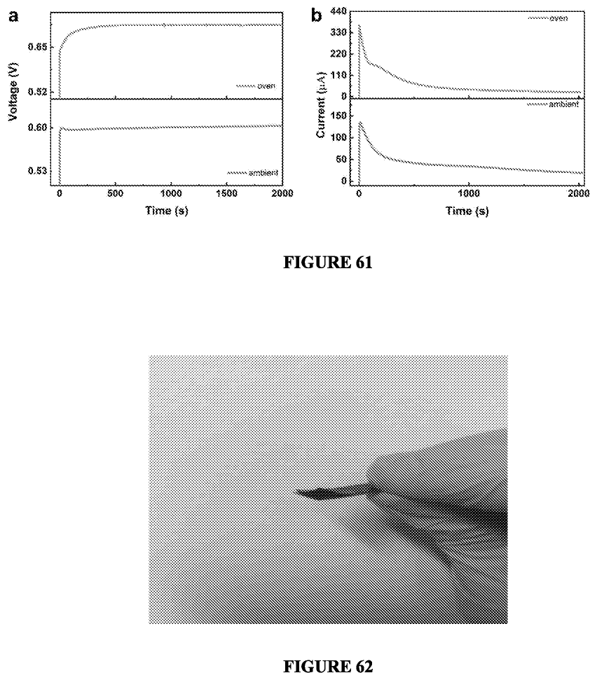

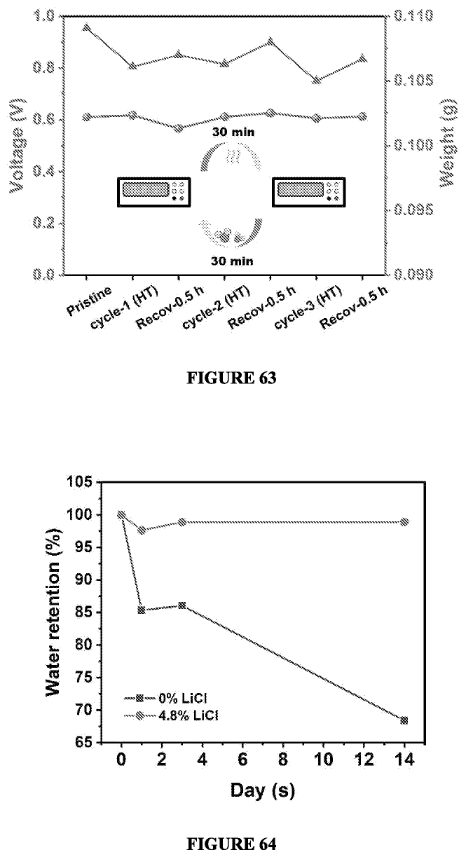

Apart from the room condition, measurement is also conducted in the refrigerator and oven to mimic the harsh conditions. The hydrogel not only displays anti-freezing property due to incorporating glycerol, but also demonstrates tolerance to high temperature through addition of LiCl salt (FIG. 60). Therefore, the function of HMEG in generating electricity could be maintained regardless of the environment (FIG. 48a). As the ion migration is affected by the temperature, the device performance changes in the corresponding environment. In particular, the ionic motion becomes more intensive at high temperature (FIG. 61), therefore, it could be seen that the HMEG shows a higher V_{oc} and short-circuit current (Is_{c}) of 0.7 V and 340 μA, respectively at the oven (50° C.). Though the mobility of ions at the subzero temperature is significantly lower than that under the room temperature, the device can still generate a voltage of 0.4 V with a current output of 75 μA at −20° C. (FIG. 49d). In addition, excellent self-restoration is also demonstrated in the HMEG to meet the demand of cyclic usage. In particular for the application in hot and dry region, weight loss of the hydrogel is unavoidable due to evaporation of water. Restoration of the loss content is a critical factor to fulfill the cyclic function. Therefore, the pristine HMEG was measured at the ambient environment and oven respectively to evaluate the device's cyclability. As shown in FIG. 49e, the weight of the devices decreases after each cycle of dehydration at the oven. Regardless of the thickness of the coated hydrogel, all HMEGs show the ability in recovering the weight by absorbing the ambient moisture. Such self-restoration characteristic is benefited from the superior water absorption capability of the hydrogel. In addition to the weight recovery, the current shares a similar trend in restoring upon absorbing the moisture, as shown in FIG. 49f. The recovery ability is enhanced with a higher concentration of the hygroscopic LiCl salt. A 100% compensation in water content and 80% restoration in current output are achieved in HMEG-4.8% LiCl due to the excellent water absorption. As to the HMEG-0% LiCl, the lower water absorption capability limits the current recovery, making it unsuitable for long-term usage. Besides, detachment from the substrate is observed in HMEG-0% LiCl (FIG. 62) while the gel with a higher concentration of LiCl (7.2%) remains undried with high viscosity after 1 day. Therefore, the concentration of 4.8% LiCl is chosen for the entire experiment. The introduction of LiCl plays a role in endowing the hydrogel with improved water absorption capability, which would be further discussed in the later context. In the meantime, the variation in output voltage shows a steady trend in three cycles of operation, indicating the good stability in different conditions (FIG. 63). The water retention capability is also greatly improved with the addition of LiCl salt. Only 65% weight is kept in HMEG-0% LiCl after 14 days while the device with 4.8% LiCl could retain its weight at ambient environment (FIG. 64). With the excellent water retention capability, the device performance could be maintained for a long time. As shown in FIG. 2g, the HMEG-4.8% LiCl was kept and exposed at the ambient condition without sealing for 4 months (120 days), and no obvious degradation is observed (retention of ˜96%), demonstrating an outstanding stability in electricity generation.

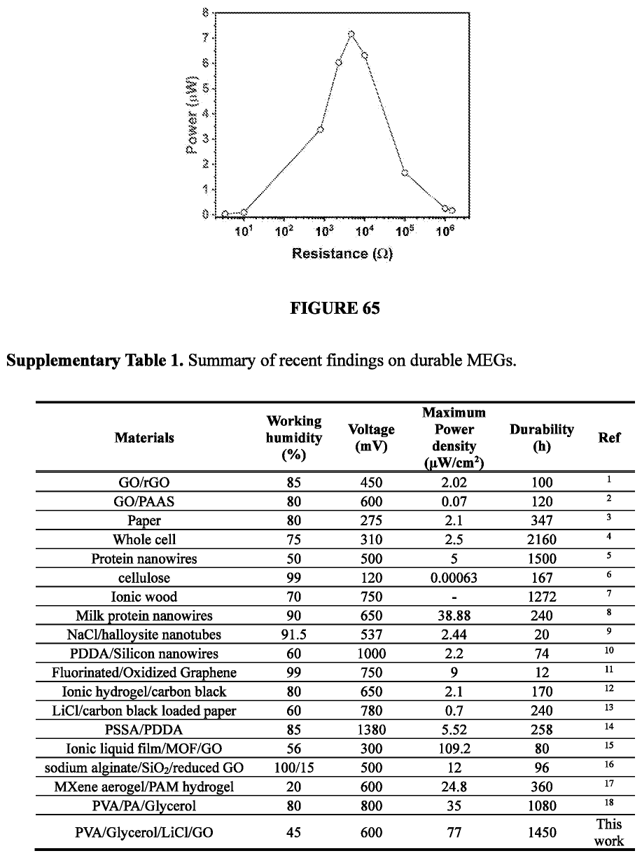

The power output of the HMEG is further evaluated under different external loads. As shown in FIG. 2h, the voltage output increases while the current output decreases when the load resistance increases from 1Ω to 2.5 MΩ. A maximum power density of 71.7 μW/cm² was achieved at the load resistance of 4670Ω (FIG. 65), which is the optimal result compared to most inorganic materials-based MEGs in the recent reports (FIG. 2i and Supplementary Table. 1).

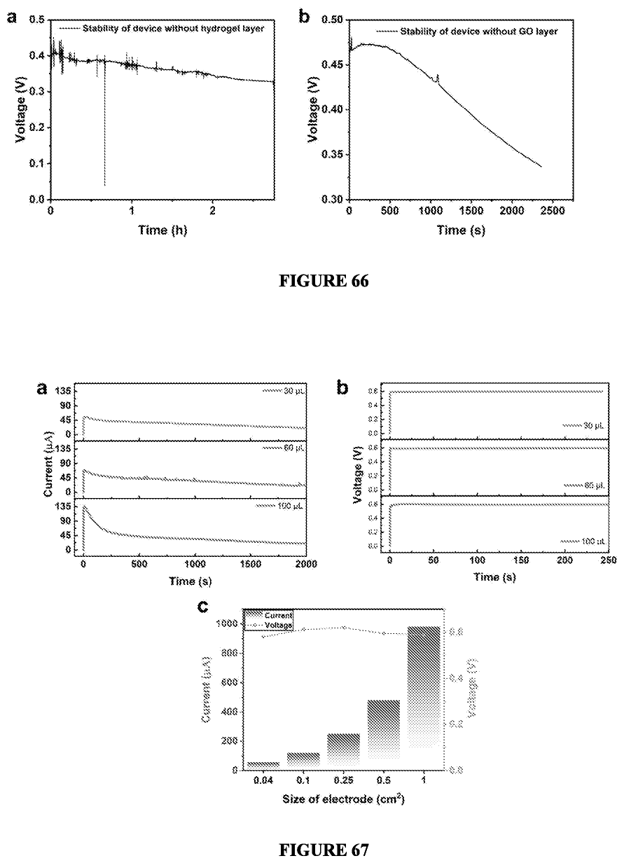

Influencing factors on the output performance. As aforementioned, the device is designed with a bilayer structure that has a bottom layer of GO and an upper layer of PVA-LiCl hydrogel, respectively. It should be noted that the device consisted of a sole GO layer or a sole hydrogel layer shows a gradual degradation of voltage output, which is certainly not applicable for long-term usage (FIG. 66). One of the reasons could be the lack of management of ion diffusion. As the hydrogel with LiCl possesses an outstanding water absorption capability, the ion concentration gradient across the hydrogel could be collapsed with time easily. Herein, the bilayer structure with stable output is proposed, in which the hydrated GO layer with a negative-charged nature assists in attracting the positively charged mobile ions (e.g., H⁺) like a screening layer for electricity generation. In this case, the effect of the layers on the HMEG performance is investigated. For the bottom GO layer, the layer thickness can be controlled with different volume of the GO solution. The influence of GO layer thickness on the voltage is not as obvious as that on the current output, as shown in FIG. 50a. The voltage retains at above 0.6 V with different layer thicknesses. Generally, the device voltage is governed by the ion concentration gradient between the upper and bottom surface of the device. Since the bottom GO layer is completed hydrated due to the added hydrogel, the ion concentration gradient within the GO layer is insignificant regardless of the GO thickness. Instead, the current of the device increases greatly with a thicker GO layer and becomes saturated at 120 μA. This could be ascribed to more dissociated mobile ions from the functional groups in the thicker GO film. However, a degradation in current is observed when the GO thickness is further increased, which is attributed to the long migration distance for the mobile ions. Meanwhile, the thickness of the hydrogel layer is also investigated. Similar to that of the GO layer, the hydrogel thickness has more impact on the current output (FIG. 67) due to the more charge carriers (e.g., Li⁺) within a thicker hydrogel.

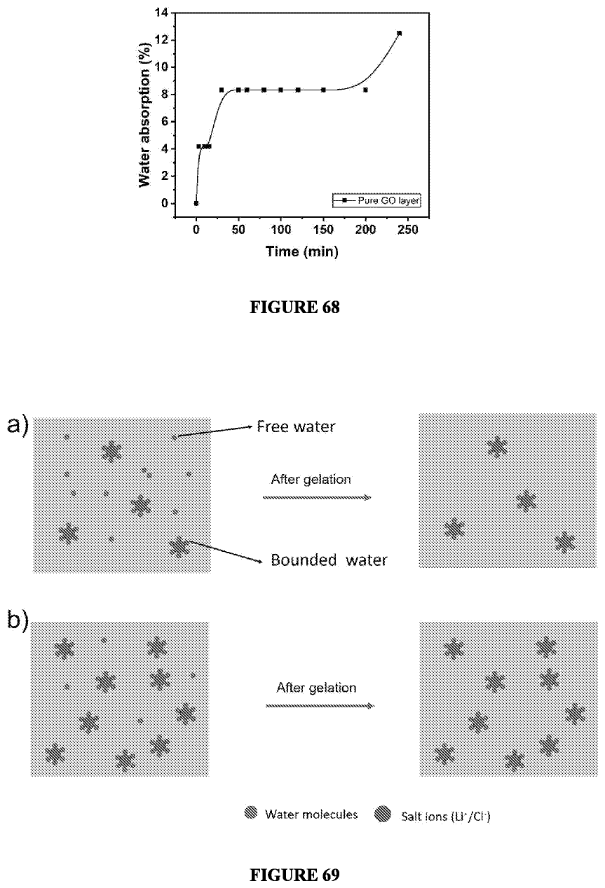

In addition, the concentration of added salt also plays a significant role in the device performance. The presence of ionic salts offers the HMEG with mobile ions that could serve as the media to strengthen the ion concentration gradient across the device, therefore, it could be seen that the HMEG possesses a higher voltage output than the device without the ionic salt, as shown in FIG. 50b. In particular, such free ions significantly enhance the conductivity of the hydrogel. The device resistance obtained from EIS measurement reflects that the hydrogel with 0% LiCl has a ten-fold higher resistance than that with 1.2% LiCl (FIG. 50c). With the increment of the concentration to 4.8%, which is the selected as the optimal concentration in this work, the resistance of the hydrogel is further reduced. The reduction in resistance facilitates the ion migration, boosting the current output of device. As such, an outstanding current signal is recorded as ˜120 μA when 4.8% LiCl is employed in HMEG (FIG. 50b). Furthermore, the water absorption capability of the hydrogel is also improved through adding the salt. Benefiting from the characteristic of hygroscopicity, LiCl could significantly absorbs moisture and binds with the water molecules. Regardless of the concentration of the added LiCl, the dehydrated HMEG also demonstrated the capability in absorbing water from the moisture (FIG. 50d). However, there is an obvious increase in the function, which is directly proportional to the concentration of the added salt, and the water absorption of the optimal design is 3-fold higher than that of the unsalted hydrogel and the pure GO (FIG. 50d and FIG. 68). The enhanced water absorption capability is beneficial to realize the proposed recovery function of the HMEG, which facilitates the water restoration to recharge the electrical performance.

However, as shown in FIG. 50e, a higher weight loss is seen at the hydrogel with a higher ionic concentration after settling at 50° C. This is because that more ions are present to interact with the water molecules in the hydrogel during the gelation process, resulting in more stored water (FIG. 69). Conversely, less water exists in the low-concentration hydrogel, which indicates less water to be evaporated during operations. In general, there are three states of water within the hydrogel, namely bond water, free water, and intermediate water. The water that forms strong hydrogen bond with the polymer chain refers to the bound water, which requires the highest activation energy to break the bonding before escaping from the hydrogel⁴⁷. The free water behaves naturally as the bulk water while the intermediate water is that with weakly or non-hydrogen bonded water molecules⁴⁸. Such water state is characterized through tracking the O—H bond with Raman spectrometer. As shown in FIG. 50f(i), the Raman shift of 3515 cm⁻¹ and 3630 cm⁻¹ indicates the existence of intermediate water within the hydrogel. As aforementioned, the addition of salt is capable of forming complexation with the polymer chains, leading to increased amount of intermediate water by reducing the formation of hydrogen-bonded water⁵⁰. In other words, the amount of intermediate water within the hydrogel is proportional to the salt concentration. Owing to the less-bounded nature, intermediate water is reported to evaporate with the least demand of energy⁵¹. For this reason, a higher amount of water loss could be seen in the hydrogel with a higher salt concentration.

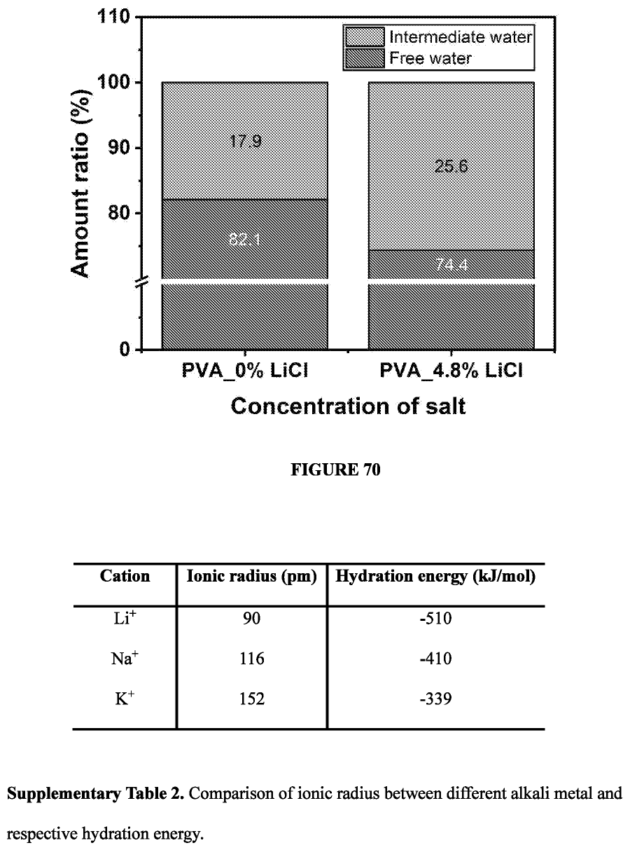

The difference indicated by the Raman spectra of the hydrogels also shows a good agreement with the research findings. The ratio of intermediate water increases from 17.9% to 25.6% upon introducing 4.8% LiCl to the pure PVA-glycerol matrix (FIG. 50f(ii) and FIG. 70). Despite the weight loss due to the water evaporation at high temperature, the ionic hydrogels exhibit the function in recovering the weight by capturing the moisture, as shown in FIG. 50e. A higher efficiency in restoring water could be obtained through increasing the ionic concentration, which is a prerequisite for effective electricity regeneration.

The impact by the type of hygroscopic salt should also be highlighted, and two other common hygroscopic salts NaCl and KCl are added into the system. Similar to Li, Na and K are also identified as the group 1 alkaline metals. As shown in FIG. 3g, the HMEG with LiCl owns the optimal function in water absorption, following by NaCl and KCl in sequence. This could be ascribed to the highest degree of hydration of Li⁺ compared to Na⁺ and K⁺, which is resulted from the smaller hydrated ionic radius (Supplementary Table. 2), and thus, more water molecules could be surrounded by the ions. In addition, the small hydrated ionic radius makes the Li with the efficient transportation rate compared to Na⁺ and K⁺. Therefore, it was monitored that the device with Li ions exhibits the highest current output, following by Na₊ and K⁺ ions sequentially (FIG. 50h). The voltage performance between different ionic hydrogels also shares the similar trend with the corresponding water absorption capability (FIG. 50h). The poorer water absorption capability in the hydrogels with KCl and NaCl suppresses the dissociation of mobile ions, and thus limits the ion concentration gradient across the device.

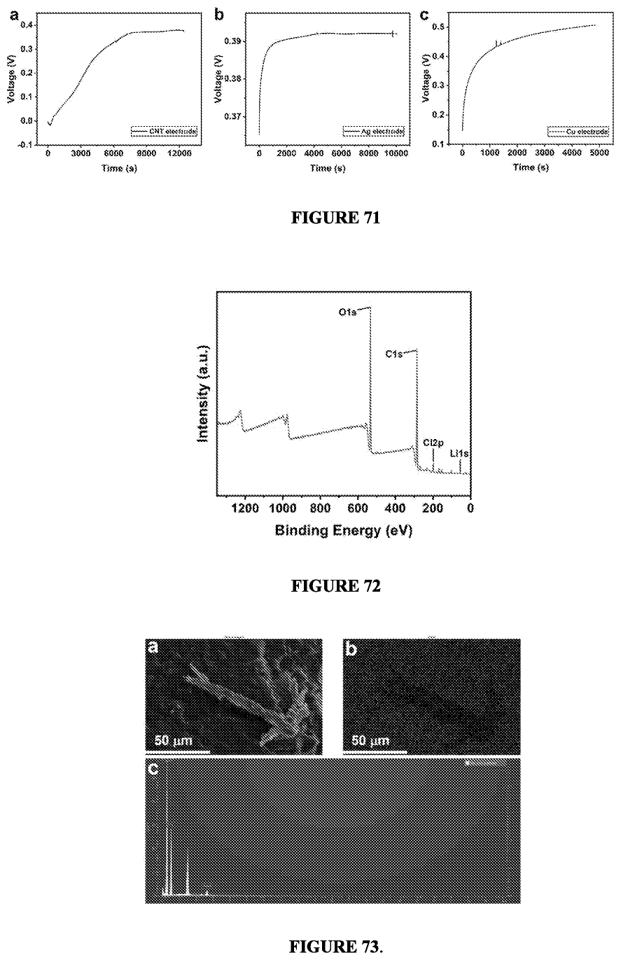

Since the top electrode works as the current collector, which reflects the effective working area, the electrode size is investigated. As shown in FIG. 67c, the current output is demonstrated to be proportional to the working area of the electrode, which increases from 80 μA to ˜1 mA with the electrode size increasing from 0.04 to 1 cm². In contrast, the voltage has less reliance on the electrode size and still retains at ˜0.6 V. Besides, the type of electrode materials also plays an important role in determining the device performance (FIG. 71). A symmetrical structure is constructed by designing both top and bottom electrodes with the CNT sheet, and materials different to CNT (e.g., Ni, Ag, and Cu) are also employed to develop asymmetrical structure. The symmetrical structure is capable of generating a V_{oc} of 0.35 V at the ambient condition. The generated electric signal from the symmetrical design also validates that the electricity is induced by the ion diffusion dissociated from the functional materials in the HMEG, which is stimulated by the moisture from the environment. When it comes to the asymmetrical structure, the HMEG with Ni electrode possesses the best performance among the selected metallic electrodes, following by Cu and Ag sequentially (FIG. 2a, FIG. 71). The difference in the electric output can be attributed to the work function difference between the two electrodes (Ni, 5.35 eV; Cu, 4.94 eV; Ag, 4.74 eV). Specifically, Schottky contact is formed within the device with different electrodes, thus confining the ion migration in a unique direction. Therefore, the greater work function difference is, the better electric output could be obtained.

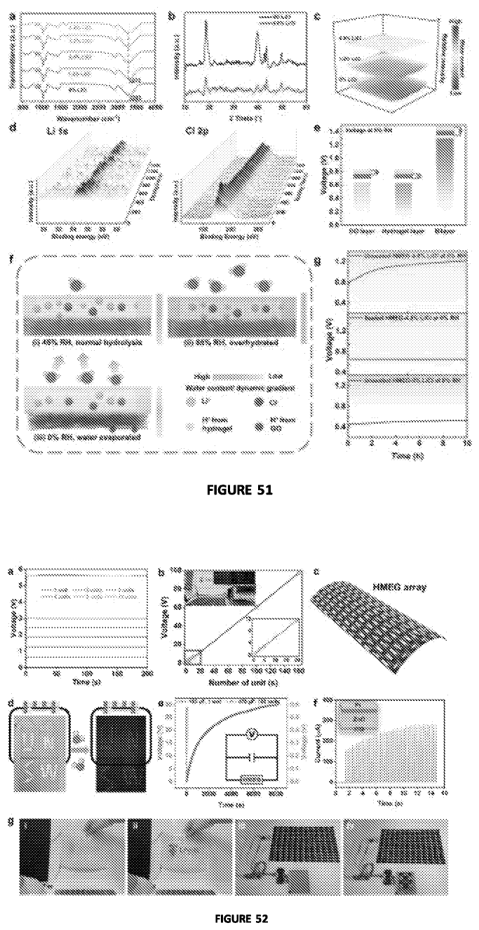

Mechanism in Hydrogel Formation. FTIR spectroscopy was employed to analyse the molecular interactions in the hydrogel (FIG. 51a). One of the characteristic peaks of PVA is at 3293 cm⁻¹, which corresponds to the stretching vibration of the hydroxyl group (—OH). The characteristic peaks at 1422 and 2925 cm⁻¹ are related to the —CH and —CH₂ stretching vibrations, respectively. On contrary to other characteristic peaks, the wavenumber of the —OH peak shifts to 3273 cm⁻¹ upon addition of LiCl, indicating the strong interaction between the added ions with the polymeric group. In particular, the Li⁺ ions could form complexes with the hydroxyl group through the coordination bonds In this manner, partial Li⁺ ions are bound to the polymeric chains to assist in forming the hydrogel. The XRD pattern in FIG. 51b also confirms the interaction between the hydroxyl group of PVA and the Li⁺ ions from the hygroscopic salt. The diffraction peaks at ˜19° and 20° are assigned to the (101̅) and (101) planes of PVA, respectively. The peaks at around 40°-43° are associated to the (111), (11̅1), (210) and (21̅0) crystalline planes. However, the intensity of the above diffraction peaks is significantly decreased upon the introduction of LiCl salt. The reduction in crystallinity indicates the strong interaction between the polymer chain of PVA-glycerol matrix with the LiCl salt. The interaction interrupts the crystallinity of the polymer matrix by breaking the hydrogen bonding. It is noted that no crystalline peak of LiCl is detected in the hydrogel with 4.8% LiCl, confirming a homogeneous formation of the ionic hydrogel. Apart from the gelation, the LiCl also contributes to the functionality of the hydrogel. Firstly, the water peak at 1650 cm⁻¹ in the FTIR displays a gradual increment upon adding the salt, revealing a growth on the water content in the hydrogel. 2D Raman mapping was also conducted to evaluate the water content within the hydrogel, which is performed by analysing the intensity of OH— stretching peak. As shown in FIG. 51c, the hydrogel with LiCl is significantly enriched with more water than that without LiCl. Meanwhile, a higher concentration of LiCl results in a greater water content in the hydrogel. The added ions are able to interact with water molecules intensively, in which Li⁺ and Cl⁻ ions could bound with four and six water molecules, respectively. Therefore, water could be confined in the hydrogel and hampered from being evaporated at room condition, contributing to the outstanding water retention capability. As shown in FIG. 64, the addition of LiCl salt could slow down the evaporation of water content in the hydrogel, and more than 95% of the weight can be maintained in the device with 4.8% LiCl in 14 days. Additionally, the structure of water molecules is interrupted by the ions, hence hindering the formation of hydrogen bond between water molecules at subzero temperature. Therefore, the hydrogel exhibits an anti-freezing property to generate electricity at low temperature (−20° C.) (FIG. 2d, FIG. 60).

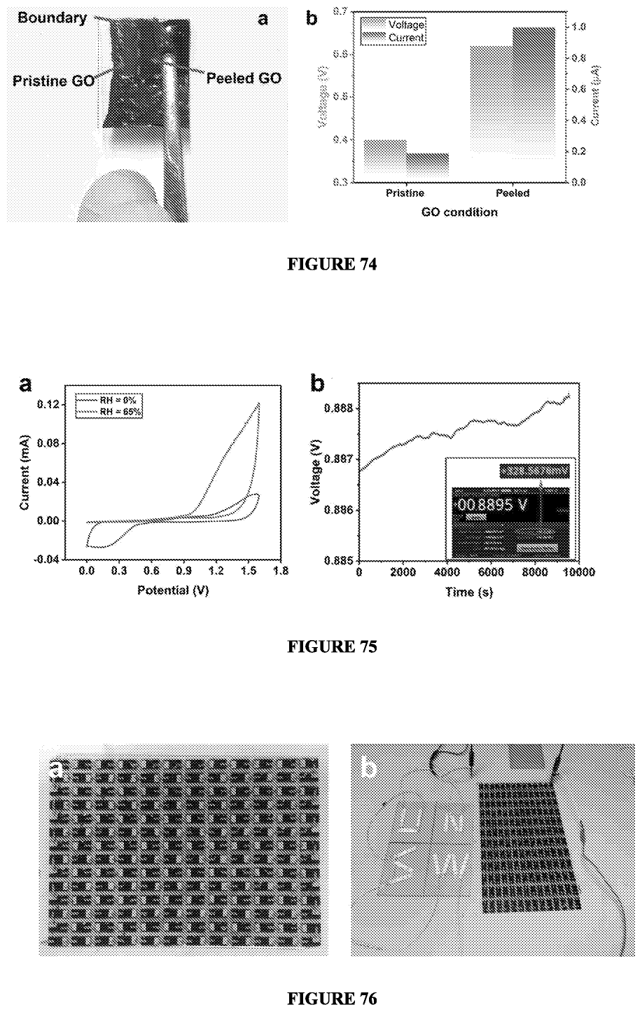

Proposed Mechanism in Electricity Generation. During the fabrication process, the hydrogel solution is directly drop-coated over the GO layer, resulting in the formation of interfacial hydrogen bond between the two layers. Ascribing to the substantial hydrophilicity of GO, water molecules inside the hydrogel solution could easily hydrate and penetrate the GO layer. On one hand, the oxygen-containing functional groups (e.g., —OH, and —COOH) within the GO layer could be dissociated into mobile H⁺ ions and the immobile skeleton upon absorbing water. Therefore, the hydrated GO owns a negatively charged nature and shows the potential in trapping the countered ions. On the other hand, the hydration process expands the interlayer spacing between the GO nanosheets, which facilitates the ion separation and allows more ions from the hydrogel to migrate. As shown in FIG. 51d and FIG. 72, XPS measurement was conducted to examine the elemental composition of the underlayer GO. The peaks at ˜55 eV and 198 eV correspond to the Li 1s and Cl 2p, respectively. The peak of Cl 2p is stronger than that of the Li 1s, suggesting more Cl⁺ ions are detected within the GO layer. The observation further validates the formation of coordination bonds between the Li⁺ ions and the hydroxyl group, which confines partial Li⁺ ions in the hydrogel layer. In contrast, Cl⁺ ions are not bound with the functional group of PVA, therefore, Cl⁻ possesses a higher atomic ratio than Li⁺ within the GO layer. Additionally, EDS mapping also confirms the presence of Cl element within the GO layer, revealing the penetration of the Cl⁻ ions from the hydrogel to the GO layer (FIG. 73). Taken all into account, it shows that the deposited hydrogel layer could hydrate the GO layer and leave the ions as the residue. To determine the involvement of the residual ions, the output performance of the pristine GO layer and the ion-contained GO layer was compared at RH of 45%. The ion-contained GO layer was obtained by peeling from the ionic hydrogel, and a clear hydrated mark was observed on the GO layer (FIG. 74a). The voltage of the ion-contained GO shows an increment from 0.4 V to 0.6 V while the current is 5-fold higher, reaching 1 μA (FIG. 74b). It could be seen that the residual ions promote the performance of the GO layer. The details would be discussed in the following corresponding context.

Analogous to the conventional MEGs, the formed ion concentration gradient governs the electricity generation in the HMEG. The mobile ions within the HMEG migrate from the top to the bottom side of the device under concentration gradient, inducing the potential difference. Conversely, electrons are collected at the top electrode, denoting the generation of current. However, the HMEG performed differently from other MEGs that are positively correlated to the RH. The underlying mechanism of the HMEG could be explained in three different states depending on the RH condition, as shown in FIG. 51f.
i) At the ambient condition (e.g., 45% RH), the hydroxyl group in the PVA could be dissociated into mobile H⁺ ions and immobile —O—skeleton upon encountering the moisture. And the mobile H⁺ ions from the hydrogel are able to hop through the interfacial hydrogen bond driven by the Grotthuss mechanism. Meanwhile, the immobile —O—group could assist in the hopping migration of hydrated Li⁺ ions through the formation of complexation, which significantly increases the conductivity of the hydrogel. As to the role of the overhydrated bottom GO layer, the dissociated H⁺ ions from the GO have limit contribution to the overall voltage, because the ionic concentration gradient is weakly constructed across the overhydrated GO layer. Instead, the dissociated free ions contribute to the improved current output. In this circumstance, the residue Li⁺ ions in the GO layer work as the additional mobile ions to migrate across the GO layer, whose diffusion is guided by the negatively charged surface of the hydrated GO. Besides, the negatively charged Cl⁻ ions are also accumulated within the GO layer, facilitating in constructing a greater electric potential difference across the device. Furthermore, the enlarged interlayer spacing of the hydrated GO layer offers a larger nanochannels to enhance the ion transportation. The synergistic effects of higher electric potential difference and the faster ion diffusion boost the power output of the device at the room condition.
ii) At the moist-enriched scenario (e.g., 85% RH), the superior moisture absorption capability of the ionic hydrogel allows a large amount of water to be harvested from the surroundings. Initially, the surface exposed to the moisture will release H⁺ ions from the hydroxyl group as usual. This could explain the observation of a short period of voltage increment at RH of 80%. With the time growth, excessive water is retained within the hydrogel, where extensive H⁺ ions are accumulated across the hydrogel layer, while the underlayer GO keeps overhydrated. In this regard, the device lacks the ion concentration gradient, leading to the continuous degradation of output voltage (FIG. 2c).
iii) At the low-humidity environment (e.g., 0% RH), it was observed that the voltage of the HMEG gradually rises instead of declining as other reported MEGs. To exclude the possibility that the voltage increment is caused by the electrochemical reaction, CV measurement was firstly conducted. The CV curves reveal that no significant electrochemical reaction occurs regardless of the RH (FIG. 75a). Besides, the top Ni electrode is replaced by Ag plate, whose reactivity is more inert than that of Ni. As shown in FIG. 75b, the voltage of the HMEG with Ag electrode is similar to that of the device with Ni, and it also increases gradually at RH of 0%. The voltage of each individual layer is measured with the Ni electrode, as shown in FIG. 51e. The voltage of the GO and hydrogel layer is 0.62 V and 0.6 V, respectively. And the device with a bilayer structure exhibits a voltage of ˜1.2V, which is consistent with the combined voltage of the series-connected hydrogel and GO device. It is noted that water within the hydrogel tends to evaporate to reach equilibrium under the low RH environment. The bonding between the water molecules and the Li⁺ ions is broken in this case, allowing the water molecules to evaporate naturally. It was reported that ions bound with more water molecules own a lower ion-hydration energy. During water evaporation, ions at the air-exposed interface are activated due to the loss of bound water molecules, and their ion-hydration energy is greater than that of the ions at the hydrogel's bottom region. The momentum for ion migration is developed by such energy difference. The release of ions (Li⁺) serves as the charge carrier rather than the H⁺ ions, which are dissociated from the hydrolysis of the PVA hydroxyl group at RH of 45%. In contrast, the capability of the device with 0% LiCl to generate electricity is limited when exposed to a low-humid environment due to a lack of mobile Li⁺ ions at RH of 0%. As a result, the hydrogel layer with LiCl was able to retain the output even at 0% RH. Meanwhile, the number of Li⁺ ions released from the ionic hydrogel increases over time, which could be reflected in the continuous increase of the output voltage. For control experiments, a HMEG sealed with water-proof film and a HMEG with 0% LiCl were measured at 0% RH, respectively. As shown in FIG. 51g, both HMEGs display a stable voltage at only 0.5 V, which is similar to that at the ambient condition (45% RH), instead of increasing to above 1 V in the unsealed HMEG with 4.8% LiCl. As to the sealed HMEG, water evaporation from the hydrogel is prevented while water is reserved within the sample, providing an ambient-like environment to maintain the device performance at 0.5 V. Despite the water evaporation from the unsealed HMEG-0% LiCl, negligible improvement is observed, further confirming that the added salt is also important as it serves as the donor of charge carriers when water evaporation occurs. Taken all into account, water evaporation affects the electrical signal while the introduced salts dominate the voltage increment at 0% RH.

Aside from the hydrogel, the GO layer in this condition contributes to the overall output performance, with a similar characteristic to the ion-contained GO at 45% RH (FIG. 74b). Firstly, the aforementioned residual ions within the GO layer are the contributor to boost the corresponding voltage from 0.4 V to 0.6 V (FIG. 51e). Water evaporation at 0% RH could alleviate the overhydration status of the GO layer. Instead of acting as an ion migration pathway in the ambient condition, the GO layer is reactivated in the low-humidity condition to act as a proton donor and enlarge the electric potential difference, resulting in an increase in output performance.

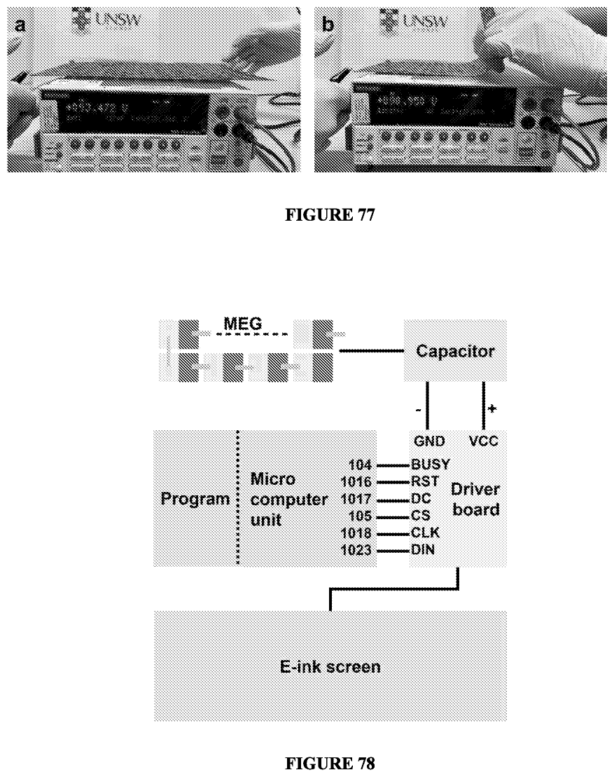

Applications of the HEMGs. Despite the substantial output of a single unit, the overall power output needs to be further enhanced to drive the commercial electronics. The facile fabrication in this work offers the feasibility in scaling up the devices to boost the electric output. As shown in FIG. 52a, 2 devices connected in series could generate twice the output voltage to 1.2 V. Such voltage could be further increased by connecting with more units, which shows a linear relation with the number of the devices (FIG. 52a, b). Besides, a large-scale connection of 168 units is achieved in series on a flexible PET substrate (210 mm×297 mm), which is able to output a total voltage of ˜97 V (FIG. 5b, c, FIG. 76a). More importantly, the large-scale device exhibits a voltage retention of more than 95% during the mechanical bending, showing a great potential as the power supply for the wearable electronics (FIG. 77). A pattern of “UNSW” designed with 39 LEDs could be directly illuminated by the power supplied from the 168 HMEGs (FIG. 52d, FIG. 76b). Commercial capacitors could be also employed to store the generated electricity for the utilization on other electronics. The 100 pF and 470 pF capacitors could be charged to 0.58 V (1 unit) and 30 V (168 units) at the ambient condition, respectively FIG. 52e). In addition, the stored power can be used to generate pulse train to realize the typical potentiation behaviour of a synaptic device (FIG. 52f). Furthermore, the charged capacitor can be used to power the electronics such as the smart window and the electronic ink screen to display the designed figures (FIG. 52g). The schematic of the circuit of the MEG-powered electronic ink display is shown in FIG. 78.

### Discussion

In summary, we report a high-performance hydrogel-based moist-electric generator (HMEG). The as-fabricated device was capable of generating an ultrahigh I_{sc} of 1.2 mA/cm² at room condition, and a V_{oc} of 0.6 V could be continuously produced for more than 1400 h. The device shows potential in working at a wide range of environmental temperature (−20° C.-50° C.) and RH (0%-85%), demonstrating all-weather workability. In contrast to the conventional MEGs, the proposed HMEG delivered a higher voltage at a lower humidity, where a durable V_{oc} of 1.2 V was recorded at 0% RH. Due to abundant water inside the hydrogel, the device could have less reliance on the ambient RH and the reduction in RH could trigger the evaporation of water within the hydrogel, boosting the device performance at 0% RH. Besides, the exceptional water absorption capability of the hydrogel with LiCl also endowed the device with ability of restoring the water loss by absorbing the ambient moisture. Such characteristic contributes to the merit of cyclic usage of the proposed HMEG. With the aid of facile fabrication, a high voltage of 97 V was demonstrated by scaling up the number of cells in series, and the voltage could be maintained after the mechanical bending. These excellent properties of the HMEG enable it a promising and sustainable power source for a variety of electronics. This work also provides insights into the device design for moist electricity generation and beyond.

### Methods

### Materials

Polyvinyl alcohol (PVA, #P1763), glycerol (#G5516), lithium chloride (LiCl,) and graphene oxide (GO) were provided by Sigma-Aldrich. Nickle (Ni) foam, silver (Ag) and copper (Cu) plate was purchased from. Commercial carbon nanotube paste was without further treatment while deionized water was collected from Milli-Q water purification system.

### Synthesis of Hydrogel

The 15 wt % pure PVA solution was obtained by dissolving the PVA powder in DI water at 95° C. under magnetic stirring. Upon collecting a transparent and bubble-free PVA solution, 20 wt % glycerol was added for further stirring. Finally, LiCl powder was blended with the as-prepared mixture to obtain the PVA-LiCl hydrogel solution. Different amount of LiCl (0, 1.2, 2.4, 4.8, and 7.2%) was added into the system.

### Fabrication of HMEG

Carbon nanotube (CNT) dispersion was coated on polyethylene terephthalate (PET) film (1 cm×2 cm) as the bottom electrode. A GO layer (1 cm×1 cm) over the CNT substrate was obtained by drying 100 μL of 2 wt % GO dispersion at 50° C. The upper hydrogel layer was obtained by drop-coating the as-prepared hydrogel solution over the GO layer. After the gelation is completed, a piece of Ni foam (0.2 cm×0.5 cm) is placed on the hydrogel as the top electrode.

### Characterization

Before the characterization, the HMEG was dried in a vacuum oven for 12 h to eliminate the water content within the hydrogel. Fourier Transform Infrared spectrum (FTIR, PerkinElmer Spectrum 100) was performed to investigate the interaction between the additives and the functional groups. The morphology of the HMEG was observed by scanning electron microscope (SEM, FEI Nova NanoSEM 450). Autolab (PGSTAT302N) workstation was employed for the electrochemical impedance spectroscopy (EIS) and cyclic voltammetry (CV) measurement. The state and amount of water within the hydrogel were evaluated with Raman spectrometer (Renishaw in Via Reflex) at the wavelength of 532 nm. The element composition of the HMEG was analysed by Energy-dispersive X-ray spectroscopy (EDS) and X-ray photoelectron spectroscopy (XPS). X-ray diffractometer (XRD) with a Cu Kα radiation source (λ=1.5418 Å) was employed to analyse the crystallinity of the hydrogel with the scan rate of 2°/min.

### Water Absorption Capability

The as-formed hydrogel was dried in oven (50° C., 15% RH) to remove the interior water content before the measurement of water absorption capability. The dried hydrogel was settled for water absorption at RH of 45%. The water absorption capability is then calculated as the below equation, where Wₐ, W_{f} and Wᵢ denotes the water absorption capability, weight of the hydrogel after absorption at the corresponding time, and initial weight of the dried hydrogel, respectively.

$${W}_{a} = \frac{{W}_{f} - {W}_{i}}{{W}_{i}}$$

### Electric Performance Measurement

The electric output of the device was measured by Keithley 2400 source meter. The source voltage is set to 0 V when measuring the short-circuit current. Conversely, the open-circuit voltage is measured at the source current of 0 A. The relative humidity is controlled by the airflow of N₂ through a chamber of DI water. To conduct the cyclic measurement, the sample was connected to the source meter and settled in an oven with a set temperature and RH of 50° C. and 15%, respectively. After a cycle of measurement in the oven, the sample was reset at the ambient environment (25° C. and 45%) to absorb moisture to realize the recovery step, followed by recording immediate voltage. As to the subzero-temp measurement, the device is settled and rested in a refrigerator for 10 min to reach the equilibrium condition before the measurement.

It is to be understood that, if any prior art publication is referred to herein, such reference does not constitute an admission that the publication forms a part of the common general knowledge in the art, in Australia or any other country.

Certain features described in the examples and the samples described above may be used with other specific examples, for example the electrodes.

In the claims which follow and in the preceding description of the invention, except where the context requires otherwise due to express language or necessary implication, the word “comprise” or variations such as “comprises” or “comprising” is used in an inclusive sense, namely, to specify the presence of the stated features but not to preclude the presence or addition of further features in various embodiments of the invention.

It is to be understood that the aforegoing description refers merely to preferred embodiments of invention, and that variations and modifications will be possible thereto without departing from the spirit and scope of the invention, the ambit of which is to be determined from the following claims.

1. A moisture electric generating device comprising:
a first electrode and a second electrode;
and a functional layer disposed between the first electrode and the second electrode, wherein the functional layer releases electrical charge carriers;
wherein:
the functional layer includes at least two sub layers;
a first sub layer of the at least two sub layers acts as a moisture reservoir to a second sub layer of the at least two sub layers, to provide moisture to the second sub layer;
the second sub layer produces electrical charge carriers as a function of moisture available from the first sub layer.

2. The moisture electric generating device according to claim 1, wherein the first sublayer comprises a polymer.

3. (canceled)

4. (canceled)

5. (canceled)

6. The moisture electric generating device according to claim 1, wherein the first sub layer releases electrical charge carriers when the moisture electric generating cell is exposed to moisture.

7. The moisture electric generating device according to claim 1, wherein the second sublayer has a net electric charge which is opposite to the charge of the of the charge carriers in the first sub layer.

8. (canceled)

9. (canceled)

10. The moisture electric generating device according to claim 1, the moisture electric generating device being configured with the second sub layer being positioned between the first sub layer and the second electrode, the second sub layer having a top surface facing towards the first sub layer and a bottom surface facing towards the second electrode, the moisture electric generating device being configured to resist an ingress of moisture into the bottom surface of the second sub layer.

11. The moisture electric generating device according to claim 1 wherein the second electrode is insulating to moisture.

12. (canceled)

13. The moisture electric generating device according to claim 1, wherein the first sub layer includes ionic salt.

14. The moisture electric generating device according to claim 1, wherein the first sub layer comprises a hydrogel.

15. (canceled)

16. (canceled)

17. A moisture electric generating device comprising:
a first electrode and a second electrode;
a functional layer which releases electrical charge carriers to the first and second electrodes;
and a layer acting as a moisture reservoir to provide moisture to the functional layer.

18. The moisture electric generating device according to claim 17, wherein the layer acting as the moisture reservoir to provide moisture to the functional layer is disposed between the first electrode and the second electrode.

19. The moisture electric generating device according to claim 17, wherein the functional layer includes at least two sub layers, with a first sub layer being the layer acting as a moisture reservoir and a second sub layer which provides electrical charge carriers when provided with moisture.

20. A moisture electric generating device comprising:
a first electrode and a second electrode;
and a functional layer disposed between the first electrode and the second electrode, wherein the functional layer releases electrical charge carriers when an electricity generating cell is exposed to moisture;
wherein the functional layer includes at least two sub layers stacked between the first and second electrodes (and adjacent layers being electrically connected);
wherein one of the at least two sub layers is a polymer sub layer.

21. The moisture electric generating device according to claim 20, wherein the polymer sub layer acts as a moisture reservoir to an adjacent sub layer when the electricity generating cell is exposed to moisture.

22. A moisture electric generating device comprising:
a first electrode and a second electrode;
and a functional layer disposed between the first electrode and the second electrode, wherein the functional layer releases electrical charge carriers when an electricity generating cell is exposed to moisture;
wherein the functional layer includes at least two sub layers stacked between the first and second electrodes (and adjacent layers being electrically connected);
wherein one of the at least two sub layers is a polymer sub layer acts as a moisture reservoir to an adjacent sub layer when the electricity generating cell is exposed to moisture.

23. An electricity generating cell comprising:
a first electrode and a second electrode, and
a functional layer located between the first and second electrodes, wherein the functional layer releases electrical charge carriers when the electricity generating cell is exposed to moisture.

24. The electricity generating cell according to claim 23, wherein the functional layer includes at least two sub layers stacked between the first and second electrodes and adjacent sub layers being electrically connected.

25.-35. (canceled)

36. The electricity generating cell according to claim 23, wherein the second electrode is insulating to moisture.

37. The electricity generating cell according to claim 23, wherein the at least two sub layers have different moisture absorption properties.

38. The electricity generating cell according to claim 37, wherein the moisture absorption properties of the at least two sub layers decrease from the sub layer adjacent to the first electrode to the sub layer adjacent to the second electrode.

39. The electricity generating cell according to claim 24, wherein a first sub layer of the at least two sub layers is a polymer layer that acts as a moisture reservoir to an adjacent sub layer when the electricity generating cell is exposed to moisture.

40.-46. (canceled)
